(19) United States
(12) Patent Application Publication
(10) Pub. No.: US 2016/0307456 A1
(43) Pub. Date: Oct. 20, 2016

(54) METHODS AND SYSTEMS FOR TEACHING AND TRAINING PEOPLE

(71) Applicant: Brett Raymond Harward, Jackson, WY (US)

(72) Inventor: Brett Raymond Harward, Jackson, WY (US)

(21) Appl. No.: 15/075,081

(22) Filed: Mar. 18, 2016

Related U.S. Application Data
(60) Provisional application No. 62/139,663, filed on Mar. 28, 2015.

(51) Int. Cl. G09B 7/00

(52) U.S. Cl. CPC G09B 7/00

(57) ABSTRACT

Methods and systems for teaching and training people are described. Identifying a desired training outcome of a customer entity, identifying existing training information of the customer entity, identifying the customer entity's training needs, organizing the customer entity's training needs into training topics, developing a training instruction for each of the training topics, identify a topic master for providing support to learners, distributing a first training instruction associated with a training topic to the topic master, training the topic master to become a master of the training topic, asynchronously distributing a second training instruction associated with the training topic to a plurality of learners, assisting, by the topic master, each of the plurality of learners to learn using the second training instruction, evaluating the training progress of each of the plurality of learners compared to the desired training outcome and communicating to the topic master the training progress of each of the plurality of learners is disclosed.

### RELATED APPLICATIONS

The present patent document claims the benefit of and priority to the filing date under 35 U.S.C. §119(e) of Provisional U.S. Patent Application Ser. No. 62/139,663, entitled “METHODS AND SYSTEMS FOR TEACHING AND TRAINING PEOPLE” and filed Mar. 28, 2015, the entire contents of which is hereby incorporated by reference as part of this application.

### BACKGROUND

The disclosure relates to systems and methods for teaching and training people.

Billions of dollars are spent every year helping people learn information and develop skills. Teaching and training opportunities abound—corporations train their employees, university professors teach students, hospitals train their doctors and staff, human resource departments train their sales teams, banks train their mortgage officers, multilevel marketing companies train their distributors and customers, authors teach their readers, pastors teach their congregations, drill sergeants train new recruits, rehabilitation clinics teach addicts, etc.

Different models of training have been developed in the past. One such model is the apprenticeship model, which was born in medieval times. The apprenticeship model develops masters who are subject matter experts. The master's role is one of being a teacher or mentor, from the perspective of mastery of a specific skill, talent or process. The apprentice is the person who is learning the relevant subject matter. Typically, this person is somewhere along the journey of mastering some skill or process. The apprentice continues training until they are a master, at which point they may train others. This model works well to develop people to have a mastery of a subject.

While some skilled and professional trades still employ a version of apprenticeship, this model is no longer practical in most trades. The efficiencies needed to train a large group of employees are not compatible with apprenticeship. Training has moved from a personal mastery focus, to a focus on the most efficient and affordable ways to deliver just enough information to do a job.

Another aspect of modern training is the spatial nature of training rather than the linear nature of apprenticeship teaching and training. In other words, in the modern model, skills and information are often taught in a non-sequential method, depending on the job at hand or scheduled subject. All learners are often taught on the same topic without necessarily having the same background and experience. This transition to efficiency focused training has impacted education, adult skills learning, and business training.

The apprenticeship model of training is extremely effective in developing mastery of a subject, but cannot be applied or scaled in large modern corporations or learning environments. For example, using the apprentice model of training, the number of new employees would be limited by the number of existing masters. The master/apprentice ratio isn't financially feasible, nor is it scalable. You simply can't get masters fast enough even if it was financially feasible. Simply put, the modern workplace requires more trained individuals than what is possible using the apprenticeship model. In response, modern training models have discarded the apprenticeship model and instead seek to gather as many people as possible together and give them as much information as possible to minimize costs. For example, hospital administrators gather their staff and train them on complex and often lengthy government regulations. Universities typically place as many students into a classroom and/or lecture hall as they can for 50 to 90 minutes or longer and dispense as much information as possible, and then test them on how much information they have learned at various intervals throughout the semester. People also write books, film videos, give lectures, provide podcasts, produce CD's, give PowerPoint presentations, and do other things to dispense large amounts of information to people. The focus under the modern approach is on the content producers rather than on the learners. Consequently, the modern approach fails to produce the level of results desired because it sacrifices effectiveness for the sake of minimizing expenses. In other words, the effectiveness of modern teaching, training, skill building and/or people development is handicapped by an effort to be efficient.

The modern approach to training and teaching people fails to implement and consider psychological factors and/or brain functions that facilitate the movement of information into a learner's short-term memory, to his/her long-term memory and, ultimately, to habit formation (and/or habit displacement). Some psychological factors and/or brain functions which may impact training effectiveness but which the modern approach fails to consider, may include the following: developing trainings which (1) accommodate a learner's limited attention spans and ability to retain a limited amount of information, (2) teach people in different ways, (3) tie the training to memories which are often linked to experiences, emotions and/or the senses, (5) reinforce and built upon each other, and (4) help learners retain information and/or increase habit formation. These psychological factors and/or brain functions suggest that the modern approach of distributing mass amounts of information to groups of people gathered together may actually impede learning and/or result in the loss of significant amounts of information.

The modern approach to training people can be expensive. Companies, government agencies and others spend large amounts of money sending people to various locations to receive training and instruction. Not only may travel costs be significant under the modern approach, but businesses may experience negative affects to workflow and/or productivity while their employees are off being trained rather than working.

Another problem with the modern approach is that some people may be absent during the training, hired after the training has begun, not paying attention during the training, not able to learn the material as quickly as others, or for whatever reason, not receive all the necessary training in a timely manner. These scenarios make it difficult for instructors to build on previous training material and maintain an efficient training pace and, as a result, learners fall behind and/or don't receive the necessary training. In an effort to remedy these problems instructors may attempt, for example, to spend a few minutes reviewing the material previously presented during the next training session. The effectiveness of such reviews is doubtful. Spending time trying to get others caught up may also interrupt the training process for others. The modern approach simply is not designed to accommodate learners who start the training process at different times and/or are at different levels.

The challenges associated with the modern approach are further compounded when there is a need for a series of specifically timed and sequenced trainings that build upon themselves and reinforce previous training topics. As indicated, some learners may have missed some of the training and need to catch up and/or need to simply start the training series at different times. In addition, and/or alternatively, some learners may be situated in a different location, such as, for example, one living in Alaska and another living in Wisconsin. The modern approach cannot effectively train each individual learner situated in different locations who may be at different stages of a specifically timed and sequenced training series.

In light of the above, there is a need for a system and method for teaching and training people that overcomes the challenges associated with the modern training and teaching approach. In particular, there is a need for a system and method for teaching and training people which may provide asynchronously training to individuals at different times, who may be at different locations, who may be at different levels of performance and/or understanding, and who may learn differently, and which may provide training that implements psychological factors and/or brain functions, which may be specifically timed and sequenced, and which may minimize expenses and interruptions to work productivity.

### SUMMARY

In one aspect, a method for teaching and training people associated with a customer entity is disclosed. The method includes identifying a desired training outcome of a customer entity. For example, a customer entity may specify their goals to a user allowing the user to identify the customer entity's goals. Existing training information of the customer entity is then identified. In some embodiments this may be done through the customer entity transmitting existing training documents to the organization. The customer entity's training needs are identified. The customer entity's training needs are organized into training topics. A training instruction is developed for each of the training topics. A topic master for providing support to learners is identified. In some embodiments, the topic master may have been previously known, or in other embodiments, the topic master may be previously unknown and identified at this time. A first training instruction associated with the training topic is distributed to the topic master, who is then trained to become a master of the training topic. A second training instruction associated with the training topic is asynchronous distributed to a plurality of learners. The learners do not receive the training instructions in lock step and may instead proceed on a need to know, individualized course. The topic master assists each of the plurality of learners to learn using the second training instruction. For example, the topic master should be able to assist a learner with any difficult questions based on their prior training. The training progress of each of the plurality of learners is compared to the desired training outcome and the training progress of each of the plurality of learners is communicated to the topic master.

In some embodiments, topic masters may assist each learner with a training progress less than the desired training outcome. In some embodiments, asynchronously distributing a second training instruction includes transmitting the second training instruction to a plurality of learners over email, website, text messaging, instant messaging, social media and push notification. In some embodiments, the method further includes identifying a support channel for providing support to topic masters. For example, an upper level manager may be identified to support a topic master in their training to master a training topic. A third training instruction associated with the training topic is distributed to the support channel. The support channel is then able to assist the topic master to learn using the first training instruction.

In another aspect a system for teaching and training people is disclosed. The system includes a first computing device, a second computing device, and a third computing device. The first computing device includes a first processor and first memory storing instructions that when executed by the first processor cause the first computing device to implement functions. The functions include identify a desired training outcome of an organization, identify existing training information of the organization, identifying the customer entity's training needs, organize the customer entity's training needs into training topics, develop a training instruction for each of the training topics, identify a topic master for providing support to learners, distribute a first training instruction associated with a training topics to the topic master, asynchronously distribute a second training instruction associated with the training topic to a plurality of learners, evaluate the training progress of each of the plurality of learners compared to the desired training outcome, and communicate to the topic master the training progress of each of the plurality of learners. The second computing device includes a second processor and a second memory storing instructions that when executed by the second processor cause the second computing device to implement functions which include receive the first training instruction, assist a topic master to become a master of the training topic, and receive the training progress of each of the plurality of learners. The third computing device includes a third processor and a third memory storing instructions that when executed by the third processor cause the third computing device to implement functions including receive the second training instruction, assist a learner to learn the training topic using the second training instruction, and communicate a training progress of the learner to another computing device.

In some embodiments, system further includes a fourth computing device having a fourth processor and a fourth memory storing instructions that when executed by the fourth processor cause the fourth computing device to implement functions including receive the second training instruction, assist a second learner to learn the training topic using the second training instruction, and communicate a progress of the second learner to another computing device. In this embodiment, asynchronously distributing a second training instruction includes transmitting the second training instruction to the third computing device and the fourth computing device.

In some embodiments, the instructions stored in the first memory further cause the first computing device to identify a support channel for providing support to topic masters and distributing a third training instruction associated with the training topic to the support channel. In such embodiments, the system further includes a fourth computing device having a fourth processor and a fourth memory storing instructions that when executed by the fourth processor cause the fourth computing device to implement functions including receive the third training instruction, assist in training the support channel with the third training instruction, and assist the support channel in training the topic master to learn using the first training instruction.

In some embodiments, the first computing device is a remote server, the second computing device is a portable device communicately coupled to the remote server, and the third computing device is a portable device communicately coupled to the remote server.

In another aspect, a system for organizing instruction is disclosed. The system includes a computing device having a processor and memory storing instructions that when executed by the processor cause the computing device to implement functions including identify a desired training outcome of an organization, identify existing training information of the organization, identify the customer entity's training needs, organize the customer entity's training needs into training topics, develop a training instruction for each of the training topics, identify a topic master for providing support to learners, distribute a first training instruction associated with a training topic to the topic master, the first training instruction instructing the topic master to become a master in the training topic, asynchronously distribute a second training instruction associated with the training topic to a plurality of learners, the second training instruction configured to enable each of the plurality of learners to learn the training topic with assistance from the topic master, evaluate the training progress of each of the plurality of learners compared to the desired training outcome, and communicate to the topic master the training progress of each of the plurality of learners.

In some embodiments, asynchronously distributing a second training instruction comprises transmitting the second training instruction to a plurality of computing devices.

In some embodiments, the instructions stored in the memory further cause the computing device to identify a support channel for providing support to topic masters and distribute a third training instruction associated with the training topic to the support channel, the third training topic configured to assist the support channel to train the topic master to become a master in a training topic.

In some embodiments, the computing device server is remote to a customer entity being trained. In some embodiments, the instructions stored in the memory further cause the computing device to update the second topic instruction based on the training progress of each of the plurality of learners.

In one aspect, a method for teaching and training people may include developing and obtaining a customer's desired outcomes; optionally determining whether a customer has existing training concepts, information and materials; assessing a customer's training needs and develops training topics, instructions, activities and communications; optionally determining whether support channels exist; optionally developing training topics, instructions, activities and communications for support channels; determining whether training topics, instructions, activities and communications have been developed; preparing training instructions, activities and communications to be distributed to intended recipients; computing implemented process automatically distributes training instructions, activities and communications to recipients; evaluating the training progress of recipients; determining whether a customer's desired outcomes were achieved; and/or determining whether a customer has additional desired outcomes.

In another aspect, a computer implemented system for teaching and training people may include a processor system and one or more memory systems connected to the processor system wherein the one or more memory systems having stored instructions which when executed by the processor system, may include: developing and obtaining a customer's desired outcomes; optionally determining whether a customer has existing training concepts, information and materials; assessing a customer's training needs and develops training topics, instructions, activities and communications; optionally determining whether support channels exist; optionally developing training topics, instructions, activities and communications for support channels; determining whether training topics, instructions, activities and communications have been developed; preparing training instructions, activities and communications to be distributed to intended recipients; computing implemented process automatically distributes training instructions, activities and communications to recipients; evaluating the training progress of recipients; determining whether a customer's desired outcomes were achieved; and/or determining whether a customer has additional desired outcomes.

In another aspect, a method for teaching and training people may include: assessing a market training needs and developing training topics, instructions, activities and communications; optionally determining whether support channels exist; optionally developing training topics, instructions, activities and communications for support channels; determining whether training topics, instructions, activities and communications have been developed; preparing training instructions, activities and communications to be distributed to intended recipients; and/or computing implemented process automatically distributes training instructions, activities and communications to recipients.

In another aspect, a computer implemented system for teaching and training people, comprising: a processor system and one or more memory systems connected to the processor system wherein the one or more memory systems having stored instructions which when executed by the processor system, may include: assessing a market training needs and develops training topics, instructions, activities and communications; optionally determining whether support channels exist; optionally developing training topics, instructions, activities and communications for support channels; determining whether training topics, instructions, activities and communications have been developed; preparing training instructions, activities and communications to be distributed to intended recipients; and/or computing implemented process automatically distributes training instructions, activities and communications to recipients.

Certain implementations may provide one or more of the following advantages. Embodiments may not achieve any or all of the listed advantages. Further, this is not an exhaustive list of all possible advantages of the disclosure. Other features and advantages will be apparent from the following detailed description, the accompanying drawings, and the claims.

As compared to other methods for teaching and training people and/or systems for teaching and training people, the methods for teaching and training people and/or systems for teaching and training people disclosed herein (including all equivalents and those within the spirit of this disclosure), together, each separately and/or arranged in every other possible arrangement (combined and/or separately), may: automate the distribution of numerous training instructions, activities and communications numerous recipients; decrease teaching and training expenses; increase teaching and training support; make teachings and trainings more memorable, retainable and/or actionable; teach and train various levels of personnel, such as, for example, from front-line learners to CEO's and all levels in-between; decrease travel expense associated with traveling to training; increase legal compliance; enhance supervisor awareness of the learning progress of those they supervise; asynchronously teach and train; increase intrinsic motivation; increase retention of material learned; increase effectiveness in applying concepts; deepen learners' understanding of material learned; automate and increase follow-up, follow through and accountability; decrease downtime and increase work production; provide focused trainings centered on learners; provide flexible and/or adaptable training schedules; be implemented in any place learners may be located provided that they have access to an operative mobile device and/or computing systems capable of connecting to the Internet and receiving and viewing email, text, and/or videos and/or receiving phone calls; automate tracking of learner progress; and/or increase likelihood that material may enter into and move from learners' short-term memory, to their long-term memory and, ultimately, to habit formation and/or displacement.

### BRIEF DESCRIPTION OF THE DRAWINGS

Various embodiments of the disclosure will now be discussed with reference to the appended drawings. It is appreciated that these drawings depict only typical embodiments of the disclosure and are not to be considered limiting of its scope.

FIG. 1 is a block diagram that depicts one embodiment of exemplary hardware architecture for a system implementing the disclosure.

FIG. 2A is a block diagram that depicts one embodiment of exemplary hardware architecture for a system implementing a method for teaching and training people.

FIG. 2B is a block diagram that depicts one embodiment of exemplary hardware architecture for a system implementing a method for teaching and training people.

FIG. 2C is a block diagram that depicts one embodiment of exemplary hardware architecture for a system implementing a method for teaching and training people.

FIG. 3 is a flow diagram that depicts one embodiment of a method for teaching and training.

FIG. 3A is a flow diagram that depicts one embodiment of a method for teaching and training.

FIG. 4 is a screenshot that depicts one embodiment of aspects of a registration process.

FIG. 5 is a screenshot that depicts one embodiment of aspects of a registration process.

FIG. 6 is a screenshot that depicts one embodiment of aspects of a payment process.

FIG. 7 is a screenshot that depicts one embodiment of aspects of a payment process.

FIG. 10 is a screenshot that depicts one embodiment of aspects of a registration process.

FIG. 11 is a screenshot that depicts one or more embodiments of aspects of an exemplary mobile application, including a registration page.

FIG. 12 is a screenshot that depicts one or more embodiments of aspects of an exemplary mobile application, including a menu page.

FIG. 13 is a screenshot that depicts one or more embodiments of aspects of an exemplary mobile application, including a different menu page than FIG. 12.

FIG. 14 is a screenshot that depicts one or more embodiments of aspects of an exemplary mobile application, including a page wherein contact information may be entered.

FIG. 16 is a screenshot that depicts one or more embodiments of aspects of an exemplary mobile application, including a page wherein contact information may be entered and which may be displayed different options than FIG. 14.

FIG. 17 is a screenshot that depicts one or more embodiments of aspects of an exemplary mobile application, including a page wherein contact information may be entered and which may be displayed different options than FIG. 14 and FIG. 16.

FIG. 17A is a screenshot that depicts one or more embodiments of aspects of an exemplary mobile application, including a page displaying certain names, dates and other information pertaining to prospects.

FIG. 18 is a screenshot that depicts one or more embodiments of aspects of an exemplary mobile application, including a page displaying certain names, dates and other information pertaining to associates.

FIG. 19 is a screenshot that depicts one or more embodiments of aspects of an exemplary mobile application, including a menu page different than FIG. 12 and FIG. 13.

FIG. 20 is a screenshot that depicts one or more embodiments of aspects of an exemplary mobile application, including displaying a text.

FIG. 22 is a screenshot that depicts one or more embodiments of aspects of an exemplary mobile application, including a page displaying tasks to be due.

FIG. 23 is a screenshot that depicts one or more embodiments of aspects of an exemplary mobile application, including a page displaying a daily success plan.

FIG. 24 is a screenshot that depicts one or more embodiments of aspects of an exemplary mobile application, including a menu page different than FIG. 12, FIG. 13, and FIG. 19.

FIG. 25 is a screenshot that depicts one or more embodiments of aspects of an exemplary mobile application, including a page displaying preferences.

FIG. 26 is a screenshot that depicts one or more embodiments of aspects of an exemplary mobile application, including a page displaying goals.

FIG. 27 is a screenshot that depicts one or more embodiments of aspects of an exemplary mobile application, including a page displaying goals compared to actuals.

FIG. 28 is a screenshot that depicts one or more embodiments of aspects of an exemplary mobile application, including scheduled events.

FIG. 29 is a screenshot that depicts one or more embodiments of aspects of an exemplary mobile application, including training and support options.

FIG. 30 is a screenshot that depicts one or more embodiments of aspects of an exemplary web site, including displaying a user tab.

FIG. 31 is a screenshot that depicts one or more embodiments of aspects of an exemplary web site, including displaying a user tab with some differences compared to FIG. 30.

FIG. 32 is a screenshot that depicts one or more embodiments of aspects of an exemplary website, including displaying a content management page.

FIG. 33 is a screenshot that depicts one or more embodiments of aspects of an exemplary website, including displaying a content management page with some differences compared to FIG. 32.

FIG. 33A is a screenshot that depicts one or more embodiments of aspects of an exemplary website, including displaying a content management page with some differences compared to FIG. 32 and FIG. 33.

FIG. 34 is a screenshot that depicts one or more embodiments of aspects of an exemplary website, including displaying a client management page.

FIG. 38 is a screenshot that depicts one or more embodiments of aspects of an exemplary web site, including displaying a training page.

FIG. 39 is a screenshot that depicts one or more embodiments of aspects of an exemplary website, including displaying a dashboard page.

FIG. 40 is a screenshot that depicts one or more embodiments of aspects of an exemplary worksheet.

### DETAILED DESCRIPTION

The following description illustrates principles of the disclosure which may be applied in various ways to provide different embodiments. There may be many different forms of embodiments of the disclosure, and as such, embodiments should not be limited to those set forth herein. That which is set forth herein, described below, and shown in the accompanying drawings, is offered to illustrate the principles of the disclosure and one or more embodiments, and not as limitations. Other variations of the disclosure may be included within the principles of the disclosure.

One or more embodiments of the disclosure may be customized, flexible, and/or adaptable to meet the various needs of various users in various circumstances.

In one or more embodiments, a system and/or systems of teaching and training people disclosed herein may be used to implement some or all of the methods of teaching and training people disclosed herein.

In one or more embodiments, a system may include a server system, customers and/or other computing resources remotely located and accessed through one or more networks, such as, for example, wide area networks, local area networks, public networks, private networks and/or hybrid networks, and/or other network types, and/or combinations of the same, along with all related software and/or hardware, whether developed later or known at the time of filing. For example, the system of computing resources may communicate via the Internet, along with all related software and/or hardware, related to and/or available through the Internet, such as, for example, the World Wide Web, browsers, cloud computing technology, etc., whether developed later or known at the time of filing. In one or more embodiments, the system may include a network that may be peer-to-peer or client/server based.

In one or more embodiments, the system may include one or more web sites designed to be a location wherein users may input information, retrieve information, and/or initiate instructions for action. The websites may be hosted on at least one web server accessible via a network such as, for example, the Internet.

In one or more embodiments, the system may include software applications, such as, for example, web applications, native applications, and/or mobile applications. In one or more embodiments, a mobile application may be: (i) designed to receive user input, retrieve information from a server system, send information to a server system, and/or initiate other instructions for action, (ii) add-ons to, applications of, and/or packaged with software that may be sold separately and/or with the system, and/or (iii) embedded in device and/or system hardware.

In one or more embodiments, the system use operating systems, along with all related software and/or hardware, such as, for example, software distributed by Apple Inc., Bell Labs, Google, IBM, LynuxWorks, Microsoft Corporation, and/or other operating system companies, which may run mobile devices, personal computers, laptops, servers and/or any other system, whether developed later or known at the time of filing.

In one or more embodiments, a system may include memory systems of any type and/or means, and/or combination thereof, along with all related software and/or hardware, such as, for example, primary memory (such as, for example, RAM, etc.), secondary memory (such as, for example, hard drives, CD-ROM, DVD-ROM, etc.), volatile (such as, for example, flash memory, etc.), non-volatile (such as, for example, cache memory, etc.), and/or any other device and/or means for storing data, and/or combination thereof, whether developed later or known at the time of filing.

In one or more embodiments, a system may include processing systems, along with all related software and/or hardware, including, for example, CPUs for carrying out instructions for performing computing functions and which may include, for example, ALUs, registers, control units, etc., whether developed later or known at the time of filing. In one or more embodiments, a system may include electronic mediums to exchange data between the system and/or components within the system, along with all related software and/or hardware, such as for example, buses, whether developed later or known at the time of filing.

In one or more embodiments, the system may be capable of receiving input and/or generating output. The input provided to the system may be made through input devices and/or other means, along with all related software and/or hardware, such as, for example, keyboards, mice, voice command and/or action translation technology, CD's, DVD's, USB storage devices, wirelessly, and/or other means for inputting data into the system, whether developed later or known at the time of filing. The output generated by the system may be stored on any storage medium (such as, for example, servers, databases, CD's, DVD's, personal computers, mobile devices, etc.), printed, displayed on any display device, distributed in any way (such as, for example, to mobile devices, online, over networks, via text, email, phone, etc.), accessed in any way (such as, for example, remotely), and/or used in any way, whether developed later or known at the time of filing.

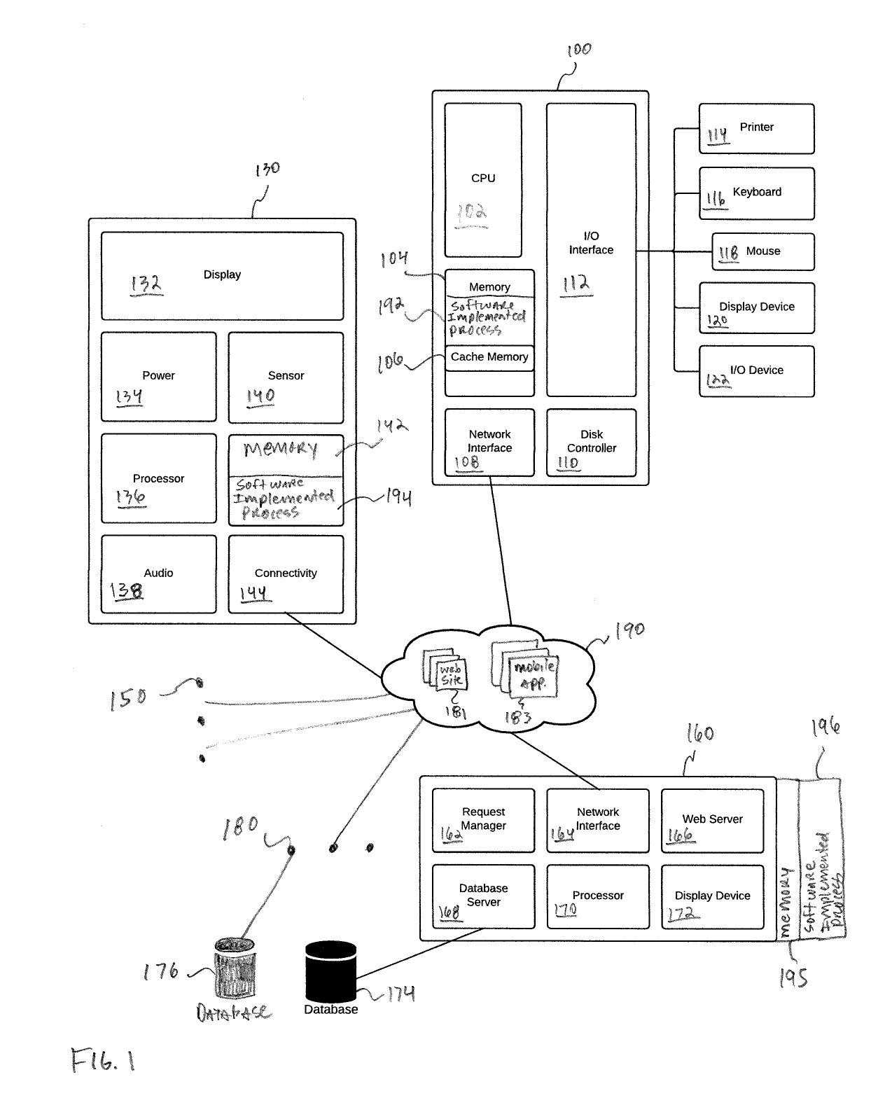

FIG. 1 is a block diagram that depicts one embodiment of exemplary hardware architecture for systems implementing methods for teaching and training people, such as, for example, methods for teaching and training people 300, 300A, that includes a network system 190 that operatively connects client systems 100, 130, 150, server systems 160, 180, and databases 174, 176.

In one or more embodiments, client system 100 may include a personal computer, laptop and/or other computing system, whether developed later or known at the time of filing. Client system 100 may include a processor system 102, a memory system 104 (including cache memory system 106 and software implemented process 192), a network interface system 108, disk controller system 110, and a user input/output interface system 112 which receives input and/or output from printer 114, keyboard 116, mouse 118, display device 120 and/or any other I/O device 122 (such as, for example, CD and/or DVD drive, USB ports, floppy disk drive, wireless ports, and/or any other device for inputting data into and/or outputting data from client system 100, whether later developed or known at the time of filing). In one or more embodiments, all or part of a method for training and teaching people (and/or all or part of a system which implements such a method), such as, for example, method for training and teaching people 300, may be, in whole or in part, stored on, uploaded into, retrieved from, displayed on, able to receive input from, and/or otherwise implemented by use of client system 100.

In one or more embodiments, client system 130 may include a mobile device of any kind, such as, for example, a smartphone, a tablet and/or other mobile device, whether developed later or known at the time of filing. Client system 130 may include a display system 132 (which may include such things as, for example, LCD display and/or touch interface capabilities), a power system 134, processor system 136 (which may include such things as, for example, application processing capabilities), an audio system 138, a sensor system 140, a memory system 142 (including software implemented process 194), and/or a connectivity system 144 (which may include such things as, for example, WIFI, NFC, and/or Bluetooth capabilities). In one or more embodiments, all or part of methods for training and teaching people (and/or all or part of systems which implement such methods), such as, for example, methods for training and teaching people 300, 300A, may be, in whole or in part, stored on, uploaded into, retrieved from, displayed on, able to receive input from, and/or otherwise implemented by use of client system 130.

In one or more embodiments, client systems 150 may include any number of and/or combinations of personal computers, laptops and/or other computing systems, and/or mobile devices of any kind, such as, for example, smartphones, tablets and/or other mobile devices (such as, for example, in client systems 100, 130) whether developed later or known at the time of filing.

In one or more embodiments, server systems 160, 180 may include a request manager 162, network interface 164, web server 166, database server system 168, processor system 170, display device 172, and/or memory system 195 (including software implemented process 196), any of which may be located on one computer and/or on a network of servers, as illustrated in FIG. 1. In one or more embodiments, server systems 160, 180 may be designed to receive and manage requests from client systems 100, 130, 150, process their requests, store the data received in databases 174, 176, return results, and/or otherwise perform the functions requested by client systems 100, 130, 150. In one or more embodiments, all or part of methods for training and teaching people (and/or all or part of systems which implement such methods), such as, for example, methods for training and teaching people 300, 300A, may be, in whole or in part, stored on, uploaded into, retrieved from, displayed on, able to receive input from, and/or otherwise implemented by the use of server systems 160, 180.

In one or more embodiments, all or part of databases 174, 176 may be managed by and/or located on database server system 168 located on server systems 160, 180 and/or managed by and/or located on client systems 100, 130, 150. In one or more embodiments, databases 174, 176 may be web based, such as, for example, connected to and/or located on network system 190. In one or more embodiments, databases 174, 176 may be a storage device utilizing software and/or hardware. In one or more embodiments, all or part of methods for training and teaching people (and/or all or part of systems which implement such methods), such as, for example, methods for training and teaching people 300, 300A, may be, in whole or in part, stored on, uploaded into, retrieved from, displayed on, able to receive input from, and/or otherwise implemented by use of databases 174, 176.

In one or more embodiments, network system 190 may include any network or combination of network systems, such as, for example, wide area networks, local area networks, public networks (such as, for example, the Internet), private networks and/or hybrid networks, and/or other network types, and/or combinations of the same, along with all related software and/or hardware, whether developed later or known at the time of filing, which are capable of communicating between and among two or more server systems and client systems. In one or more embodiments, server systems 160, 180 may connect to network system 190 via network interface system 164; client system 100 may connect to network system 190 via network interface system 108; and client system 130 may connect to network system 190 via connectivity system 144. Thus, in one or more embodiments, server systems 160, 180 may communicate with client systems 100, 130, 150 via network system 190. In one or more embodiments, interface system 164 and network interface system 108 may include network interface cards, broadband, modems, wireless communication and/or any other means for operatively connecting databases 174, 176, server systems 160, 180 and client systems 100, 130, 150. In one or more embodiments, one or more components of databases 174, 176, server systems 160, 180 and client systems 100, 130, 150 may be located remotely on network 190. In one or more embodiments, all or part of methods for training and teaching people (and/or all or part of systems which implement such methods), such as, for example, methods for training and teaching people 300, 300A, may be, in whole or in part, stored on, uploaded into, retrieved from, displayed on, able to receive input from, and/or otherwise implemented by use of network system 190.

In one or more embodiments, all or part of methods for training and teaching people (and/or all or part of systems which implement such methods), such as, for example, methods for training and teaching people 300, 300A, may include one or more websites 181 and/or mobile applications 183. In one or more embodiments, one or more websites 181 and/or mobile applications 183 may be designed to be a location wherein users may input information, retrieve information, and/or initiate instructions for action. In one or more embodiments, one or more websites 181 and/or mobile applications 183 may be hosted on at least one web server (such as, for example, web server 166) accessible via a network (such as, for example, network system 190), such as, for example, through the Internet.

In one or more embodiments, all or part of methods for training and teaching people (and/or all or part of systems which implement such methods), such as, for example, methods for training and teaching people 300, 300A, may be, in whole or in part, stored on, uploaded into, retrieved from, displayed on, able to receive input from, and/or otherwise implemented by use of memory system 104 (including cache memory system 106) on client system 100; memory system 142 on client system 130; memory system 195 on server system 160; databases 174, 176 via database server system 168 on server system 160, and/or a database server system on server systems 180 (respectively); web based functionality via network system 190; software implemented process 192 on memory system 104 on client system 100; software implemented process 194 on memory system 142 on client system 130; and/or software implemented process 196 on memory system 195 on server system 160; and executed on client systems 100, 130, 150, server systems 160, 180 and/or network system 190. In one or more embodiments, memory may include any type of memory and/or combination thereof, such as, for example, volatile (such as, for example, flash memory, etc.), non-volatile (such as, for example, cache memory, etc.), and/or any other device and/or means for storing data, and/or combination thereof, whether developed later or known at the time of filing.

In one or more embodiments, all or part of methods for training and teaching people (and/or all or part of systems which implement such methods), such as, for example, methods for training and teaching people 300, 300A, may be called from executable code, such as, for example, software of any kind, including software implemented process 192, software implemented process 194, and/or software implemented process 196. In one or more embodiments, when an operation and/or application takes action, such may be the result of one or more processors (such as, for example, processor system 102, processor system 136, and/or processor system 170) executing instructions. In one or more embodiments, the execution of all or part of methods for training and teaching people (and/or all or part of systems which implement such methods), such as, for example, methods for training and teaching people 300, 300A, may involve ruler and/or agent processes not illustrated in FIG. 1.

Although not illustrated in FIG. 1, those skilled in the art would appreciate that network system 190, server systems 160, 180, client systems 100, 130, 150, and databases 174, 176, are only illustrative of the number and types of systems, components and configurations thereof that may be used in all or part of methods for training and teaching people (and/or all or part of systems which implement such methods), such as, for example, methods for training and teaching people 300, 300A, and different and numerous network systems, server systems, client systems and databases and other systems, components and configurations may be used with this disclosure, whether developed later or known at the time of filing. Those skilled in the art would appreciate that not all systems, components and configurations of network system 190, server systems 160, 180, client systems 100, 130, 150, and databases 174, 176 are illustrated in FIG. 1 or expressly stated herein, and that the exact systems, components and configurations of network system 190, server systems 160, 180 and client systems 100, 130, 150, may vary, be tailored, be fewer, and/or be more than as illustrated in FIG. 1, in order to meet the needs of numerous circumstances.

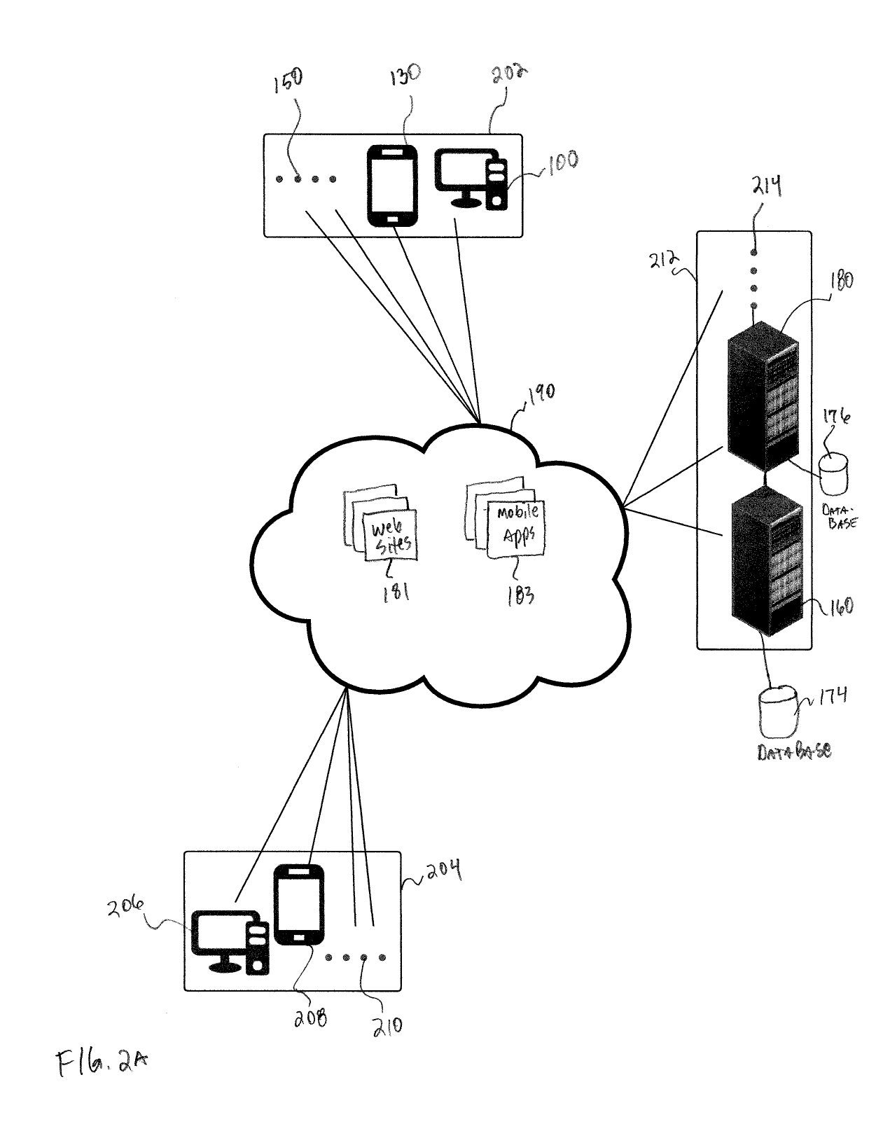

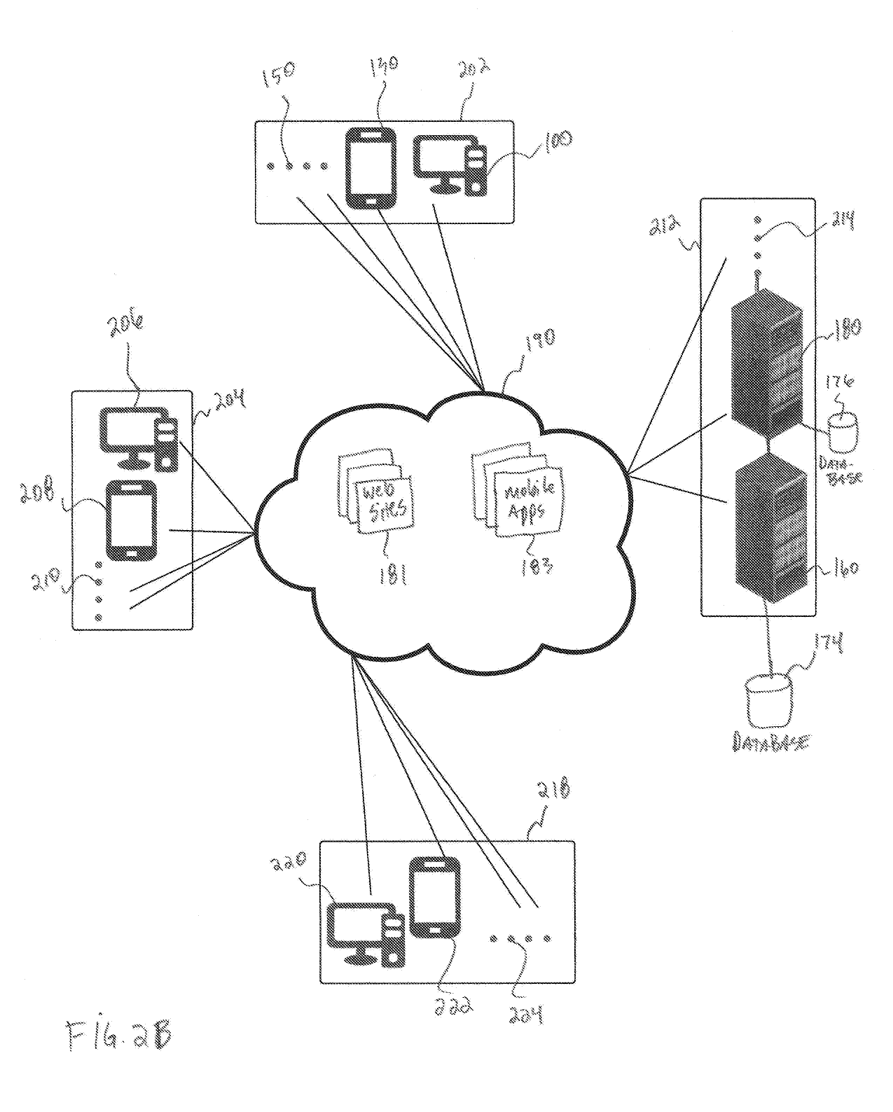

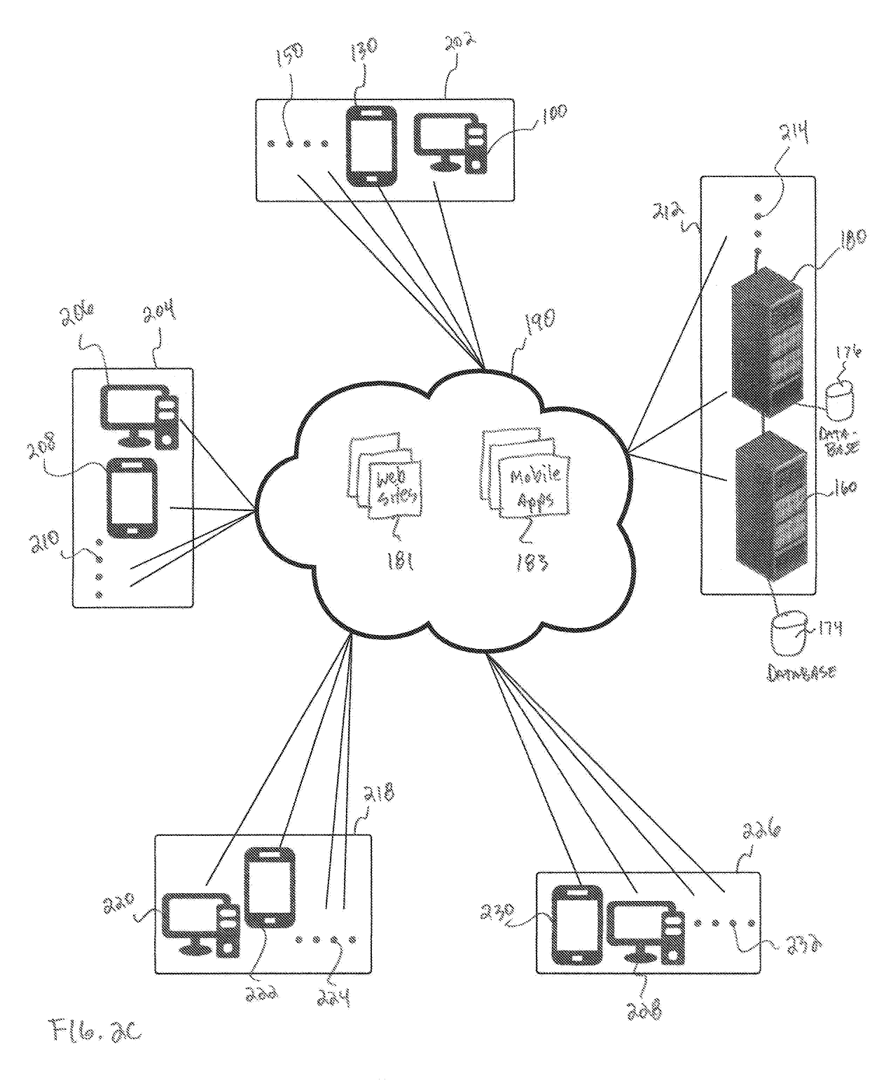

For example, FIG. 2A is a block diagram that depicts one embodiment of exemplary hardware architecture for systems implementing methods for teaching and training people, such as, methods for teaching and training people 300, 300A, that includes a network system 190 that operatively connects client systems 202, 204, server system 212, and databases 174, 176, as well as one or more websites 181 and/or mobile applications 183.

In one or more embodiments, client system 202 may include client systems 100, 130, 150, as discussed above. In one or more embodiments, client system 204 may include client systems 206, 208, 210, which may include systems, components and/or configurations the same, similar and/or different to client systems 100, 130, 150. In one or more embodiments, server system 212 may include server systems 160, 180, as discussed above, as well as 214 which may include systems, components and/or configurations the same, similar and/or different to server systems 160, 180. In one or more embodiments, websites 181 and/or mobile applications 183 may be stored on server system 212 and accessed, retrieved, downloaded and/or otherwise used by client systems 202, 204 from server system 212 via network system 190.

In one or more embodiments, client system 202 may be, for example, utilized by an organization to use all or part of methods for training and teaching people (and/or all or part of systems which implement such methods), such as, for example, methods for training and teaching people 300, 300A, including, for example, to develop, access, and/or otherwise use websites 181 and/or mobile applications 183 which may include some, none, and/or all of the following administrative privileges and/or capabilities, as well as other privileges and/or capabilities not specifically listed herein:
Provide goods/services to its customers;
Setup and manage all customer accounts and all customer account settings, which may be customizable to each customer's need (such as, for example, entering and/or modifying their names, usernames, passwords, phone numbers, emails, addresses, billing information, trainings, goals, logins, up line/down line relationships, adding, editing and/or deleting customers, managing relevant settings, etc.);
Link all customer accounts to their respective customer mobile applications;
Gather and track matrixes and information regarding all customer accounts (such as, for example, billing information, payment status, training progress, usage information, goals, logins, up line and down line relationships associated with each user, etc.);
Generate reports on matrixes and information regarding all customer accounts (such as, for example, on all customer accounts combined, each customer account separately, on a particular category of users, etc.);
Group and/or classify customers into various categories and subcategories;
Develop training instructions, activities and communications and manage their relevant settings/parameters; and/or
Manage training instruction, activity and communication distribution (such as, for example, determining the timing and sequence in which each user is distributed training instructions, activities and communications, etc.).

In one or more embodiments, client system 204 may be, for example, utilized by an organization's customers to receive, access and/or otherwise use training instructions, activities and communications and/or purchase other goods/services provided by an organization; to use websites 181 and/or mobile applications 183; to setup and manage their respective accounts; and/or to otherwise use all or part of methods for training and teaching people (and/or all or part of systems which implement such methods), such as, for example, methods for training and teaching people 300, 300A.

In terms of data modeling, FIG. 2A may represent at least two levels of relationships—grandparent (e.g. the organization on client system 202) and parent (e.g. the customer on client system 204). It is contemplated that the organization may have more customers who may use all or part of methods for training and teaching people (and/or all or part of systems which implement such methods), such as, for example, methods for training and teaching people 300, 300A, which are not represented in FIG. 2A. In one or more embodiments, each customer may have its own customized mobile applications 183.

In another example, according to one or more embodiments, an organization may have customers who have various users, each with their own account. Under such circumstances the organization and/or customers may need certain administrative privileges and/or capacities to manage their user accounts. For example, in one or more embodiments, the organization's customer may be a bank with various loan officers. Bank administrators may need certain administrative privileges and capacities to properly manage its loan officers. Furthermore, bank administrators and loan offices may each receive different training instructions, activities and communications.

In one or more embodiments, all or part of methods for training and teaching people (and/or all or part of systems which implement such methods), such as, for example, methods for training and teaching people 300, 300A, may be designed to be customized, flexible, and/or adaptable to meet the various needs of various users in various circumstances.

For example, FIG. 2B is a block diagram that depicts one embodiment of exemplary hardware architecture for systems implementing methods for teaching and training people, such as, methods for teaching and training people 300, 300A, that includes a network system 190 that operatively connects client systems 202, 204, 218, server system 212, and databases 174, 176, as well as one or more websites 181 and/or mobile applications 183.

In one or more embodiments, client systems 202, 204 may include client systems 100, 130, 150, 206, 208, 210 as discussed above. In one or more embodiments, client system 218 may include client systems 220, 222, 224, which may include systems, components and/or configurations the same, similar and/or different to client systems 100, 130, 150, 206, 208, 210. In one or more embodiments, server system 212 may include server systems 160, 180, 214 as discussed above. In one or more embodiments, websites 181 and/or mobile applications 183 may be stored on server system 212 and accessed, retrieved, downloaded and/or otherwise used by client systems 202, 204, 218 from server system 212 via network system 190.

In one or more embodiments, client system 202 may be, for example, utilized by an organization to use all or part of methods for training and teaching people (and/or all or part of systems which implement such methods), such as, for example, methods for training and teaching people 300, 300A, including, for example, to develop, access, and/or otherwise use websites 181 and/or mobile applications 183 which may include some, none, and/or all of the administrative privileges and/or capabilities as described above, including such that may apply to users associated with its customers, as well as other privileges and/or capabilities not specifically listed herein.

In one or more embodiments, client system 204 may be, for example, utilized by an organization's customers to use all or part of methods for training and teaching people (and/or all or part of systems which implement such methods), such as, for example, methods for training and teaching people 300, 300A, including, for example, to develop, access, and/or otherwise use websites 181 and/or mobile applications 183 which may include some, none, and/or all of the following administrative privileges and/or capabilities, as well as other privileges and/or capabilities not specifically listed herein:
Setup and manage their respective customer accounts and user accounts, which may be customizable to their needs (such as, for example, entering and/or modifying their names, usernames, passwords, phone numbers, emails, addresses, billing information, trainings, goals, logins, up line/down line relationships, adding, editing and/or deleting users, managing relevant settings, etc.);
Purchase, receive, obtain, and/or otherwise use the goods/services provided by an organization;
Receive, access and/or otherwise use training instructions, activities and communications;
Use websites 181 and/or mobile applications 183;
Gather and track matrixes and information regarding their respective customer and user accounts (such as, for example, billing information, payment status, training progress, usage, goals, logins, up line/down line relationships, etc.);
Generate reports on matrixes and information regarding their respective customer and user accounts (such as, for example, reporting on a particular category of users, etc.);
Group and/or classify their respective users into various categories and subcategories;
Develop training instructions, activities and communications and manage relevant settings/parameters; and/or
Manage training instruction, activity and communication distribution (such as, determining the timing and sequence in which each training instructions, activities and communications may be distributed, etc.).

In one or more embodiments, client system 218 may be, for example, utilized by users associated with a customer to receive, access and/or otherwise use training instructions, activities and communications and/or purchase other goods/services provided by an organization; to use websites 181 and/or mobile applications 183; to setup and manage their respective accounts; and/or to otherwise use all or part of methods for training and teaching people (and/or all or part of systems which implement such methods), such as, for example, methods for training and teaching people 300, 300A.

In terms of data modeling, FIG. 2B may represent at least three levels of relationships—grandparent (e.g. the organization on client system 202), parent (e.g. the customer on client system 204), and child (e.g. the users associated with the customer on client system 218). It is contemplated that the organization may have many customers and users who may use all or part of methods for training and teaching people (and/or all or part of systems which implement such methods), such as, for example, methods for training and teaching people 300, 300A, which are not represented in FIG. 2B. In one or more embodiments, each customer may have its own customized mobile application(s) 183.

In another example, according to one or more embodiments, as discussed above, an organization may have customers who have various users, each with their own account. Under such circumstances, the organization and/or customers may need certain administrative privileges and/or capacities to manage their user accounts. Furthermore, in one or more embodiments, those users may manage other users and therefore may need certain administrative privileges and/or capacities to manage the other user accounts.

For example, in one or more embodiments, an organization's customer may be a hospital needing certain administrative privileges and/or capacities over its doctors and staff and where doctors need certain administrative privileges and/or capacities over the staff. In one or more embodiments, the organization may distribute different training instructions, activities and communications to each of the hospital administration, doctors and staff.

Similarly, for example, in one or more embodiments, an organization's customer may be a multilevel marketing company which has a management team and a large number of distributors seeking to recruit new contacts. In one or more embodiments, the management team may need certain administrative privileges and/or capacities over its distributors and the distributors may need administrative privileges and/or capacities over their contacts. In one or more embodiments, the organization may distribute different training instructions, activities and communications to each of the management team, distributors and contacts.

In one or more embodiments, all or part of methods for training and teaching people (and/or all or part of systems which implement such methods), such as, for example, methods for training and teaching people 300, 300A, may be designed to be customized, flexible, and/or adaptable to meet the various needs of various users in various circumstances.

For example, FIG. 2C is a block diagram that depicts one embodiment of exemplary hardware architecture for systems implementing methods for teaching and training people, such as, methods for teaching and training people 300, 300A, that includes a network system 190 that operatively connects client systems 202, 204, 218, 226, server system 212, and databases 174, 176, as well as one or more websites 181 and/or mobile applications 183.

In one or more embodiments, client systems 202, 204, 218 may include client systems 100, 130, 150, 206, 208, 210, 220, 222, 224 as discussed above. In one or more embodiments, client system 226 may include client systems 228, 230, 232, which may include systems, components and/or configurations the same, similar and/or different to client systems 100, 130, 150, 206, 208, 210, 220, 222, 224. In one or more embodiments, server system 212 may include server systems 160, 180, 214 as discussed above. In one or more embodiments, websites 181 and/or mobile applications 183 may be stored on server system 212 and accessed, retrieved, downloaded and/or otherwise used by client systems 202, 204, 218, 226 from server system 212 via network system 190.

In one or more embodiments, client system 202 may be, for example, utilized by an organization to use all or part of methods for training and teaching people (and/or all or part of systems which implement such methods), such as, for example, methods for training and teaching people 300, 300A, including, for example, to develop, access, and/or otherwise use websites 181 and/or mobile applications 183 which may include some, none, and/or all of the following administrative privileges and/or capabilities as described above, including such that may apply to users associated with its customers and users/contacts managed by other users, as well as other privileges and/or capabilities not specifically listed herein.

In one or more embodiments, client system 204 may be, for example, utilized by an organization's customers to use all or part of methods for training and teaching people (and/or all or part of systems which implement such methods), such as, for example, methods for training and teaching people 300, 300A, including, for example, to develop, access, and/or otherwise use websites 181 and/or mobile applications 183 which may include some, none, and/or all of the following administrative privileges and/or capabilities as described above, including such that may apply to users associated with the customer and users/contacts managed by its users, as well as other privileges and/or capabilities not specifically listed herein.

In one or more embodiments, client system 218 may be, for example, utilized by a user associated with a particular customer (and who manages other users/contacts) to use all or part of methods for training and teaching people (and/or all or part of systems which implement such methods), such as, for example, methods for training and teaching people 300, 300A, including, for example, to develop, access, and/or otherwise use websites 181 and/or mobile applications 183 which may include some, none, and/or all of the following administrative privileges and/or capabilities, as well as other privileges and/or capabilities not specifically listed herein:
Setup and manage their respective user accounts and contact accounts, which may be customizable to their needs (such as, for example, entering and/or modifying their names, usernames, passwords, phone numbers, emails, addresses, billing information, trainings, goals, logins, up line/down line relationships, adding, editing and/or deleting users, managing relevant settings, etc.);
Purchase, receive, obtain, and/or otherwise use the goods/services provided by an organization;
Receive, access and/or otherwise use training instructions, activities and communications;
Use websites 181 and/or mobile applications 183;
Gather and track matrixes and information regarding their respective user and contact accounts (such as, for example, billing information, payment status, training progress, usage, goals, logins, up line/down line relationships, etc.);
Generate reports on matrixes and information regarding their respective user and contact accounts (such as, for example, reporting on a particular category of users/contacts, etc.);
Group and/or classify their respective users/contacts into various categories and subcategories;
Develop training instructions, activities and communications and manage relevant settings/parameters; and/or
Manage training instruction, activity and communication distribution (such as, determining the timing and sequence in which each training instructions, activities and communications may be distributed, etc.).

In one or more embodiments, client system 226 may be, for example, utilized by users/contacts who are managed by users associated with a particular customer to receive, access and/or otherwise use training instructions, activities and communications and/or purchase other goods/services provided by an organization; to use websites 181 and/or mobile applications 183; to setup and manage their respective accounts; and/or to otherwise use all or part of methods for training and teaching people (and/or all or part of systems which implement such methods), such as, for example, methods for training and teaching people 300, 300A.

In terms of data modeling, FIG. 2C may represent at least four levels of relationships—grandparent (e.g. the organization on client system 202), parent (e.g. the customer on client system 204), child (e.g. the users associated with the customer on client system 218) and grandchild (e.g. the contacts/other users on client system 226 who are managed by users associated with the customer). It is contemplated that the organization may have many customer's users and/or contacts who may use all or part of methods for training and teaching people (and/or all or part of systems which implement such methods), such as, for example, methods for training and teaching people 300, 300A, which are not represented in FIG. 2C. In one or more embodiments, each customer may have its own customized mobile application(s) 183.

In one or more embodiments, all or part of methods for training and teaching people (and/or all or part of systems which implement such methods), such as, for example, methods for training and teaching people 300, 300A, may include one or more websites 181 and/or mobile applications 183 wherein training topics, instructions, activities and/or communications and/or all or part of methods for training and teaching people (and/or all or part of systems which implement such methods), such as, for example, methods for training and teaching people 300, 300A, may be purchased, used, accessed, obtained, downloaded, viewed and/or otherwise interacted with via a network system (such as, for example, network system 190) via the Internet.

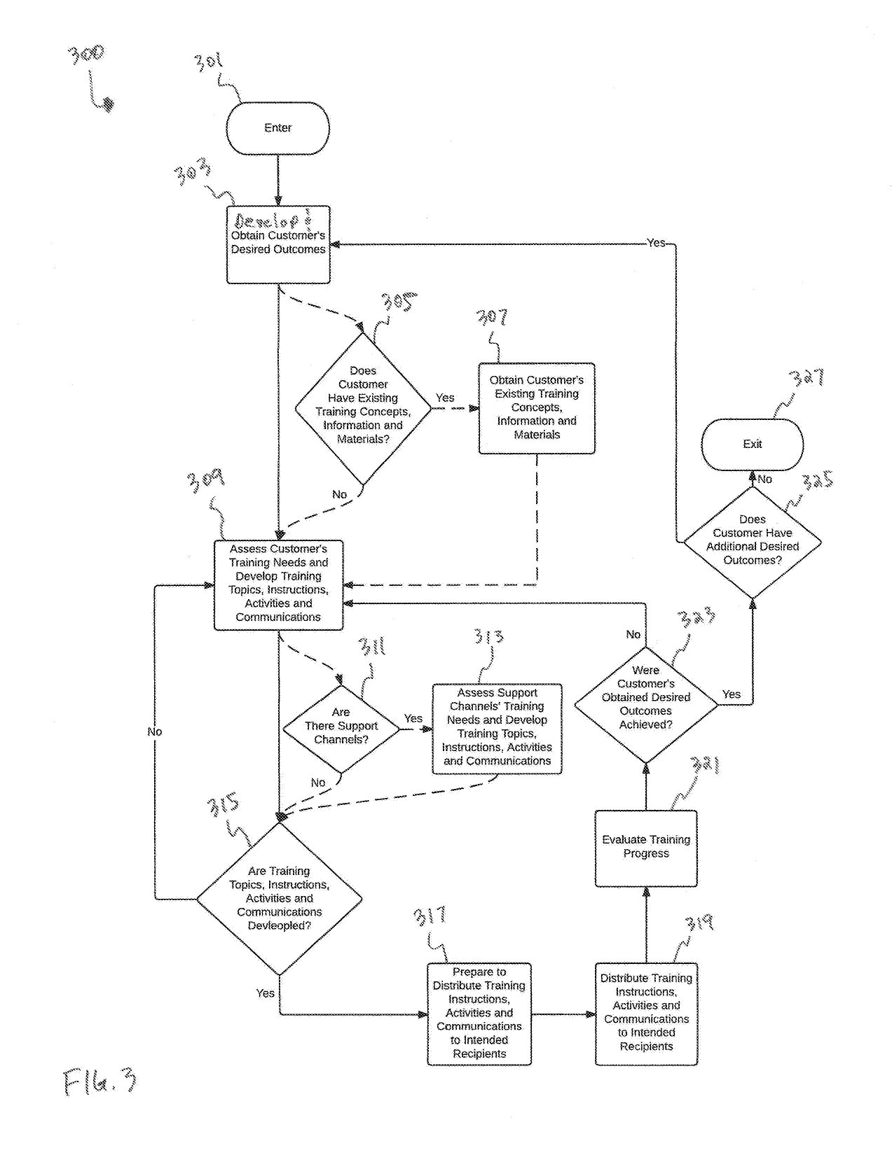

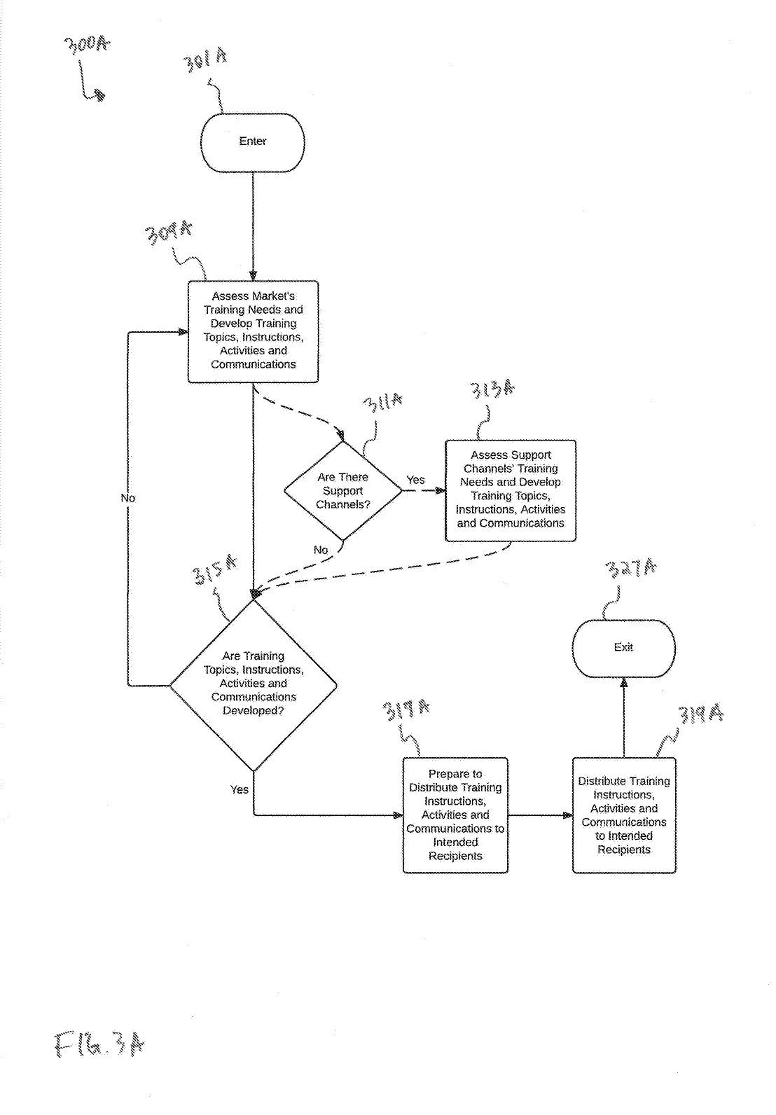

FIG. 3 is a flow diagram that depicts a method for teaching and training people 300 in accordance with one embodiment. In one or more embodiments, the method for teaching and training people as illustrated flow diagram FIG. 3 may be customized, flexible and adapted to various circumstances and situations. In one or more embodiments, in step 301, a user enters the process. (The term “user” denotes any person(s) and/or entity(ies) which uses, in any way, all or part of a method for training and teaching people (and/or all or part of a system which implements such a method), such as, for example, method for training and teaching people 300. For example, in one or more embodiments, an organization may use this disclosure in providing goods/services to its customers. The organization may, in one or more embodiments, be hired by a customer to help teach and training its employees/agents on how to improve a particular skill. In addition, in one or more embodiments, perhaps the customer is a sales company wherein each sales agent has certain contacts. In such an example, the term “user” may include all individuals from the organization and its customers who use, in any way, all or part of a method for training and teaching people (and/or all or part of a system which implements such a method), such as, for example, method for training and teaching people 300, as well as the contacts who use, in any way, all or part of a method for training and teaching people (and/or all or part of a system which implements such a method), such as, for example, method for training and teaching people 300. Furthermore, users may have different privileges and/or capacities granted to them with regards to the disclosure. For example, an upper management team may have more privileges and/or capacities than a lower level management team.)

In one or more embodiments, all or part of a method for training and teaching people (and/or all or part of a system which implements such a method), such as, for example, method for training and teaching people 300, may enable users to register. For example, in one or more embodiments, users may register individually (such as, for example, in a situation where a customer wants its employee to register individually and/or where a user may be responsible for paying a fee associated with using the disclosure). Alternatively, in one or more embodiments, users may be registered in groups (such as, for example, via importing information about groups of users via a database and/or a Microsoft Excel file containing user names, email addresses, phone numbers and/or any other pertinent information).

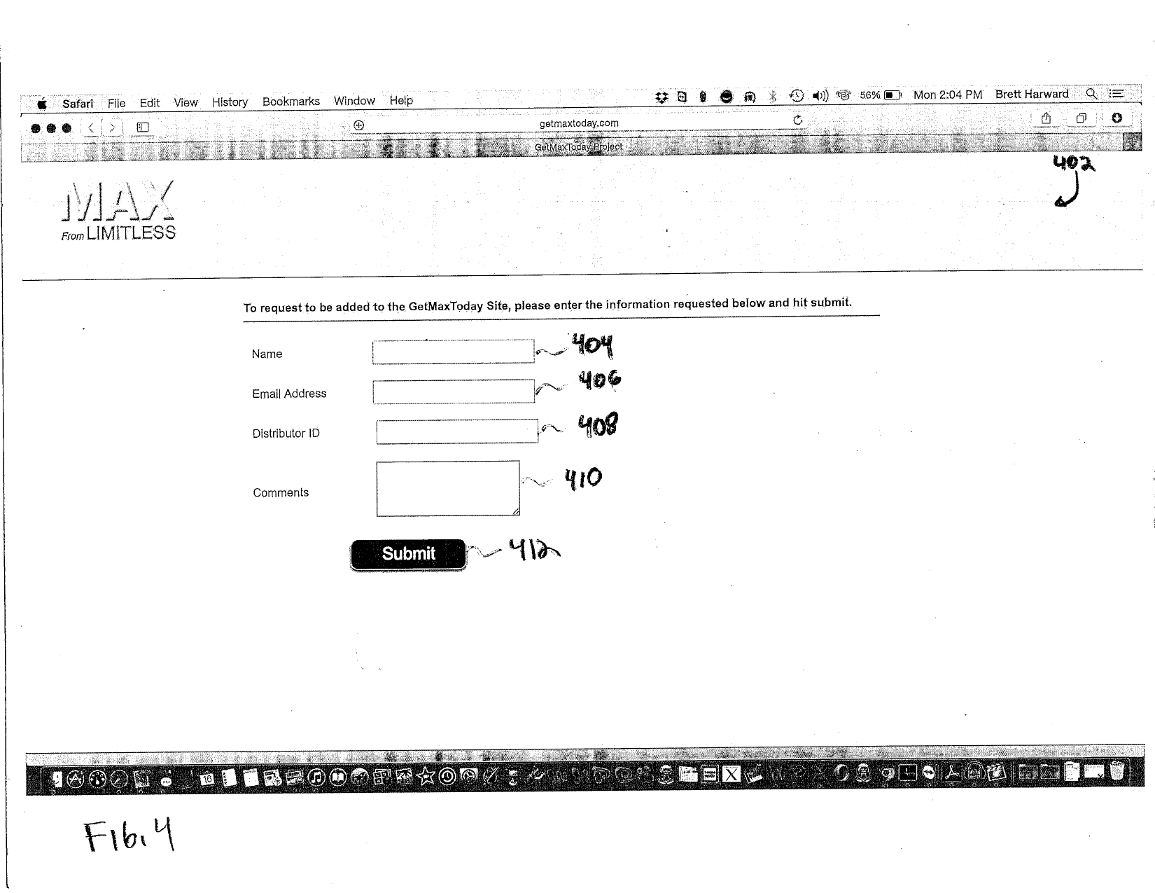

FIG. 4 through FIG. 10 are screenshots that depict one or more embodiment of aspects of a registration and/or payment process for a system implementing a method for teaching and training people, such as, method for teaching and training people 300 and the appearance, functionality and features of such may vary greatly while still remaining true to the spirit and principles of this disclosure.

For example, in one or more embodiments, referring to FIG. 4, all or part of a method for training and teaching people (and/or all or part of a system which implements such a method), such as, for example, method for training and teaching people 300, may include registration landing page 402 located on a website where users may register. Registration landing page 402 may be accessible, for example, via a client systems 100, 130. Registration landing page 402 may allow users to enter, such things as, for example: its/his/her name (such as, for example, in “Name” text field 404); email address (such as, for example, in “Email Address” text field 406); distributor identification number, if any, (such as, for example, in “Distributor ID” text field 408); and/or comments (such as, for example, in “Comments” text field 410); and submit said information for registration (such as, for example, via clicking “Submit” button 412).

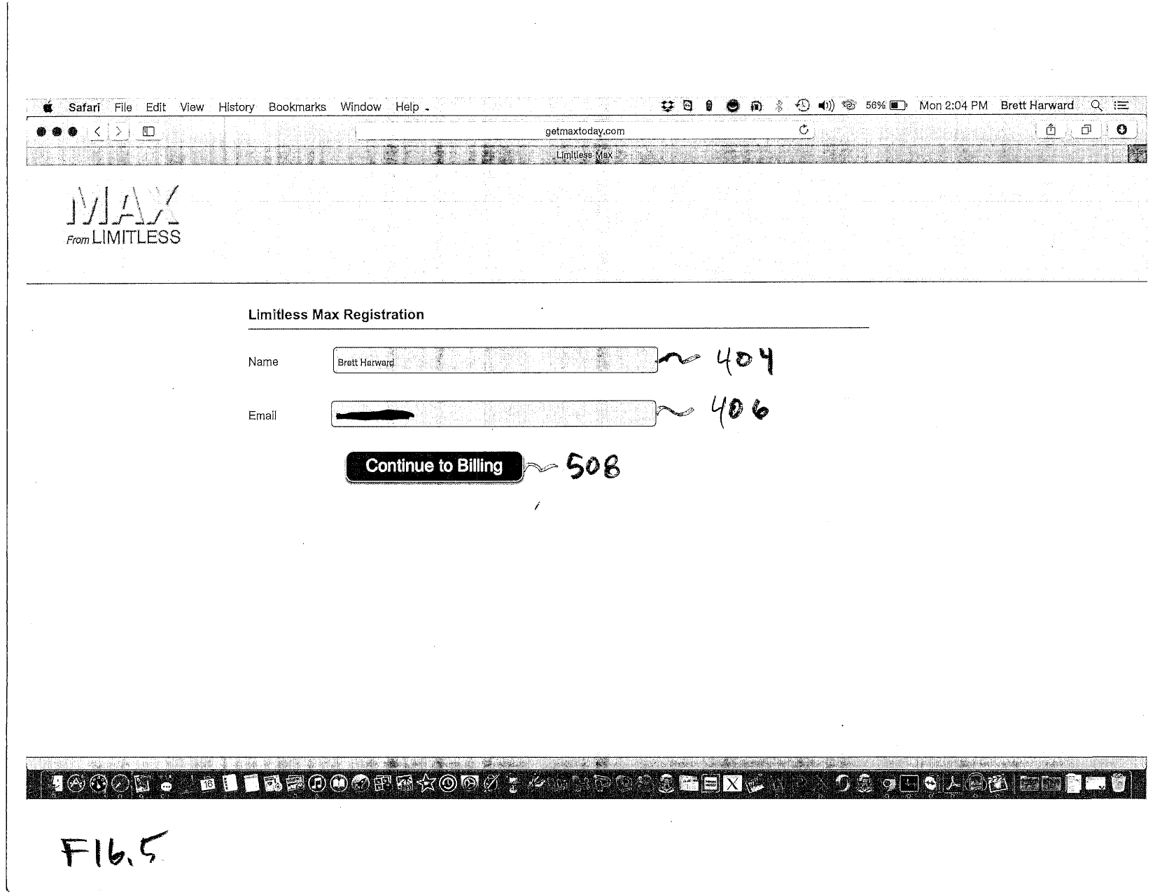

In one or more embodiments, all or part of a method for training and teaching people (and/or all or part of a system which implements such a method), such as, for example, method for training and teaching people 300, may be designed to allow users to enter billing information and/or make payments. For example, in one or more embodiments, referring to FIG. 5 through FIG. 9, all or part of a method for training and teaching people (and/or all or part of a system which implements such a method), such as, for example, method for training and teaching people 300, may allow customers and/or users to select certain billing options. In one or more embodiments, in FIG. 5, after registering (via entering the certain information (404, 406, etc.) and then clicking “Submit” button 412, as illustrated in FIG. 4) a user may log into the computing system by entering its/his/her name in “Name” text field 404 and email address in “Email” text field 406 (which may be the same as initially entered when registering but which may be changed) and then clicking “Continue to Billing” button 508.

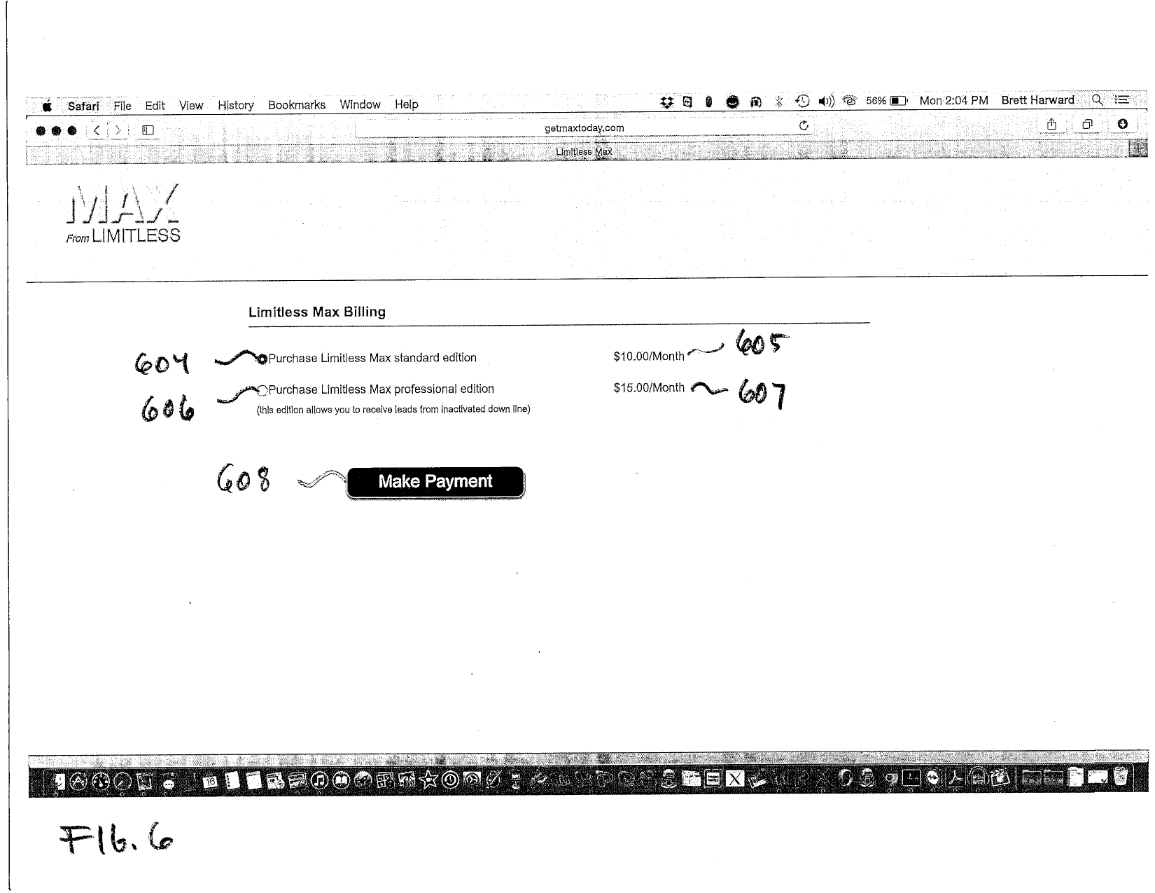

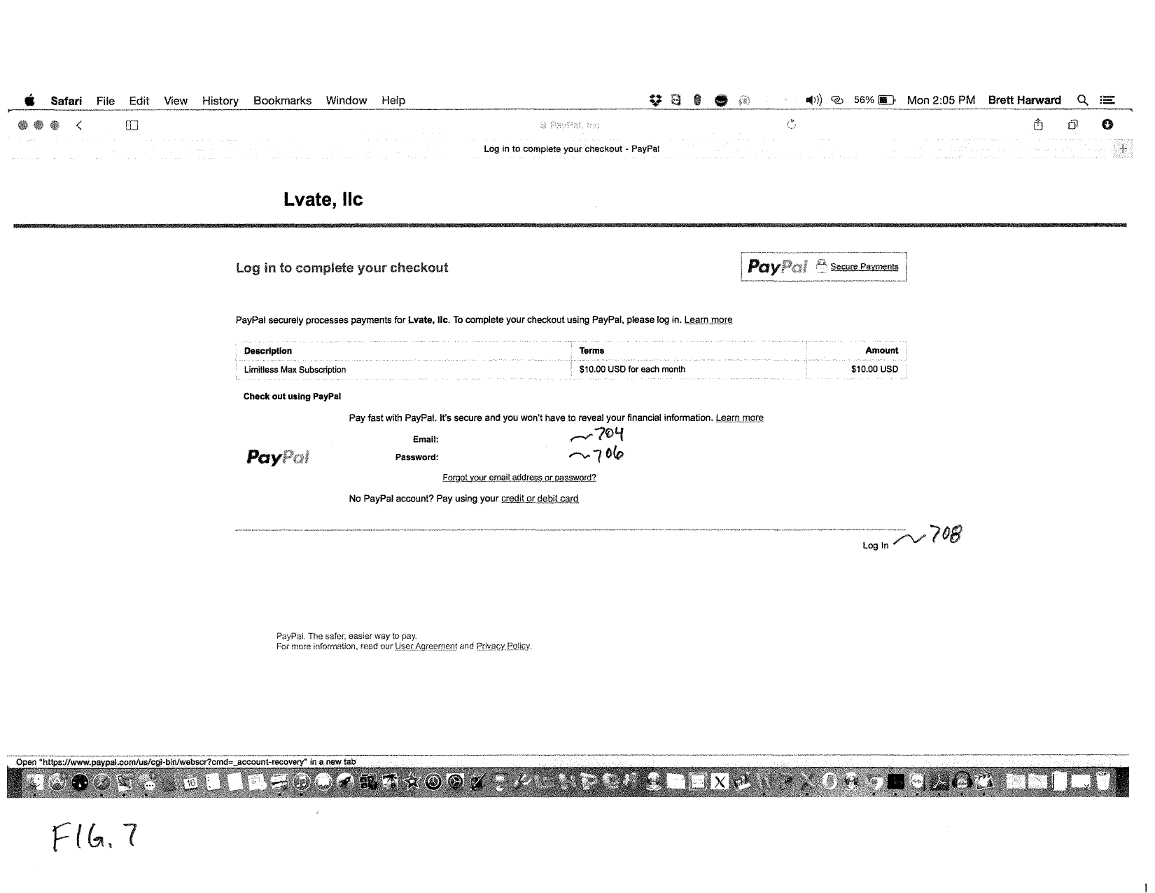

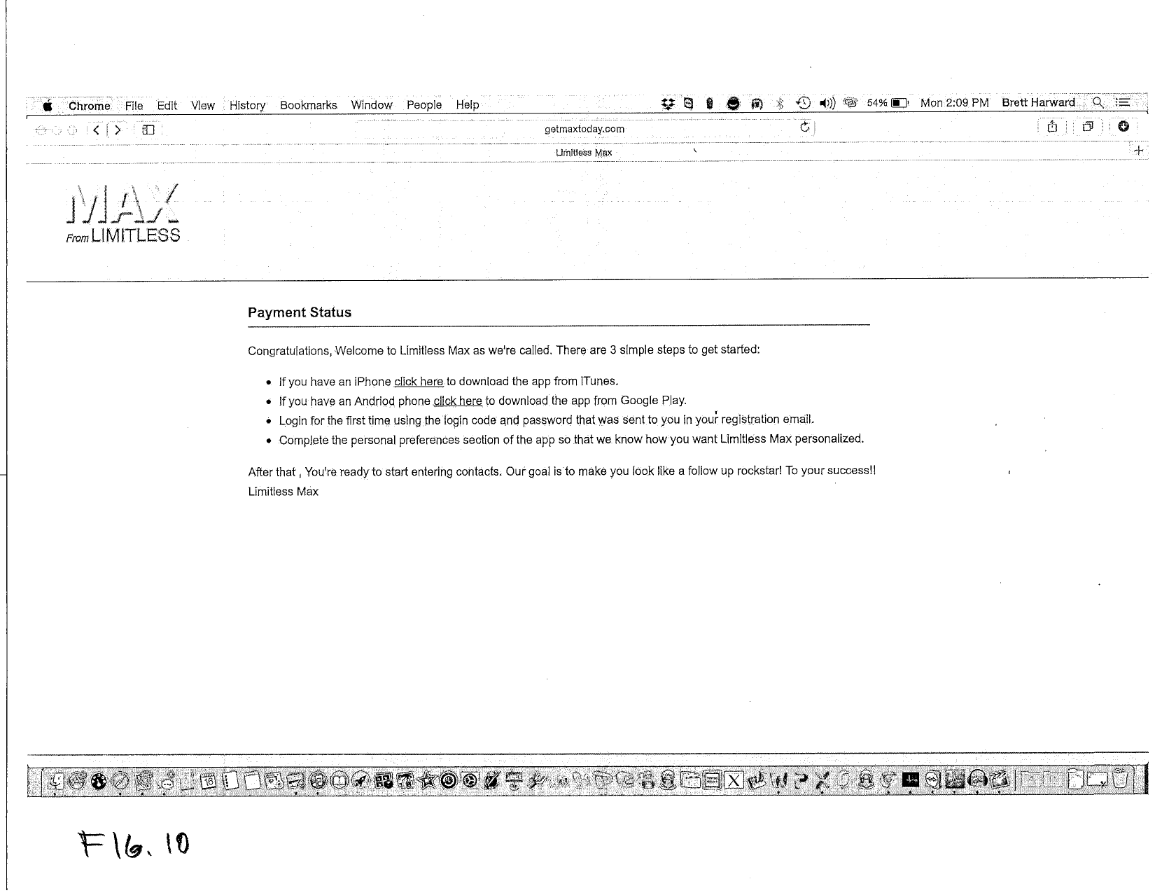

In one or more embodiments, all or part of a method for training and teaching people (and/or all or part of a system which implements such a method), such as, for example, method for training and teaching people 300, may send a confirmation registration email to the user's email address and a login code and password; may allow a user to select the products and/or services available, such as, for example, illustrated in FIG. 6. In one or more embodiments, in FIG. 6 a user may select from two available services by clicking one of radio buttons (604, 606). The fee amounts and/or frequency of payments due may be displayed (605, 607). In one or more embodiments, other products and/or services may be available from time to time and/or depending on the user. In one or more embodiments, after selecting the desired products and/or services, a user may then make a payment, such as, for example, by clicking “Make Payment” button 608, wherein a variety of type of payment may be accepted, including, for example, payment made by credit card, debit card, electronic transfer, outline account, and/or other form of payment, whether developed later or known at the time of filing. For example, in one or more embodiments, in FIG. 7 a user may pay by means of PayPal, wherein users may log into their outline account, such as, for example, PayPal, by, for example, entering in the customer's and/or user's email address in text field 704 and password in text field 706, and then logging into PayPal by clicking “Login” button 708. In one or more embodiments, referring to FIG. 10, once a payment type has been may, all or part of a method for training and teaching people (and/or all or part of a system which implements such a method), such as, for example, method for training and teaching people 300, may send a confirmation email confirming the registration and/or otherwise indicate the next steps to be taken, such as, for example, to download a customer's mobile application.

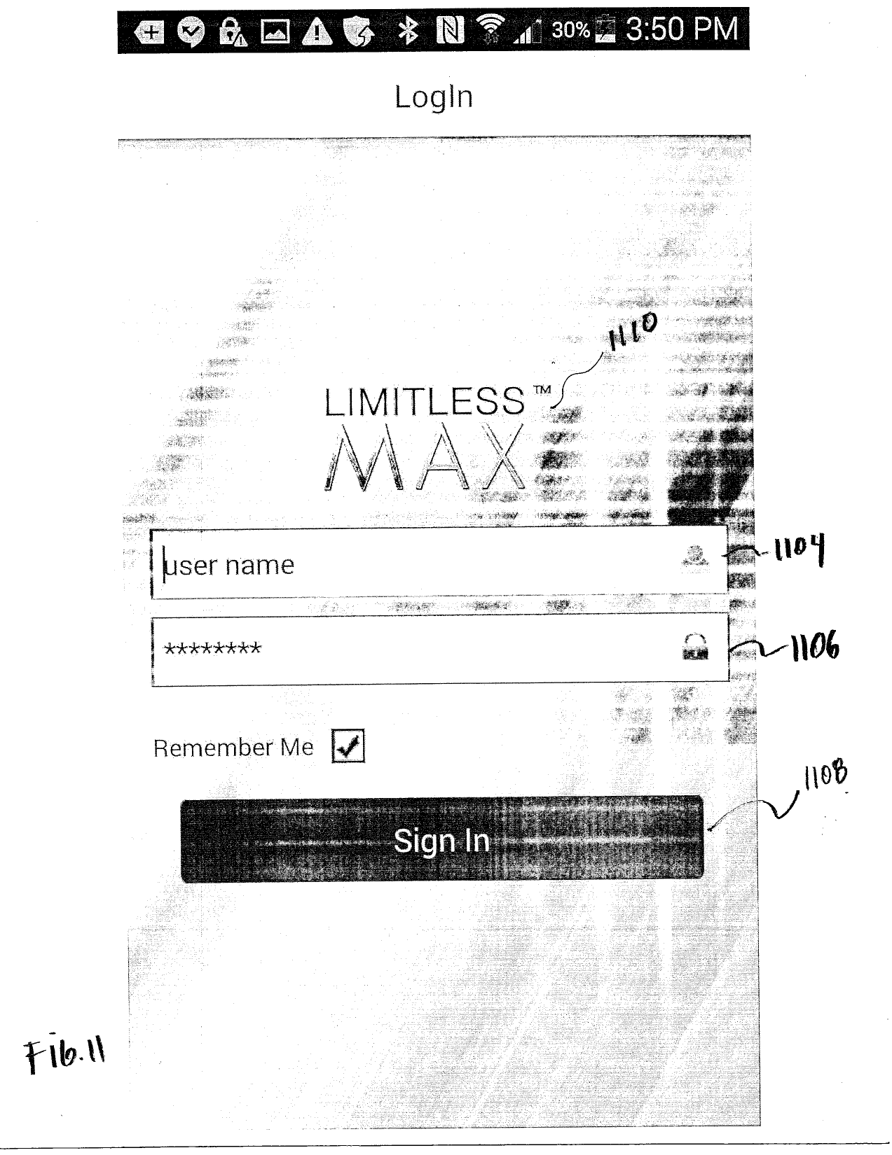

In one or more embodiments, all or part of a method for training and teaching people (and/or all or part of a system which implements such a method), such as, for example, method for training and teaching people 300, may be designed to include one or more mobile applications. In one or more embodiments, each customer may have a private label mobile application available to its users. In one or more embodiments, one or more mobile applications may:
Be downloadable to any mobile device (such as, for example, smartphones, tablets, etc.), whether developed later or known at the time of filing;
Be associated with a particular customer and linked to that customer's account;
Be customized to each customer's needs and/or branded to their marketing strategy (such as, for example, a customer's mobile application may display the customer's logo, company name, colors, etc., such as, for example, illustrated in FIG. 11, which displays “LIMITLESS MAX” label 1110);
Allow users to interact with the training instructions, activities and communications;
Allow users to setup and manage their respective account information and settings (such as, for example, name, email, street address, city, state, zip code, etc.);
Allow users to classify other users and/or contacts into categories and subcategories;
Allow users to interact with other users and/or contacts (such as, for example, communicating with user contacts via email, phone calls, text, etc.);
Allow users to schedule/calendar tasks to be accomplished (such as, for example, communication to occur with other users and/or contacts);
Allow users to track the progress of other users and/or contacts;
Provide users lists of items to accomplish (such as, for example, daily, weekly and/or monthly to do's, and/or all events scheduled) and when (such as, for example, dates and/or times the items are scheduled to be accomplished);
Allow users to set goals, track results and/or generate reports; and/or
Allow users to obtain technical support.

FIG. 11 through FIG. 29 are screenshots which depict one or more embodiments of aspects of an exemplary mobile application 183 for a system implementing a method for teaching and training people, such as, method for teaching and training people 300 and the appearance, functionality and features of such may vary greatly while still remaining true the spirit and principles of this disclosure.

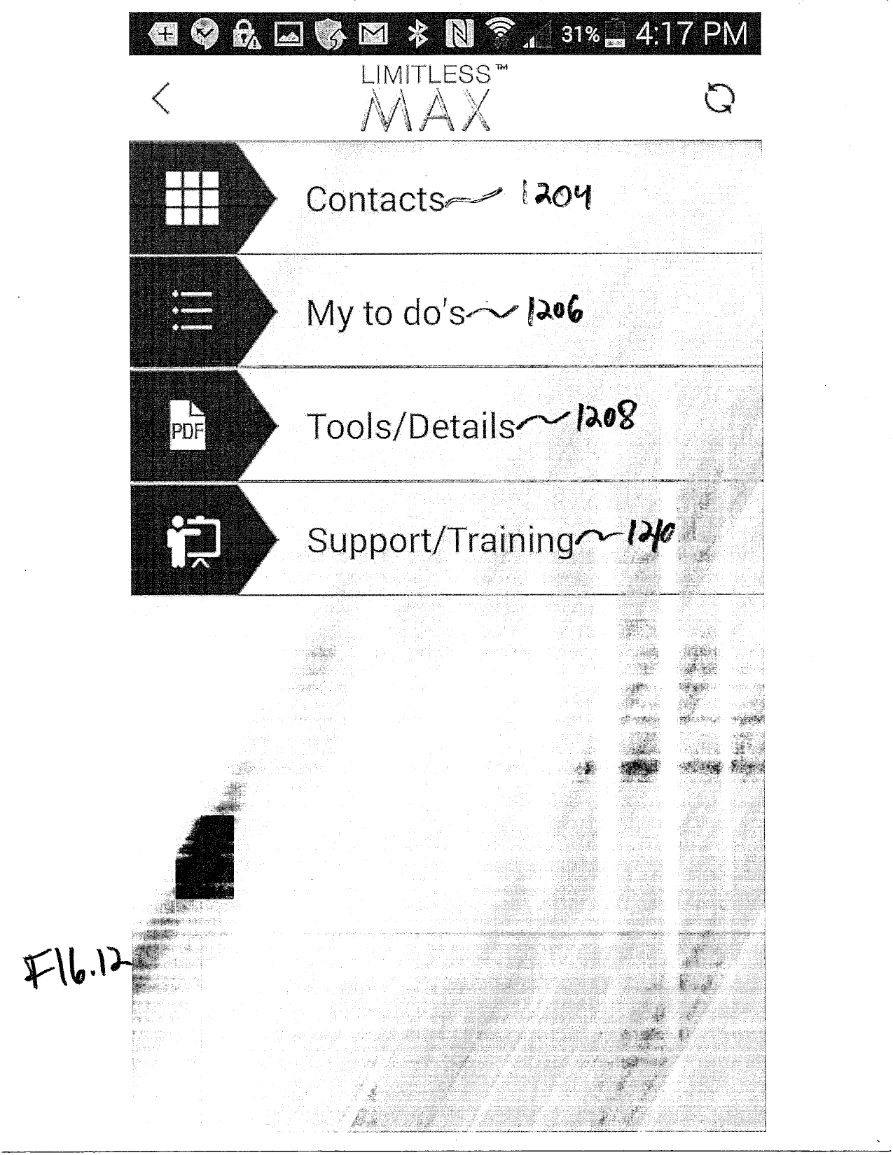

In one or more embodiments, mobile application 183 may allow users to sign in by entering a user name and password in the applicable text fields (1104, 1106) and then clicking on “Sign In” button 1108. In one or more embodiments, after signing into mobile application 183, mobile application 183 may provide a menu of options a user may select from, including, for example, retrieving a user's contacts, a list of items to accomplish, certain tools and/or certain support and trainings and a variety of other menu options designed to meet user needs and/or a customer's desired outcomes. For example, in one or more embodiments, referring to FIG. 12, a user may click on “Contacts” menu option 1204, “My to do's” menu option 1206, “Tools/Details” menu option 1208, and/or “Support/Training” menu option 1210.

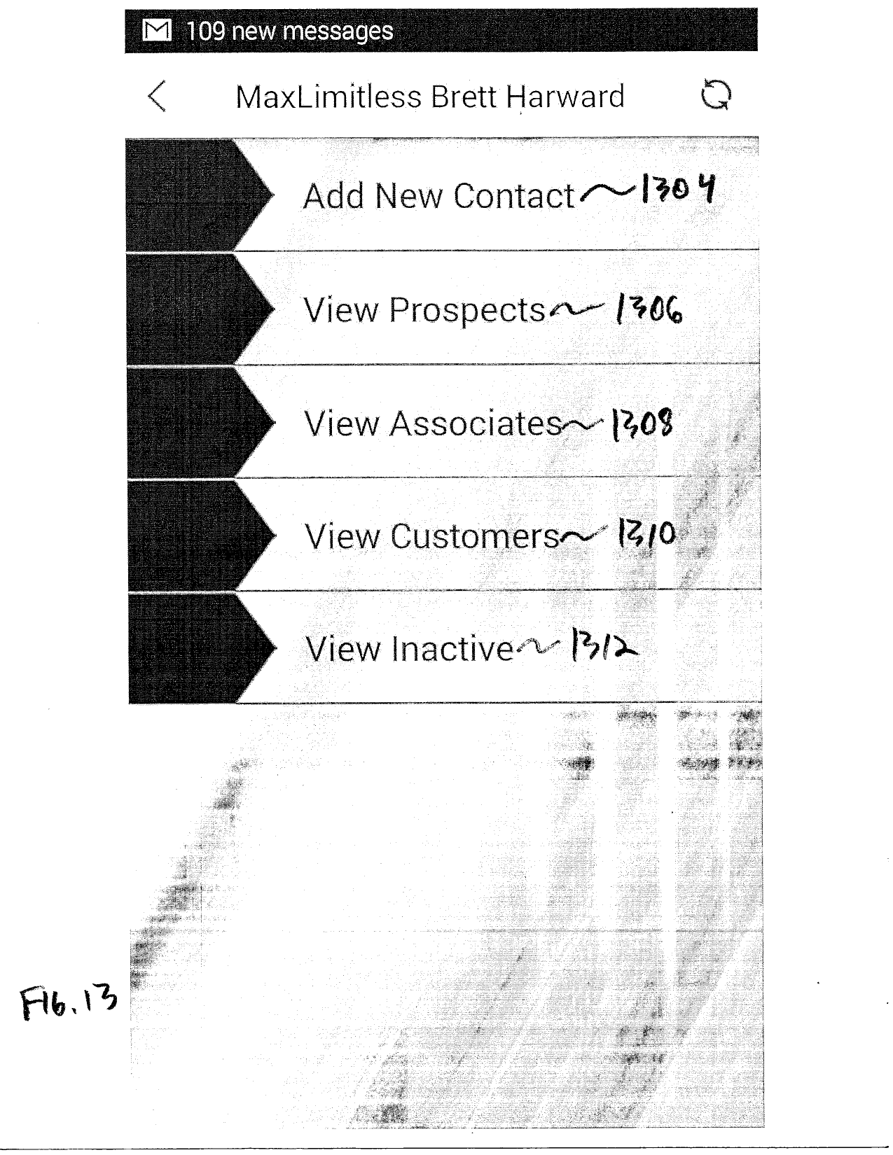

In one or more embodiments, by clicking on “Contacts” menu option 1204, mobile application 183 may direct a user to a menu providing various menu options pertaining to contacts, such as, for example, in the case of a multilevel marketing company, adding new contacts, viewing prospects, associates, and/or customers and viewing individuals who have been inactivated. For example, in one or more embodiments, referring to FIG. 13, mobile application 183 may allow a user to click on “Add New Contact” menu option 1304, “View Prospects” menu option 1306, “View Associates” menu option 1308, “View Customers” menu option 1310, and/or “View Inactive” menu option 1312.

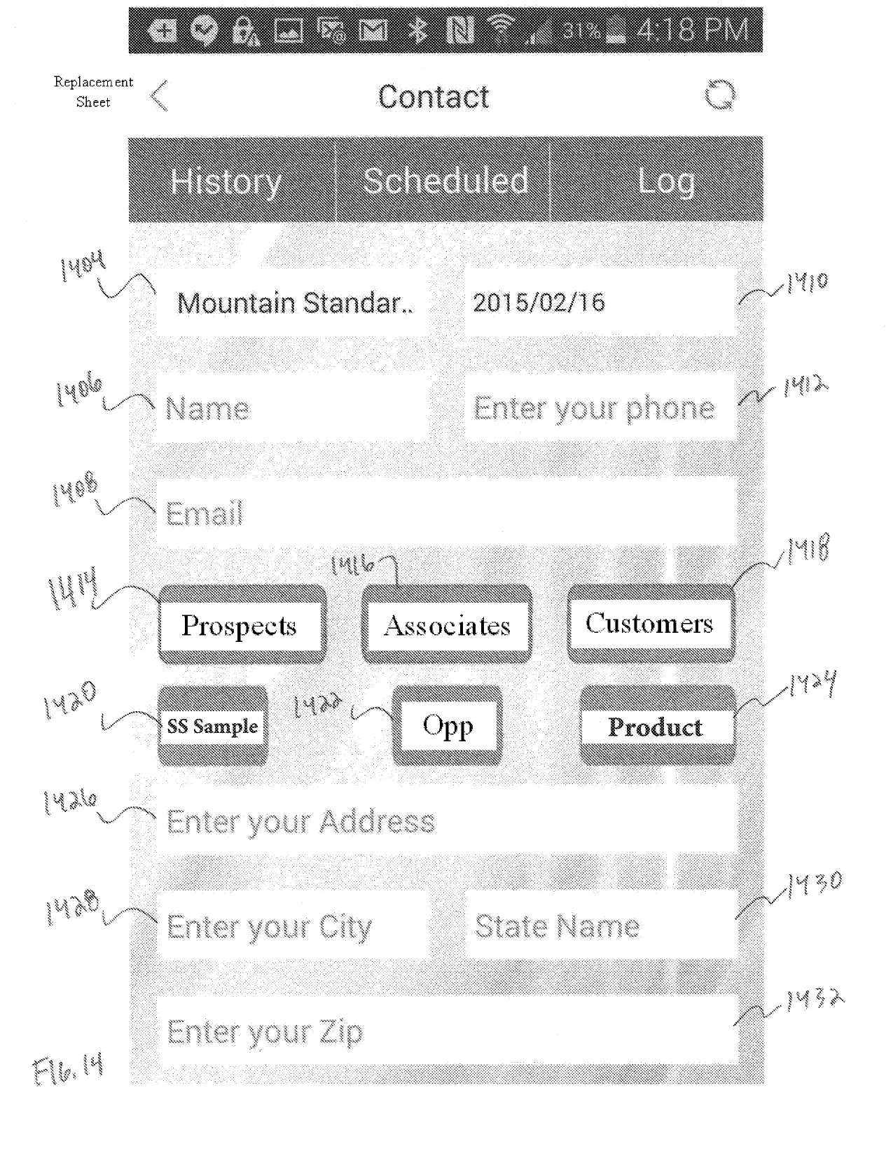

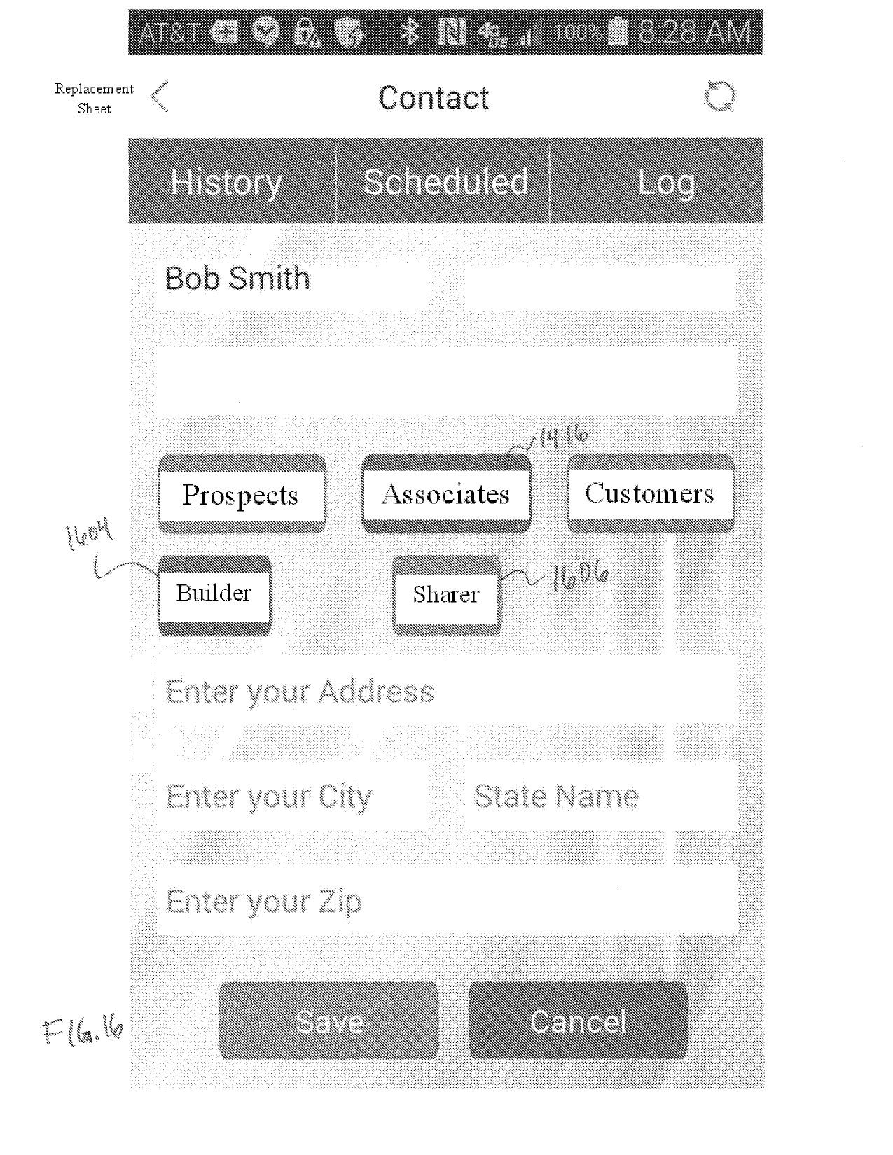

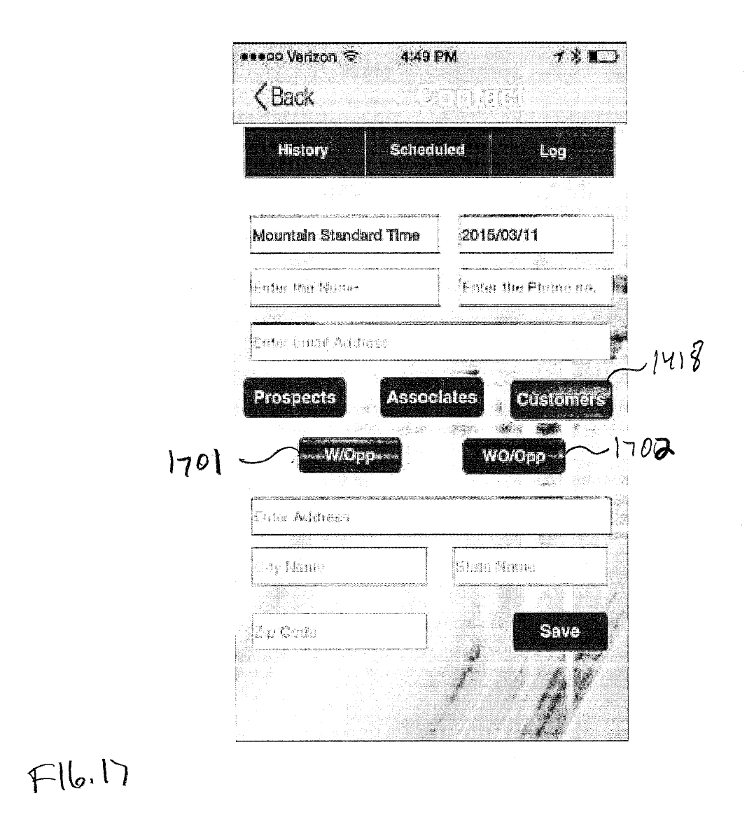

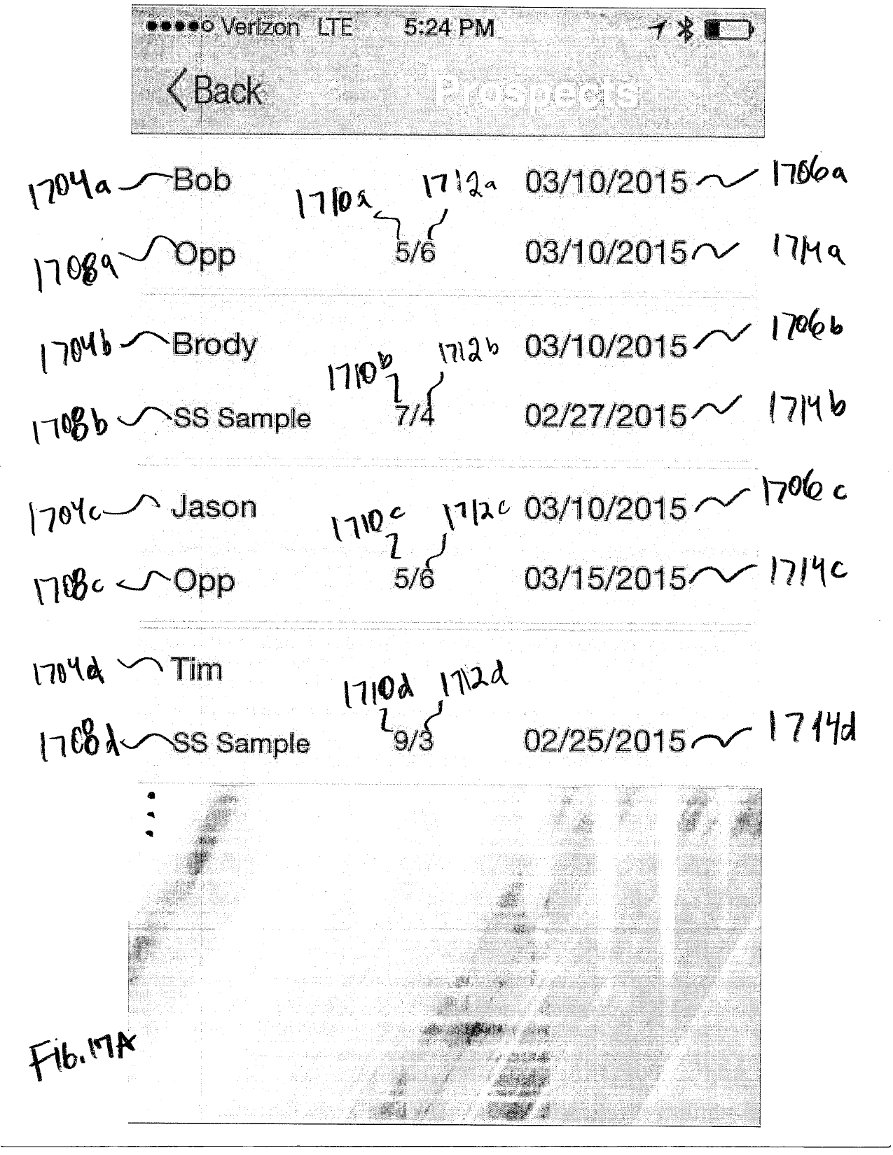

In one or more embodiments, by clicking on “Add New Contact” menu option 1304, mobile application 183 may direct a user to a menu providing various menu options pertaining to adding new contacts, such as, for example, entering a new contact's name, address, phone number, email, time zone, a description of the new contact's status, and/or any other relevant attribute. For example, in one or more embodiments, referring to FIG. 14, in the case of a multilevel marketing company, mobile application 183 may allow a user to select the contact's time zone by clicking on “Mountain Standard Time” text field 1404; to enter in the contact's name, email address, phone number, street address, city, state and/or zip code by typing the same into “Name” text field 1306, “Email” text field 1408, “Enter you phone” text field 1412, “Enter you Address” text field 1426, “Enter you City” text field 1428, “State Name” text field 1430, and/or “Enter your Zip” text field 1432, respectively; to enter in the date the contact information may be entered into mobile application 183 by entering it into text field 1410; and/or to select a category describing the contacts, such as, for example, in a case involving a multilevel marketing company, as a prospect by clicking on “Prospects” button 1414, as an associate by clicking on “Associates” button 1416, and/or as a customer by clicking on “Customers” button 1418. In one or more embodiments, various categories describing the contacts may be broken down into subcategories. For example, in one or more embodiments, in FIG. 14, FIG. 16 and FIG. 17, “SS Sample” button 1420, “Opp” button 1422, and “Product” button 1424 may be subcategories to the prospects category and automatically appear when a user clicks on “Prospects” button 1414; “Builder” button 1604 and “Sharer” button 1606 may be subcategories to the associates category and automatically appear when a user clicks on “Associates” button 1416; and “W/Opp” button 1701 and “WO/Opp” button 1702 may be subcategories to the customers category and automatically appear when a user clicks on “Customers” button 1418.

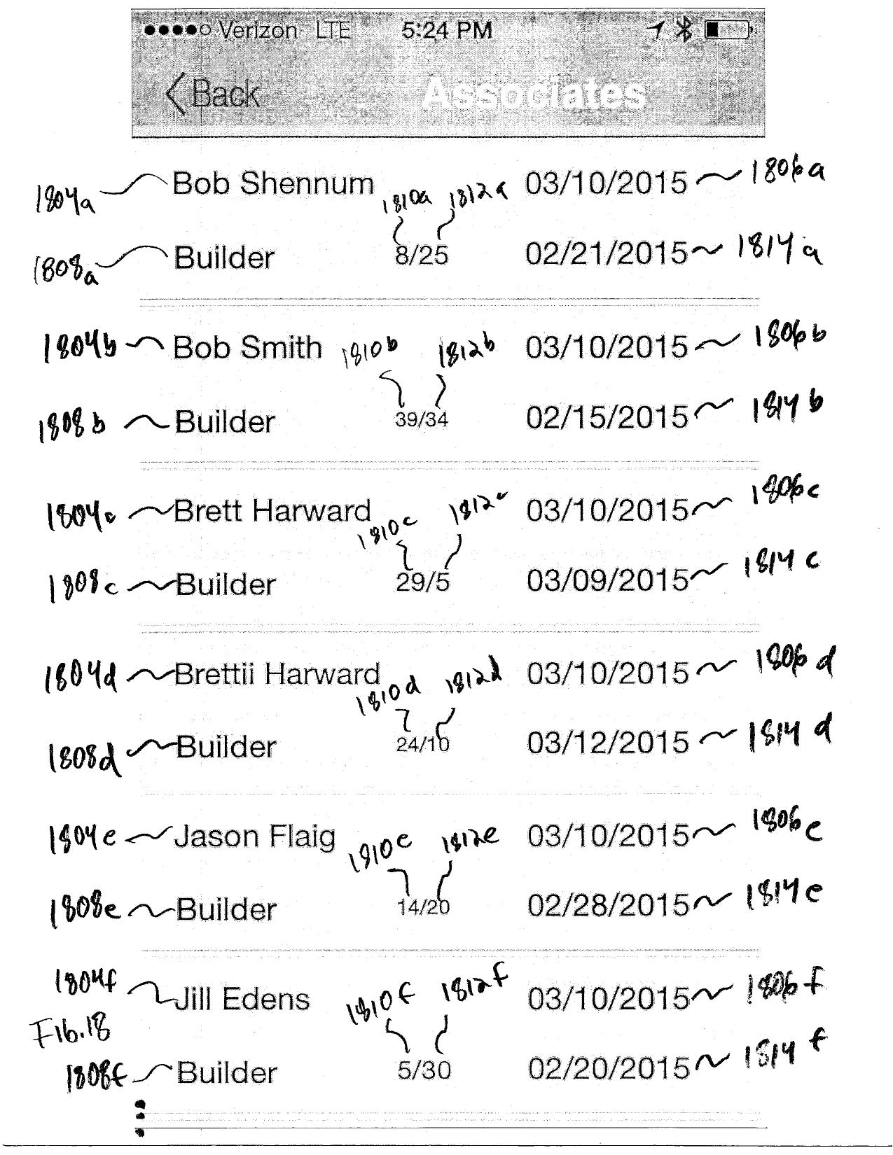

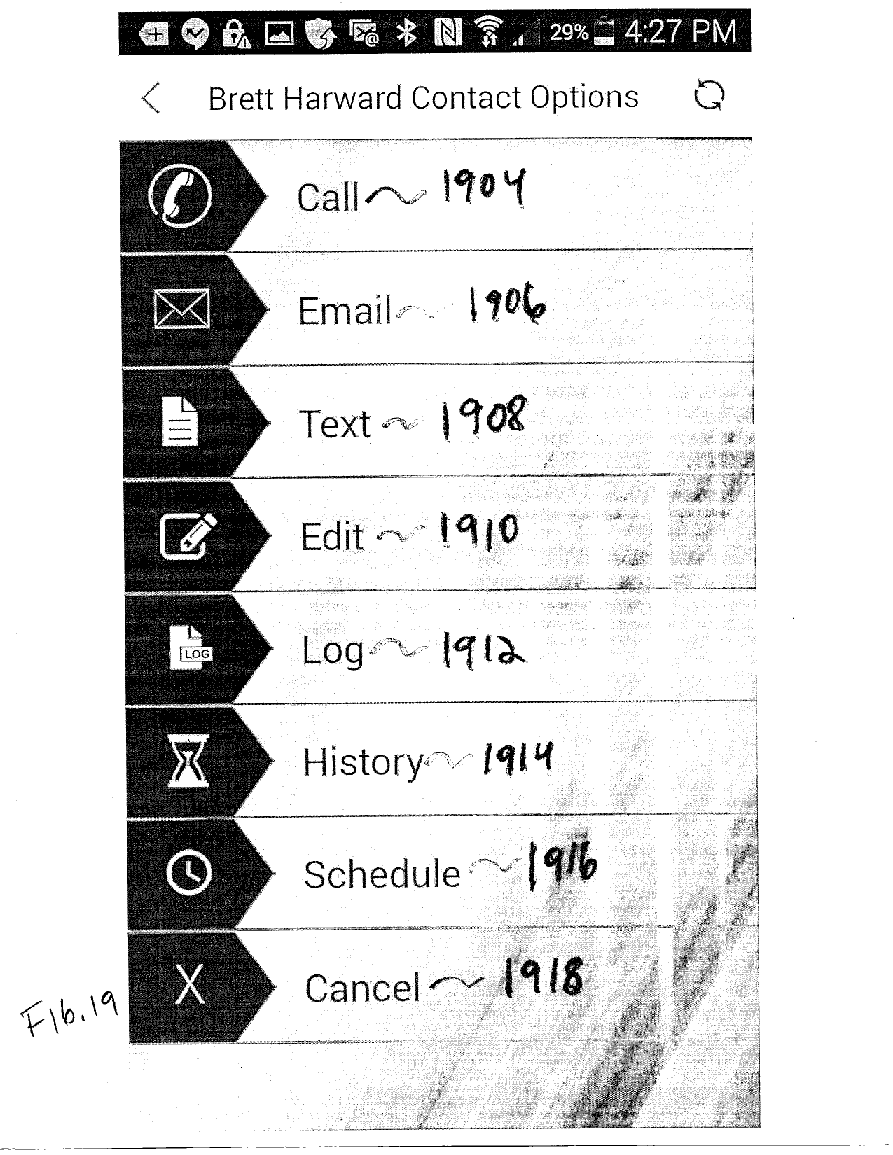

Returning to FIG. 13, in one or more embodiments, by clicking on “View Prospects” menu option 1306, “View Associates” menu option 1308, “View Customers” menu option 1310, and/or “View Inactive” menu option 1312, mobile application 183 may, for example, in one or more embodiments, display contacts entered into all or part of a method for training and teaching people (and/or all or part of a system which implements such a method), such as, for example, method for training and teaching people 300 (such as, for example, contacts categorized as a prospect, associate and/or customer). For example, in one or more embodiments, after selecting “View Prospects” menu option 1306, mobile application 183 may display: (i) a list of prospects and their relevant information, such as, for example, as illustrated in FIG. 17A, a prospect's name (1704a, 1704b, 1704c, 1704d); a date the associate was first entered into the computing system (1706a, 1706b, 1706c); a subcategory (1708a, 1708b, 1708c, 1708d) associated with the associate (such as, for example “Opp” (1708a, 1708c) “SS Sample” (1708b, 1708d) and/or “Product”); the number of trainings completed (1710a, 1710b, 1710c, 1710d); and/or the number of trainings to be completed (1712a, 1712b, 1712c, 1712d) by the associate and/or an event date (1714a, 1714b, 1714c, 1714d). For example, in one or more embodiments, after selecting “View Associates” menu option 1308, mobile application 183 may display: (i) a list of associates and their relevant information, such as, for example, as illustrated in FIG. 18, an associate's name (1804a, 1804b, 1804c, 1804d, 1804e, 1804f); a date the associate was first entered into the computing system (1806a, 1806b, 1806c, 1806d, 1806e, 1806f); a subcategory (1808a, 1808b, 1808c, 1808d, 1808e, 1808f) associated with the associate; the number of trainings completed (1810a, 1810b, 1810c, 1810d, 1810e, 1810f); and/or the number of trainings to be completed (1812a, 1812b, 1812c, 1812d, 1812e, 1812f) by the associate and/or an event date (1814a, 1814b, 1814c, 1814d, 1814e, 1814f). A mobile application may, for example, in one or more embodiments, allow a user to perform a number of functions in relation to contacts entered into all or part of a method for training and teaching people (and/or all or part of a system which implements such a method), such as, for example, method for training and teaching people 300 (such as, for example, contacts categorized as a prospect, associate and/or customer). For example, in one or more embodiments, in FIG. 19, mobile application 183 may allow a user to call a contact by clicking on “Call” menu option 1904, to email a contact by clicking on “Email” menu option 1906, and/or to text a contact by clicking on “Text” menu option 1908; edit a contact's information (such as, for example, information entered as illustrated in FIG. 14, FIG. 16, and/or FIG. 17) by clicking on “Edit” menu option 1910; schedule/calendar a communication event with a contact by clicking on “Log” menu option 1912; review the history of communications with a contact by clicking on “History” menu option 1914; determine which communications are scheduled/calendared to occur in the future by clicking on “Schedule” menu option 1916; and/or any other function needed.

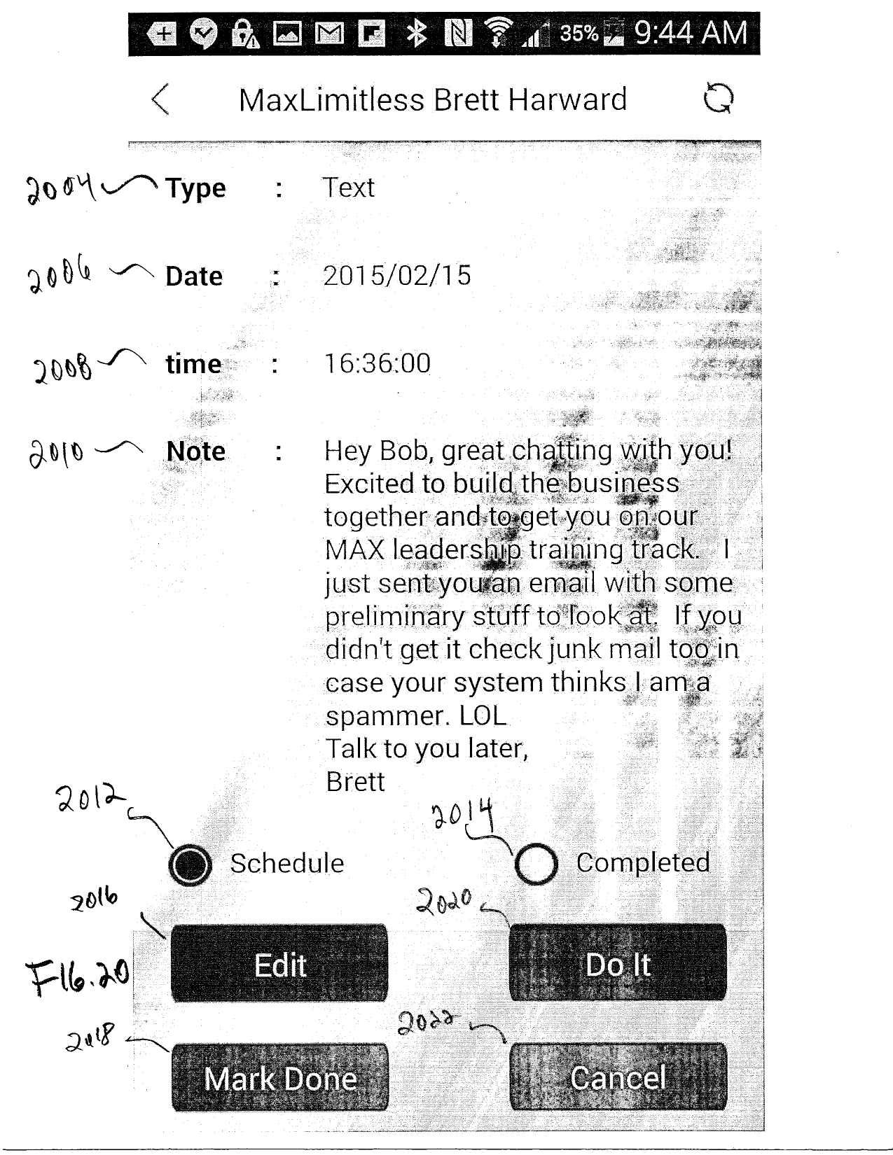

In one or more embodiments, scheduling/calendaring a communication event with a contact by clicking on “Log” menu option 1912, may include such things, for example, as illustrated in FIG. 20, a user may select the type of a communication by selecting “Type” menu option 2004, (such as, for example, text, email, phone call, conference call, etc.), the date of a communication by selecting “Date” menu option 2006, and/or the time of a communication by selecting “time” menu option 2008; and/or other functionality, such as, for example, drafting a note (2010) regarding communication, marking the communication to be scheduled (2012), complete (2014), and/or editing (2016), marking done (2018), canceled (2022) and/or to do it (2020).

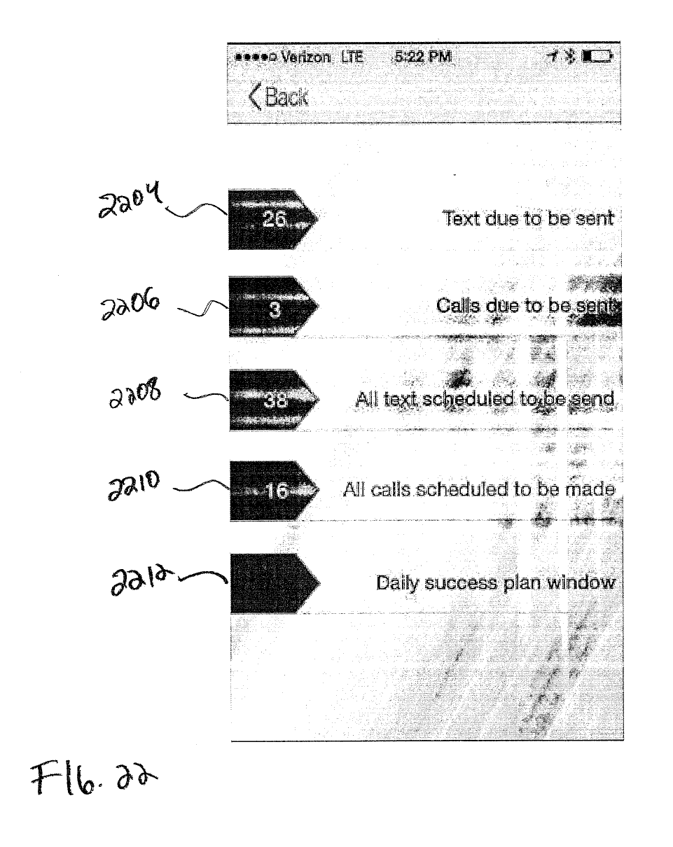

Returning to FIG. 12, in one or more embodiments, by clicking on “My to do's” menu option 1206, mobile application 183 may direct a user to a menu providing various menu options pertaining to items scheduled to be done, such as, for example, text messages to be sent, calls to be made, emails to be sent, in-person communications to be made, daily goals and plans, etc. For example, in one or more embodiments, referring to FIG. 22, a user may review the total number of scheduled text messages to be sent by clicking on “All text scheduled to be sent” menu option 2208; review scheduled text messages by clicking on “Text due to be sent” menu option 2204; review the total number of scheduled calls to be made by clicking on “All calls scheduled to be made” menu option 2210; and/or review the script and/or matters to be discussed in each particular scheduled call by clicking on “Calls due to be made” menu option 2206. In one or more embodiments, after selecting a particular communication, a user may then modify the communication as illustrated, for example, in FIG. 20.

In one or more embodiments, mobile application 183 may provide a user the ability to review all communications scheduled with all contacts for any particular day selected. For example, in one or more embodiments, in FIG. 22, a user may click on “Daily Success Plan” menu option 2212, mobile application 183 may display all communications scheduled with all contacts for any particular day selected, including: the date selected 2304 (the then current date may be the default); the option to select different dates (2306, 2308); a list of each communication 2312a, 2312b, 2312c, 2312d, etc. for the date selected 2304; the name of the contact 2310a, 2310b, 2310c, 2310d, etc. for which each communication is intended; the time 2314a, 2314b, 2314c, 2314d, etc. in which each communication is scheduled to occur; whether the communication has been completed (such as, for example, completed communications may be marked with a checkmark, 2316c and uncompleted communications may be blank 2316a, 2316b, 2316d); and/or the option to view the actual communication 2320, such as via toggle buttons 2318a, 2318b, 2318c, 2318d, etc.

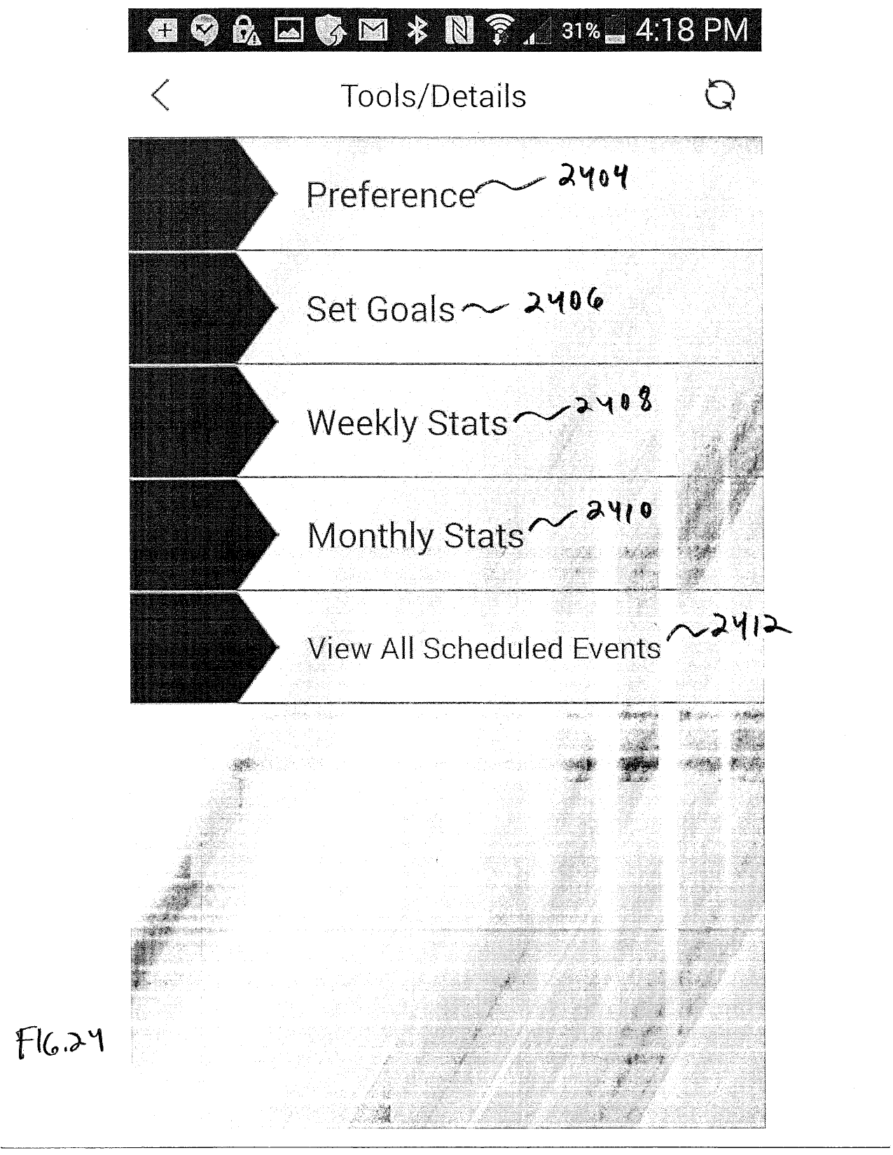

Returning to FIG. 12, in one or more embodiments, by clicking on “Tools/Details” menu option 1208, mobile application 183 may direct a user to a menu providing various menu options pertaining to such things as, for example, account preferences, goals, statistics, scheduled events, etc. For example, in one or more embodiments, referring to FIG. 24, a user may review and/or update his/her: (i) account preferences by clicking on “Preference” menu option 2404; (ii) goals by clicking on “Set Goals” menu option 2406; (iii) weekly statistics by clicking on “Weekly Stats” menu option 2408; (iv) monthly statistics by clicking on “Monthly Stats” menu option 2410; and (v) all events scheduled by clicking on “View All Scheduled Events” menu option 2412.

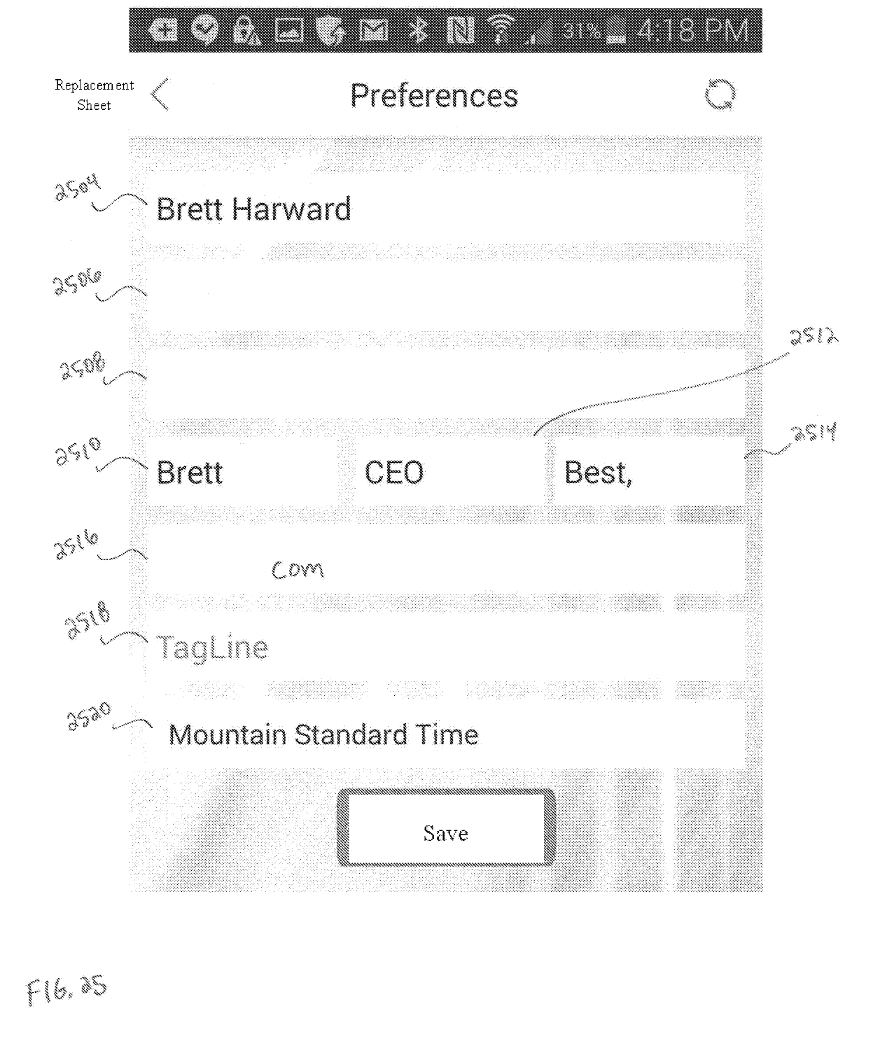

In one or more embodiments, by clicking on “Preference” menu option 2404, mobile application 183 may display and/or allow a user to update such things as, for example, in one or more embodiments, referring to FIG. 25, his/her name (2504), phone number (2506), email address (2508), signature name 2510, title (2512), closing name (2514), website (2516), tagline (2518), and/or time zone (2520).

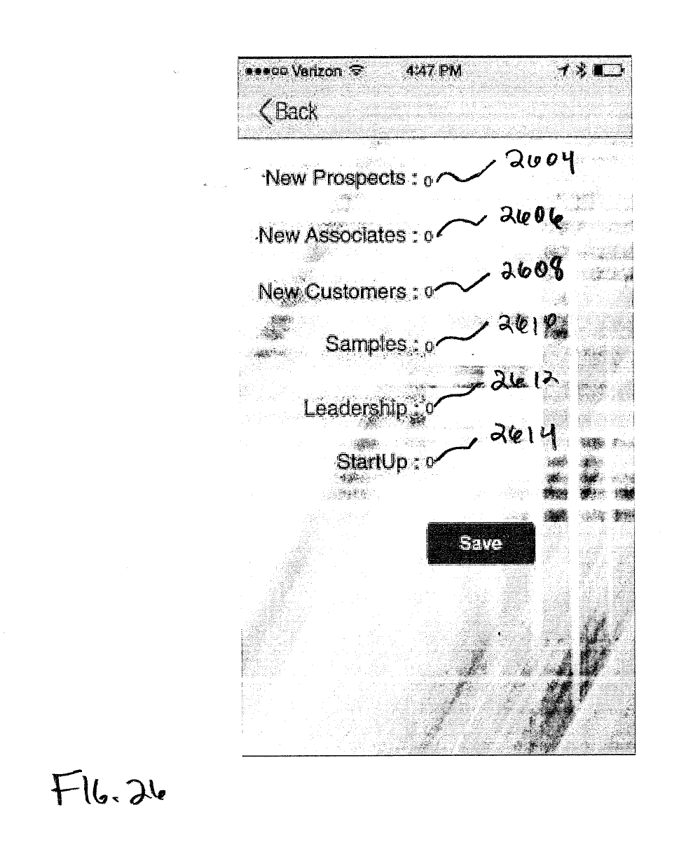

By clicking on “Set Goals” menu option 2406, mobile application 183 may display a user's goals and/or allow user to set, update and/or track goals such things as, for example, in one or more embodiments, referring to FIG. 26, a user's goals for new prospects by entering in the desired amount in “New Prospects” text field 2604; a user's goals for new associates by entering in the desired amount in “New Associates” text field 2606; a user's goals for new customers by entering in the desired amount in “New Customers” text field 2608; and/or other goals specific to a particular customer.

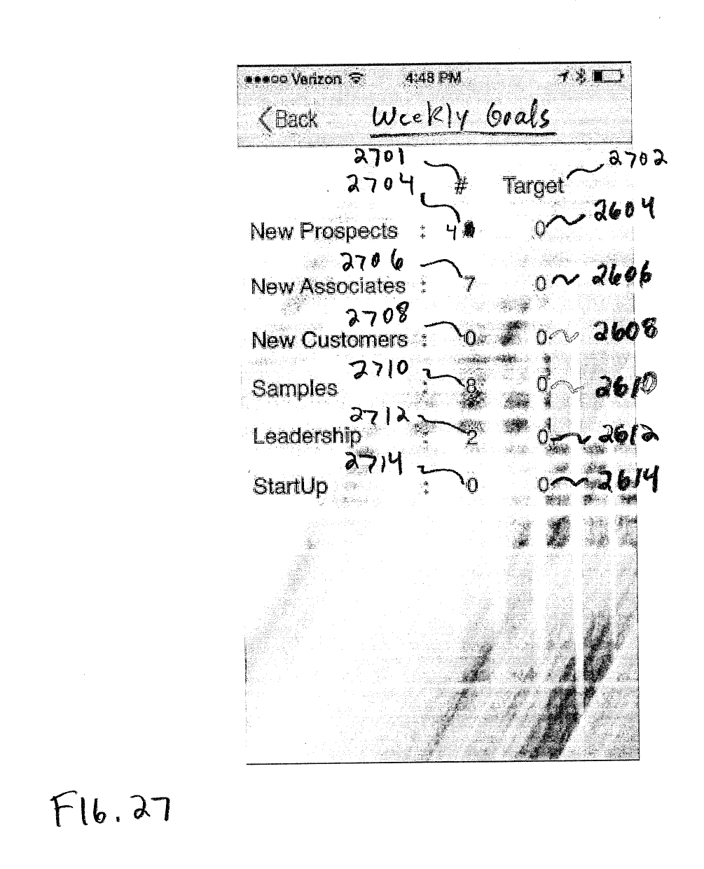

In one or more embodiments, by clicking on “Weekly Stats” menu option 2408, mobile application 183 may display statistics on a user performance during a particular week as compared to the goal a user set for that same week, such as, for example, in one or more embodiments, referring to FIG. 27, a user's target (2702) goal for new prospects (2604) for a particular week compared to the actual number (2701) of new prospects (2704) obtained during that week; a user's target (2702) goal for new associates (2606) for a particular week compared to the actual number (2701) of new associates (2706) obtained during that week; a user's target (2702) goal for new customers (2608) for a particular week compared to the actual number (2701) of new customers (2708) obtained during that week; and/or other goals and actual performance specific to a particular customer. In one or more embodiments, “Monthly Stats” menu option 2410, may have the same, similar and/or different statistical comparisons, except at the monthly level. In one or more embodiments, other statistics, goals, comparisons and timeframes are contemplated and may be implemented by the disclosure.

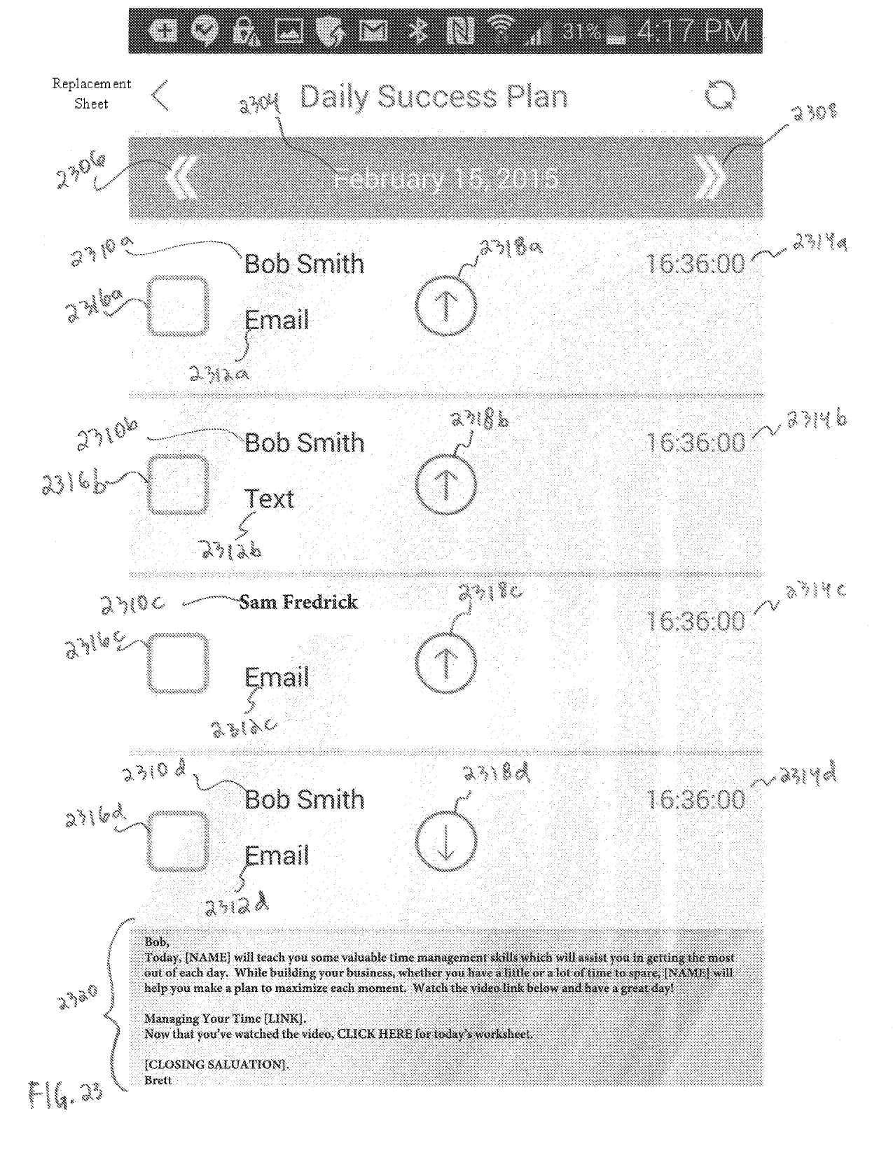

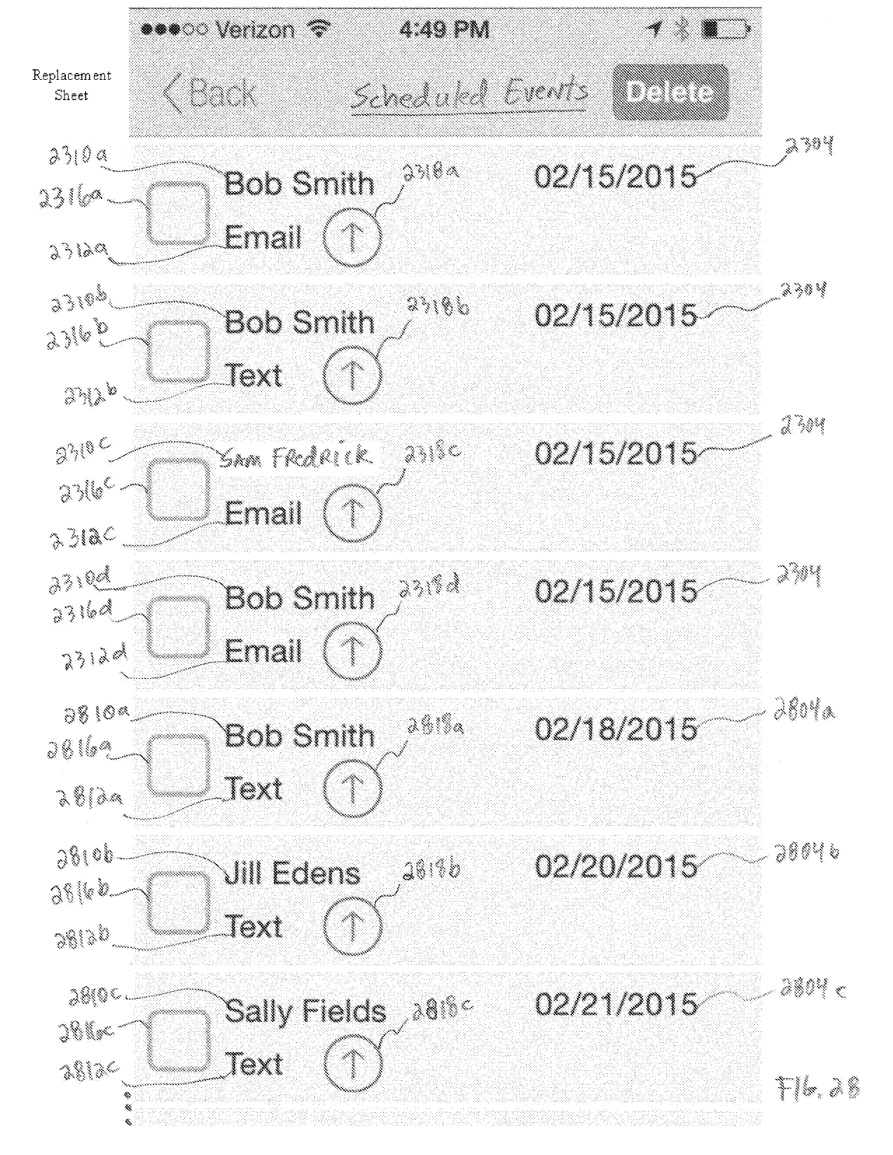

In one or more embodiments, by clicking on “View All Scheduled Events” menu option 2412, mobile application 183 may display scheduled events associated with that particular user and his/her contacts and/or those managing that user. For example, in one or more embodiments, referring to FIG. 28, a mobile device may display information the same, similar and/or different information and functionality to what is shown in FIG. 23 (which is associated with clicking on “Daily success plan window” menu option 2212 in FIG. 22) except that instead of displaying events for a particular day only, “View All Scheduled Events” menu option 2412 may show all scheduled events associated with that particular user, including those events displayed in FIG. 23. For example, in one or more embodiments, referring to FIG. 28, which is an illustration of the display resulting from clicking “View All Scheduled Events” menu option 2412, names of contacts (2310a, 2310b, 2310c, 2310d, etc.), communications (2312a, 2312b, 2312c, 2312d, etc.), options to view the actual communication such as via toggle buttons (2318a, 2318b, 2318c, 2318d, etc.) and whether the communication has been completed (such as, for example, completed communications may be marked with a checkmark, 2316c and uncompleted communications may be blank 2316a, 2316b, 2316d), which are associated with Feb. 15, 2015 (2304), are also displayed as a result of clicking “View All Scheduled Events” menu option 2412, as well as other scheduled communication (2812a, 2812b, 2812c, etc.) on other days (2804a, 2804b, 2804c, etc.) in addition to Feb. 15, 2015 (2304), and other names of contacts (2810a, 2810b, 2810c, etc.), and options to view the actual other scheduled communication such as via toggle buttons (2818a, 2818b, 2818c, etc.) and indications of the status of other scheduled communication completion (2816a, 2816b, 2816c, etc.) may be displayed.

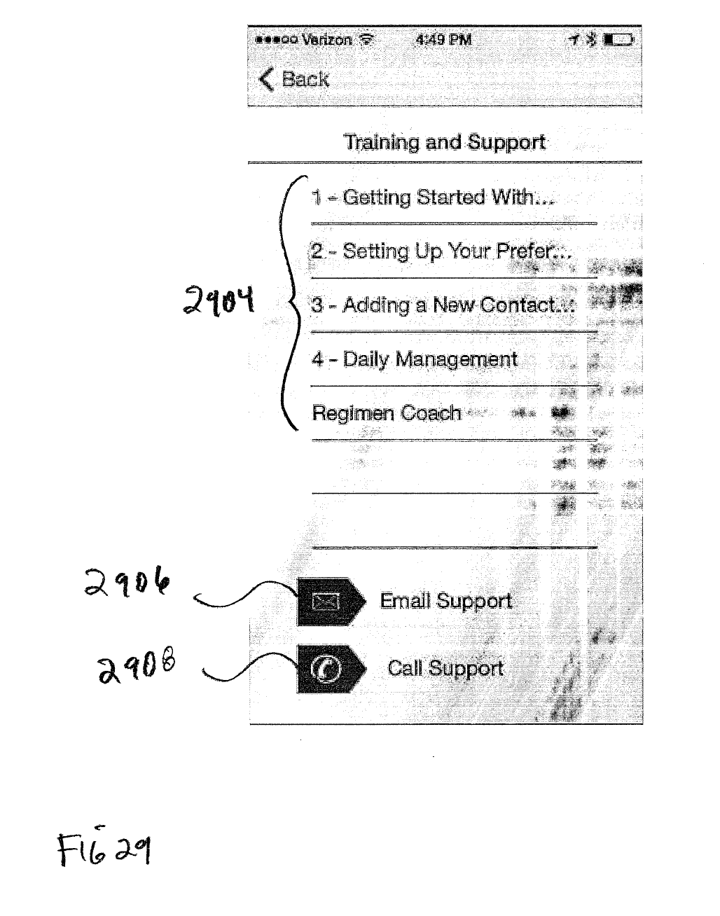

Returning to FIG. 12, in one or more embodiments, by clicking on “Support/Training” menu option 1210, mobile application 183 may direct a user to a menu providing various menu options pertaining to such things as, for example, various training available to the user and support via email, text and/or phone to support personnel. For example, in one or more embodiments, referring to FIG. 29, a user may select from a variety of available trainings (2904), which may be in any form, including, for example, videos and/or text, as well as support via clicking on “Email Support” button 2906 and/or on “Call Support” button 2908.

In one or more embodiments, mobile application 183 may allow users to assign and/or cause to be distributed to other trainings instructions, activities and communications.

In one or more embodiments, a user may register and/or download mobile application 183 at any time during all or part of a method for training and teaching people (and/or all or part of a system which implements such a method), such as, for example, method for training and teaching people 300, however, in order to receive all applicable training instructions, activities and communications, a user may need to register and download mobile application 183.

In one or more embodiments, in step 303, a user develops and/or obtains a customer's desired outcomes. Developing and/or obtaining a customers desired outcomes may include identifying the customer's desired outcome, either by receiving the desired outcome directly from the customer, or by developing a desired outcome for the customer and identifying the developed outcome. In one or more embodiments, a customer's desired outcomes may include such things as, for example, a customer's desire to improve customer retention, product consumption, follow-up, repurchasing, prospect to customer conversion, closing percentages, revenues, customer satisfaction indexes, quality controls, retention, turnover, etc. In one or more embodiments, the customer's desired outcomes may be quantifiable. In one or more embodiments, a customer's desired outcomes may be behavior driven, or in other words, the desired outcomes may seek to influence behavior.

In one or more embodiments, a user may ensure that all or part of a method for training and teaching people (and/or all or part of a system which implements such a method), such as, for example, method for training and teaching people 300, is designed to produce the desired outcomes obtained in step 303.

In one or more embodiments, a customer may establish targets that measure the level of success in achieving the desired outcomes. For example, a multilevel marketing company may have a goal to improve their prospect to customer conversion rates from 10% to 40%. In one or more embodiments, targets may have timing components (i.e. deadlines).

In one or more embodiments, a customer may establish leading indicators which may indicate whether a particular target and/or desired outcome is likely to be achieved. For example, if an insurance company desires to increase the amount of revenue a particular insurance agent is generating, leading indicators may be, for example, whether he/she (i) placed a certain number of cold calls to new prospects, (ii) made a certain number of follow-up phone calls to interested parties, and/or (iii) placed a certain number of adds in the paper, etc. In one or more embodiments, leading indicators may have a direct tie to one or more behaviors and/or the desired outcomes.

In one or more embodiments, a customer may establish lagging/trailing indicators which may indicate whether a particular target and/or desired outcome has been achieved. For example, if an insurance company desires to increase the amount of revenue a particular insurance agent is generating, a lagging/trailing indicator may be how many sales the agent generated within a month. In one or more embodiments, lagging/trailing indicators may focus on expected results stemming from behaviors.

In one or more embodiments, a customer may establish baselines which may, for example, include information about a customer's historical performance relating to the desired outcomes. For example, historical data may show that, prior to implementing the disclosure a customer's prospect to customer conversion rate was ten percent. Baselines may provide a convenient way to compare a customer's performance prior to implementing the disclosure to a customer's performance after implementing the disclosure.

In one or more embodiments, a customer's desired outcomes (as well as its targets, indicators, and/or baselines) may have multiple channels of focus. Meaning, for example, if a customer's overall desired outcome is to increase revenues via additional sales, the customer may break down that overall goal into specific goals for the different departments and/or levels of management involved. For example, the goals for its sales team may be different than the goals for those who manage the sales team. Consequently, the training for its sales team may be different than the training for those who manage the sales team. Thus, in this example, there may be two separate channels—one for the sales force and one for the management team.

In one or more embodiments, in step 303, a user may develop, obtain and/or provide to all or part of a method for training and teaching people (and/or all or part of a system which implements such a method), such as, for example, method for training and teaching people 300, data representing a customer's desired outcomes (as well as its targets, indicators, and/or baselines), by any means in any form from any source, and/or combination of the same, whether developed later or known at the time of filing.

For example, in one or more embodiments, a user may develop and obtain data representing a customer's desired outcomes (as well as its targets, indicators, and/or baselines) from communication with a customer and/or third party (such as, for example, conversations with management, human resources, consultants, living/mock training sessions, etc.) and/or from materials and documents (such as, for example, reports, financial statements, manuals, handbooks, books, etc.) which may be provided to all or part of a method for training and teaching people (and/or all or part of a system which implements such a method), such as, for example, method for training and teaching people 300, by a user entering such data into client systems 202, 204, 218, 226 via user interfaces.

For example, in one or more embodiments, a user may develop, obtain and/or provide to all or part of a method for training and teaching people (and/or all or part of a system which implements such a method), such as, for example, method for training and teaching people 300, data representing a customer's desired outcomes (as well as its targets, indicators, and/or baselines), to/from any data stored and/transferred electronically which may be in a computer readable format and/or to/from a computer program product (such as, for example, emails, text messaging, instant messaging, spreadsheets, PowerPoint presentations, ebooks, videos, webinars, webcasts, podcasts, on-demand trainings, internet sites, emails, text, CD's, DVD's, flash memory, USB drives, tapes, audio files, etc. and/or any applicable software application, package, and/or system).

For example, in one or more embodiments, a user may develop, obtain and/or provide to all or part of a method for training and teaching people (and/or all or part of a system which implements such a method), such as, for example, method for training and teaching people 300, data representing a customer's desired outcomes (as well as its targets, indicators, and/or baselines), to/from one, some and/or all of software implemented processes 192, 194, 196 which implement, include, are accessed by, and/or are otherwise related to all or part of a method for training and teaching people (and/or all or part of a system which implements such a method), such as, for example, method for training and teaching people 300.

In one or more embodiments, a user may develop, obtain and/or provide to all or part of a method for training and teaching people (and/or all or part of a system which implements such a method), such as, for example, method for training and teaching people 300, data representing a customer's desired outcomes (as well as its targets, indicators, and/or baselines), to/through any network (such as, for example, network system 190) or combination of network systems, such as, for example, wide area networks, local area networks, public networks (such as, for example, the Internet), private networks and/or hybrid networks, and/or other network types (whether data is transmitted in waveform or otherwise transferred, collected, relayed, accessed, obtained, and/or provided and/or which may be capable of communicating between and among two or more server systems and/or client systems, including, for example, any network, server systems, computing systems, and/or devices disclosed herein), and/or combinations of the same, along with all related software and/or hardware, whether developed later or known at the time of filing.

In one or more embodiments, a user may develop, obtain and/or provide to all or part of a method for training and teaching people (and/or all or part of a system which implements such a method), such as, for example, method for training and teaching people 300, data representing a customer's desired outcomes (as well as its targets, indicators, and/or baselines), to/from: (i) any computing system's memory system such as, for example, located on client systems 100, 206, 220, 228, 150, 210, 224, 232; (ii) any mobile device's memory system, such as, for example, located on client systems 130, 208, 222, 230, 150, 210, 224, 232; and/or (iii) any database, such as, for example, databases 174, 176.

In one or more embodiments, a user may develop, obtain and/or provide to all or part of a method for training and teaching people (and/or all or part of a system which implements such a method), such as, for example, method for training and teaching people 300, data representing a customer's desired outcomes (as well as its targets, indicators, and/or baselines), to/from: (i) any other database, memory system, server system, web-based system, network, computing system, any device (including mobile devices), computer readable medium, computer program product, apparatus, method, means, process, and/or machine, and/or combination of the same, whether developed later or known at the time of filing; and/or (ii) any other means (and/or combination of the same, whether developed later or known at the time of filing, not otherwise expressly stated herein) for copying, imputing, transferring, transmitting, processing, scanning, relaying, entering, uploading, downloading, accessing and/or providing such data to, into, and/or by all or part of a method for training and teaching people (and/or all or part of a system which implements such a method), such as, for example, method for training and teaching people 300.

In one or more embodiments, in step 305, a user may optionally determine whether a customer has existing training concepts, information and/or materials. Such a determination may be made by identifying existing training information, which may include receiving existing materials from the customer. In one or more embodiments, if a customer has existing training concepts, information and/or materials, a user may optionally obtain such in step 307, else the process flows to step 309.

In one or more embodiments, in step 307, a user may obtain and/or provide to all or part of a method for training and teaching people (and/or all or part of a system which implements such a method), such as, for example, method for training and teaching people 300, data representing a customer's existing training concepts, information, and/or materials by any means in any form from any source, and/or combination of the same, whether developed later or known at the time of filing.

For example, in one or more embodiments, a user may obtain data representing a customer's existing training concepts, information, and/or materials from communication with a customer and/or third party (such as, for example, conversations with management, human resources, consultants, living/mock training sessions, etc.) and/or from materials and documents (such as, for example, reports, financial statements, manuals, handbooks, books, etc.) which may be provided to all or part of a method for training and teaching people (and/or all or part of a system which implements such a method), such as, for example, method for training and teaching people 300, by a user entering such data into client systems 202, 204, 218, 226 via user interfaces.

For example, in one or more embodiments, a user may obtain and/or provide to all or part of a method for training and teaching people (and/or all or part of a system which implements such a method), such as, for example, method for training and teaching people 300, data representing a customer's existing training concepts, information, and/or materials, to/from any data stored and/transferred electronically which may be in a computer readable format and/or to/from a computer program product (such as, for example, emails, text messaging, instant messaging, spreadsheets, PowerPoint presentations, ebooks, videos, webinars, web casts, podcasts, on-demand trainings, internet sites, emails, text, CD's, DVD's, flash memory, USB drives, tapes, audio files, etc. and/or any applicable software application, package, and/or system).

For example, in one or more embodiments, a user may obtain and/or provide to all or part of a method for training and teaching people (and/or all or part of a system which implements such a method), such as, for example, method for training and teaching people 300, data representing a customer's existing training concepts, information, and/or materials, to/from one, some and/or all of software implemented processes 192, 194, 196 which implement, include, are accessed by, and/or are otherwise related to all or part of a method for training and teaching people (and/or all or part of a system which implements such a method), such as, for example, method for training and teaching people 300.

In one or more embodiments, a user may obtain and/or provide to all or part of a method for training and teaching people (and/or all or part of a system which implements such a method), such as, for example, method for training and teaching people 300, data representing a customer's existing training concepts, information, and/or materials, to/through any network (such as, for example, network system 190) or combination of network systems, such as, for example, wide area networks, local area networks, public networks (such as, for example, the Internet), private networks and/or hybrid networks, and/or others network types (whether data is transmitted in waveform or otherwise transferred, collected, relayed, accessed, obtained, and/or provided and/or which may be capable of communicating between and among two or more server systems and/or client systems, including, for example, any network, server systems, computing systems, and/or devices disclosed herein), and/or combinations of the same, along with all related software and/or hardware, whether developed later or known at the time of filing.

In one or more embodiments, a user may obtain and/or provide to all or part of a method for training and teaching people (and/or all or part of a system which implements such a method), such as, for example, method for training and teaching people 300, data representing a customer's existing training concepts, information, and/or materials, to/from: (i) any computing system's memory system such as, for example, located on client systems 100, 206, 220, 228, 150, 210, 224, 232; (ii) any mobile device's memory system, such as, for example, located on client systems 130, 208, 222, 230, 150, 210, 224, 232; and/or (iii) any database, such as, for example, databases 174, 176.

In one or more embodiments, a user may develop, obtain and/or provide to all or part of a method for training and teaching people (and/or all or part of a system which implements such a method), such as, for example, method for training and teaching people 300, data representing a customer's existing training concepts, information, and/or materials, to/from: (i) any other database, memory system, server system, web-based system, network, computing system, any device (including mobile devices), computer readable medium, computer program product, apparatus, method, means, process, and/or machine, and/or combination of the same, whether developed later or known at the time of filing; and/or (ii) any other means (and/or combination of the same, whether developed later or known at the time of filing, not otherwise expressly stated herein) for copying, imputing, transferring, transmitting, processing, scanning, relaying, entering, uploading, downloading, accessing and/or providing such data to, into, and/or by all or part of a method for training and teaching people (and/or all or part of a system which implements such a method), such as, for example, method for training and teaching people 300.

In one or more embodiments, in step 309, a user may assess a customer's training needs and develops training topics, instructions, activities and communications.

In one or more embodiments, a user assessing a customer's training needs may include any analysis, investigating, discovering, learning, searching, researching, brainstorming, communication, ascertaining, inquiring, consulting, etc., and/or any other thing and/or action, through any means, that may be relevant to identifying possible training opportunities a customer may have.

For example, in one or more embodiments, assessing a customer's training needs may include such things as, for example, reviewing a customer's desired outcomes obtained in step 303; reviewing targets, indicators and baselines obtained in step 303 and comparing them to a customer's desired outcomes obtained in step 303; reviewing existing training modules and materials optionally obtained in step 307 and determining if there are more effective means for trainings as disclosed; communicating with a customer regarding and/or otherwise determining more about a customer's processes, methods, approaches, organization, arrangements, affairs, financials, culture, systems, devices, history, projections, market, customers, contacts, etc. to gain further insight in determining a customer's training needs and, perhaps, training topics, instructions, activities and communications that may be tailored to their circumstances and/or desired outcomes; and/or consulting with experts in a customer's field, learning experts, and/or any other person(s), application, program, process, and/or institution able to assess a customer's training needs.

In one or more embodiments, it is contemplated herein that such an assessment may be performed for each user and/or group of users associated with a particular customer.

Herein, the term “training”—whether used as a noun (e.g. “The training was effective.”); whether used as an adjective (e.g. “The training topics, instructions, activities and communications were customized.”); whether used in singular or plural form; whether used with and without the “ing” gerund; whether used in present, past and/or future tenses; and/or whether used in any other way—denotes any and all aspects of the teaching, training and learning process, for any topic, and is interchangeable with the following terms (both in singular and plural form, with and without the “ing” gerund): “teaching”, “learning”, “motivating”, “instructing”, “practicing”, “applying”, “engaging”, “inspiring”, “coaching”, “mentoring”, “tutoring”, “communicating”, “guiding”, “explaining”, “educating”, “informing”, “directing”, “exemplifying”, “illustrating”, “implementing”, “modeling”, “transferring”, “imparting”, “covering”, “describing”, “influencing”, etc. and/or any combination of the same.

In one or more embodiments, once a customer's training needs have been determined, a user develops training topics, instructions, activities and communications for a customer. The training topics may be developed by organizing the existing training information into topics. In one or more embodiments, at any time while developing training topics, instructions, activities and communications for a customer in step 309, a user may reassess a customer's training needs based on newly acquired information and/or developments and/or modify, eliminate and/or add training topics, instructions, activities and communications.

In one or more embodiments, a user may design training topics, instructions, activities and communications that: (i) inform and/or educate learners (such as, for example, teaching facts, figures, and/or data (e.g. product information, policy information, etc.)); (ii) develop learners' hard skills (such as, for example, properly greet customers, closing cash registers, calculating profit margins, assembling a shelf, producing a list of potential contacts, etc.); (iii) develop learners' soft skills (such as, for example, closing deals, improving integrity, conflict resolution, decision making, leadership, honesty, service, etc.); (iv) teach accountability and follow-up to learners (such as, for example, reminders, notifications, etc.); (v) relate in any way to a user's assessment of a customer's training needs performed in step 309; (vi) relate in any way to a customer's desired outcomes obtained in step 303; and/or (vii) in any way, may enhance the learning process for learners, such as, for example, by:
Obtaining and keeping learners' attention;
Customizing trainings for different learners;
Sequencing trainings in an effort to build on and/or reinforce past trainings;
Asynchronously distributing trainings;
Keeping learners advancing towards targeted behaviors and/or desired outcomes;
Automating contact, follow-up, follow-through and/or communication with leaners;
Tracking the learning progress of multiple users with each being, potentially, at a different stages in the learning process;
Reporting the progress of learners to those who manage and/or are otherwise responsible for them;
Tying trainings to learners' behaviors, experiences, senses, emotions, physical functions, mental functions, etc.;
Transforming concepts, information and/or desired outcomes into behaviors that learners may perform;
Allowing learners to practice, apply and/or experience what is taught;
Enhancing learners' ability to learn, understand, recall, retain and/or use trainings;
Providing intrinsic motivation, desire and/or value for learners to become and/or remain engaged in the learning process;
Allowing learners' to develop complex skills and understandings;
Working within measurably shrinking attention spans;
Adding relevance to learners' situation;
Allowing trainings to be kept short and focused;
Moving training from learners' short-term memory to their long-term memory, episodic memory and/or declarative memory and, ultimately, to habit formation and/or displacement; and/or
Accomplish any other reasons and/or objectives stated herein and/or in spirit with the disclosure and/or which would assist learners, in anyway, in achieving customers' desired outcomes.

In one or more embodiments, training topics, instructions, activities and communications may involve multiple categories of training topics, instructions, activities and communications, such as, for example, conflict management which may involve both soft skill development (such as, for example, those that focus on how to see the disputed issue from the other person's prospective) as well as hard skill development (such as, for example, those that focus on what specific questions and/or statements to say in order to show sympathy and disarm an agitated person).

In one or more embodiments, developing training topics, instructions, activities and communications may include anything related to creating and/or leading to the creation of training topics, instructions, activities and communications, including those aimed at achieving a customer's desired outcomes obtained by a user in step 303, such as, for example, a user may:
Break down a customer's desired outcomes obtained by a user in step 303 into training topics, instructions, activities and communications;
Break down a customer's existing training concepts, information, and/or materials, if optionally obtained by a user in step 307 into training topics, instructions, activities and communications;
Optionally break training topics into training subtopics;
Break down training topics into training instructions, activities and/or communications;
Determine the number of training topics, instructions, activities and communications;
Determine the sequence and form in which training topics, instructions, activities and communications may be created, distributed and/or presented;
Outline, organize and/or script training topics, instructions, activities and communications;
Create training topics, instructions, activities and communications; and/or
Engage in any activity relevant to the training development process.

The term “break down”—whether used in singular or plural form; whether used with and without the “ing” gerund; whether used in present, past and/or future tenses; and/or whether used in any other way—denotes reducing, separating and/or dividing something into parts and/or subparts, and/or explaining something; and is interchangeable with the following terms (both in singular and plural form, with and without the “ing” gerund): “transforming”, “sculpting”, “shaping”, “separating”, “dividing”, etc. and/or combinations of the same.

In one or more embodiments, in step 309, when a user may break down (i) a customer's desired outcomes obtained by a user in step 303 and/or (ii) a customer's existing training concepts, information, and/or materials, if any, optionally obtained by a user at 307, into training topics, he/she may do such things as, for example, take a customer's desired outcome of increasing prospect to customer conversion rates and breaking it down into various training topics, such as, for example, integrity, handling resistance, creating passion about a product, three-way calling, inviting prospects to watch a video, following up, etc.

In one or more embodiments, in step 309, when a user may break down training topics into training instructions, activities and/or communications, he/she may do such things as, for example, transform training topics (and/or subtopics, as the case may be) into specific behaviors that learners may perform. For example, in one or more embodiments, a user may take the training topic of integrity and break it down into three trainings focused on specific behaviors, such as, for example, (1) training a trainee on how to make clear agreements, such as, for example, saying what task he/she will do and/or when he/she will complete the task (e.g. “I will call Mr. Smith by tomorrow afternoon at 3:00 P.M.”) rather than implying what task he/she will do and/or when he/she will complete the task without making a firm commitment (e.g. “I have some availability this week to contact Mr. Smith.”); (2) training a trainee on how to be accurate and specific when communicating, such as, for example, saying where he/she is located and when he/she will arrive at a destination (e.g. “I'm driving on Highway I-15 and just passed Malad, Id. and will arrive in Pocatello, Id. in about one hour.”) rather than giving vague approximations (e.g. “I'll be home around dinner time.”); and/or (3) training a trainee on how to say decline invitations, such as, for example, saying he/she is not available or does not engage in that line of work (e.g. “I'm sorry, our firm doesn't practice that area of law.”) rather than implying that he/she may accept the invitation even though he/she actually has no intention of doing so (e.g. “That sounds interesting. Let me talk to my boss and get back with you.”). Specific behavior may be easier to measure, teach, learn, implement and/or remember, than concepts.

In one or more embodiments, in step 309, when a user may break down training topics into activities, he/she may design the activities to allow learners to experience practicing and applying the targeted behavior and/or desired outcome. Such a design may enhance the transfer of the training's content and/or targeted behavior from learners' short-term memory to his/her long-term memory. In one or more embodiments, training activities may be created by any means and in any form, including such things as, for example:
Practice exercises—may be such things as, for example, approaching a stranger and finding 20 things you have in common with that person and/or completing workbooks, worksheets, or simulators, which may provide learners live experiences and/or mock/simulated experiences applying training;
Introspection exercises—may be such things as, for example, journal writing and/or logging, which may allow learners to reflect upon what they have learned and to deepen their understanding of the content of the training and/or to make connections between past trainings and present trainings and/or between concepts and desired outcomes;
Collaborative/Obtaining feedback exercises—may be such things as, for example, communicating with others via social networks, blogging, in-person feedback, mentors, partners, and/or any other form or avenue for collaborating and/or receiving feedback, which may provide learners insight from others;
Assessment exercises—may be such things as, for example, tests, quizzes, surveys and/or evaluations, which may allow learners to evaluate their mastery of training content and/or assess their attitudes and opinions regarding the training;
Accountability exercises—may be such things as, for example, reporting to a supervisor and/or other authoritative figure, which may motivate learners to perform according to the desired outcomes and account for results of his/her performance; and/or
Any other exercise, such as, for example, any that may stretch the learner and get them out of their comfort zone.

In one or more embodiments, in step 309, when a user may outline, organize, and/or script training topics, instructions, activities and communications, he/she may do such things as, for example, brainstorm, spider web, map, design, discuss, flow chart, identify concepts, information, training activities, desired outcomes, and/or behaviors desired to be eliminated, and/or any other thing relevant to developing training topics, instructions, activities and communications, including those aimed at achieving a customer's desired outcomes obtained by a user in step 303.

In one or more embodiments, in step 309, a user may develop training topics, instructions, activities and communications to include a particular amount of content, as the amount of content in each may influence learners' attention spans and/or how much learners may retain in their short-term memory long enough to apply it and/or move into long-term memory and/or eventually to become a habit. In one or more embodiments, the amount of content contained in each training topic, instruction, activity and communication may be kept to 1, 2, 3, 4, 5, 6, 7, 8 and/or 9 points, and/or more as the circumstances necessitate.

In one or more embodiments, in step 309, a user may develop training topics, instructions, activities and communications to a particular length of time, as the length of each may influence learners' attention spans and/or how much learners may retain in their short-term memory long enough to apply it and/or move into long-term memory and/or eventually to become a habit. In one or more embodiments, the length of each training topic, instruction, activity and communication may be up to 3 minutes, up to 5 minutes, up to 10 minutes, up to 15 minutes, and/or more as the circumstances necessitate.

For example, in one or more embodiments, a user may take a customer's existing four-hour long training session and break it down into 60 separate training instruction videos each about four minute long. Each training video may be accompanied with a training activity, such as a worksheet, a challenge, a journaling topic, etc.; and thus totaling 60 training activities and their supporting materials. In addition, in one or more embodiments, various support channels may receive training communications such as, for example, notifications that their subordinates are receiving certain training instructions and activities and reminders to follow-up on such trainings. Furthermore, in one or more embodiments, the support channels may receive their own focused training instruction videos with accompanying training activities, all of which may be specifically timed, distributed and topically correlated to the specific trainings each of their subordinates are receiving.

In one or more embodiments, in step 309, a user may develop training topics, instructions, activities and communications to be sequenced in a particular order (such as, for example, chronologically and/or linearly) so that the content of one (or more than one) may access, restate, repeat, connect to, build on and/or reinforce the content of previous training topics, instructions, activities and/or communications. Such organization may allow for such things as, for example: (i) repetition of targeted concepts, information and behaviors and thus facilitate long-term memory and behavioral change and/or the achievement of a customer's desired outcomes obtained in step 303; (ii) building upon small pieces of information, concepts and/or behaviors more complex skillsets and/or knowledge base; and/or (iii) keeping each training topic, instruction, activity and communication focused, which may, for example, improve retention and/or application of the training. For example, in one or more embodiments, teaching a sales person basic skills to approach a prospect may be foundational to and need to be taught before teaching more advanced customized prospect approaches. Thus, the behavior of asking a person for their email address and phone number may need to be taught to a sales person before other behaviors in the follow-up process.

In one or more embodiments, in step 309, a user may develop training topics, instructions, activities and communications to help learners use and/or connect the content of the trainings with and/or to one or more of their senses (such as, for example, hearing, smelling, touching, seeing, etc.), emotions (such as, for example, fear, excitement, discovery, etc.), physical functions (such as, for example, sight, hearing, speaking, moving, etc.); mental functions (such as, for example, thought, analysis, etc.), and/or any combinations of the same; past experiences; and/or via associations.

In one or more embodiments, in step 309, a user may develop training topics, instructions, activities and communications to include intrinsic motivation. Learners may need to see value in the things being taught and/or be motivated to learn them. If not, their attentions made fade. Training topics, instructions, activities and communications may be designed to capture learners' attention and/or establish a desire to learn what is being taught. Certain and/or each element of the training topics, instructions, activities and communications may have a specific purpose. For example, in one or more embodiments, the following statement may be contained in a training video: “Today, you'll learn a basic sales approach that will help you easily initiate a sales conversation with most prospects.” The purpose of the before mentioned statement is to inform learners about the purpose of training—to “easily initiate a sales conversation.” Such may answer the questions, “Why is it important for me to know?” and/or “What I'm about to be taught?” Such may build intrinsic motivation for the learner, increase their receptiveness, keep their attention, and/or free-up their short-term memory.

In one or more embodiments, in step 309, a user may develop training topics, instructions, activities and communications by any means in any form from any source.

In one or more embodiments, the training topics, instructions, activities and communications may be developed based on a user's assessment and/or reassessment of a customer's training needs as discussed in detail above.

In one or more embodiments, in step 309, a user may develop, obtain and/or provide to all or part of a method for training and teaching people (and/or all or part of a system which implements such a method), such as, for example, method for training and teaching people 300, data representing training topics, instructions, activities and communications by any means in any form from any source, and/or combination of the same, whether developed later or known at the time of filing.

For example, in one or more embodiments, a user may develop and/or obtain data representing training topics, instructions, activities and communications from communication with a customer and/or third party (such as, for example, conversations with management, human resources, consultants, living/mock training sessions, etc.) and/or from materials and documents (such as, for example, reports, financial statements, manuals, handbooks, books, etc.) which may be provided to all or part of a method for training and teaching people (and/or all or part of a system which implements such a method), such as, for example, method for training and teaching people 300, by a user entering such data into client systems 202, 204, 218, 226 via user interfaces.

For example, in one or more embodiments, a user may develop, obtain and/or provide to all or part of a method for training and teaching people (and/or all or part of a system which implements such a method), such as, for example, method for training and teaching people 300, data representing training topics, instructions, activities and communications, to/from any data stored and/transferred electronically which may be in a computer readable format and/or to/from a computer program product (such as, for example, emails, text messaging, instant messaging, spreadsheets, PowerPoint presentations, ebooks, videos, webinars, webcasts, podcasts, on-demand trainings, internet sites, emails, text, CD's, DVD's, flash memory, USB drives, tapes, audio files, etc. and/or any applicable software application, package, and/or system).

For example, in one or more embodiments, a user may develop, obtain and/or provide to all or part of a method for training and teaching people (and/or all or part of a system which implements such a method), such as, for example, method for training and teaching people 300, data representing training topics, instructions, activities and communications, to/from one, some and/or all of software implemented processes 192, 194, 196 which implement, include, are accessed by, and/or are otherwise related to all or part of a method for training and teaching people (and/or all or part of a system which implements such a method), such as, for example, method for training and teaching people 300.

In one or more embodiments, a user may develop, obtain and/or provide to all or part of a method for training and teaching people (and/or all or part of a system which implements such a method), such as, for example, method for training and teaching people 300, data representing training topics, instructions, activities and communications, to/through/from any network (such as, for example, network system 190) or combination of network systems, such as, for example, wide area networks, local area networks, public networks (such as, for example, the Internet), private networks and/or hybrid networks, and/or others network types (whether data is transmitted in waveform or otherwise transferred, collected, relayed, accessed, obtained, and/or provided and/or which may be capable of communicating between and among two or more server systems and/or client systems, including, for example, any network, server systems, computing systems, and/or devices disclosed herein), and/or combinations of the same, along with all related software and/or hardware, whether developed later or known at the time of filing.

In one or more embodiments, a user may develop, obtain and/or provide to all or part of a method for training and teaching people (and/or all or part of a system which implements such a method), such as, for example, method for training and teaching people 300, data representing training topics, instructions, activities and communications, to/from: (i) any computing system's memory system such as, for example, located on client systems 100, 206, 220, 228, 150, 210, 224, 232; (ii) any mobile device's memory system, such as, for example, located on client systems 130, 208, 222, 230, 150, 210, 224, 232; and/or (iii) any database, such as, for example, databases 174, 176.

In one or more embodiments, a user may develop, obtain and/or provide to all or part of a method for training and teaching people (and/or all or part of a system which implements such a method), such as, for example, method for training and teaching people 300, data representing training topics, instructions, activities and communications, to/from: (i) any other database, memory system, server system, web-based system, network, computing system, any device (including mobile devices), computer readable medium, computer program product, apparatus, method, means, process, and/or machine, and/or combination of the same, whether developed later or known at the time of filing; and/or (ii) any other means (and/or combination of the same, whether developed later or known at the time of filing, not otherwise expressly stated herein) for copying, imputing, transferring, transmitting, processing, scanning, relaying, entering, uploading, downloading, accessing and/or providing such data to, into, and/or by all or part of a method for training and teaching people (and/or all or part of a system which implements such a method), such as, for example, method for training and teaching people 300.

In one or more embodiments, in step 311, a user may optionally determine whether support channels exist that may provide learners support during the training process. In one or more embodiments, a support channel includes a topic master who is responsible for providing support for a learner. In one or more embodiments, if an existing support channel is identified, a user may optionally assess the support channels' training needs and develop training topics, instructions, activities and communications for such in step 313, else the process flows to step 315.

In one or more embodiments, support channels, including topic masters, may include, for example, relationships such as: up-line personnel/down-line personnel, teacher/student, doctor/nurse, supervisor/subordinate, coach/player, shareholder/director, director/officer, mentor/mentoree, sponsor/sponsoree, management/staff, foreman/line worker, distributor/prospect, principal/agent, client/fiduciary and/or any relationship wherein one person or group of people may influence, motivate, and/or hold another person or group of people accountable, and/or follow-up on the training process. In one or more embodiments, motivation, follow-up and/or accountability may be important aspects of the learning process and support channels may facilitate such motivation, follow-up and/or accountability.

In one or more embodiments, a user may identify multiple channels of support. For example, in a multilevel marketing company there may be different levels of management, such as, for example, lower, middle and upper management. Upper management of the multilevel marketing company may determine that all distributors need to receive certain training and that each distributor's direct supervisor, such as, for example, a team leader is designated as a topic master and is responsible for motivating, following-up and holding their respective distributors accountable for completing the training. In such a scenario, each team leader may need reports on the status of each of his/her distributors; and upper management may need reports on the overall status of progress toward completing the training process. Both upper management and each team leader constitute separate channels of support that a user may identify in step 311.

In one or more embodiments, a user's optional assessment of support channels' training needs may include any analysis, investigating, discovering, learning, searching, researching, brainstorming, communication, ascertaining, inquiring, consulting, etc., and/or any other thing and/or action, through any means, that may be relevant to identifying possible training opportunities for support channels, such as, for example, those discussed in relation to a customer's training needs as discussed in step 309 (which step is hereby incorporated herein by reference in its entirety as if set forth in full) albeit adapted to assessing support channel training needs.

In one or more embodiments, it is contemplated herein that such an assessment may be performed for each user and/or group of users associated with a particular customer.

In one or more embodiments, training communications (and/or training instructions and/or activities) may be made to learners and/or any number of individuals/entities who may support learners in the learning process. In one or more embodiments, leaders, such as, for example, as discussed above, team leaders who directly supervise learners, may receive communications. In one or more embodiments, other support channels besides and/or in addition to direct supervisors may receive communications (and/or training instructions and/or activities), such as, for example, divisional leaders over team leaders, general managers over divisional leaders, and/or chief executive officers over general managers. The disclosure may be customized, flexible, and/or adaptable to various levels of support as each circumstance may vary.

In one or more embodiments, training communications (and/or training instructions and activities) provided to support channels, may include such things as, for example, (i) notifications to team leaders that learners may have recently received certain training and/or been assigned to perform certain activities, reminders to team leaders to contact learners and follow up on trainings and/or assignments, and/or leadership trainings to team leaders on how to manage teams, resolve conflict, motivate team members, etc. and/or (ii) training to upper management on advanced leadership skills and/or how to run effective meetings, establish a culture of trust, hire, set goals, etc. These training communications may be separate from communications provided directly to learners, and may prepare the support channel to master a topic of concern.

In one or more embodiments, the training instructions, activities and communications provided to support channels may be synced to the individual training tracks of front-line training recipients and/or trained “just in time” in connection with those they manage. For example, if a front-line employee is learning how to make a three-way call with their supervisor, the supervisor may receive training on how to lead a three-way call that same day. In some embodiments, the support channel may master the topic, just before training at least one learner on a topic. The training may occur asynchronously, such that the training materials are delivered to each individual learner at a time independent from the delivery of training materials to other users.

In one or more embodiments, once support channels' training needs have been determined, in step 313, a user may optionally develop training topics, instructions, activities and communications for support channels which includes such things as, for example, discussed in relation to developing training topics, instructions, activities and communications for customer as discussed in step 309, (which step is hereby incorporated herein by reference in its entirety as if set forth in full) albeit adapted to developing training topics, instructions, activities and communications relating to support channels.

In one or more embodiments, at any time while developing training topics, instructions, activities and communications for support channels in step 313, a user may reassess support channel training needs based on newly acquired information and/or developments and/or modify, eliminate and/or add training topics, instructions, activities and communications.

In one or more embodiments, in step 313, a user may develop, obtain and/or provide to all or part of a method for training and teaching people (and/or all or part of a system which implements such a method), such as, for example, method for training and teaching people 300, data representing training topics, instructions, activities and communications by any means in any form from any source, and/or combination of the same, including those discussed in relation to a customer as discussed in step 309 (which step is hereby incorporated herein by reference in its entirety as if set forth in full) albeit adapted to developing training topics, instructions, activities and communications relating to support channels, whether developed later or known at the time of filing.

In one or more embodiments, in step 315, a user may determine whether training topics, instructions, activities and communications have been developed. In one or more embodiments, if so, a user may prepare to distribute training instructions, activities and communications to intended recipients in step 317, else the process flow returns to step 309 and/or to step 313 wherein a user assesses a customer's and/or a support channel's training needs and develops training topics, instructions, activities and communications.

In one or more embodiments, if a particular training topic, instruction, activity and/or communication has not been developed and/or additional information in received by a user that necessitates revising, editing, eliminating and/or developing additional training topics, instructions, activities and communications, a user may return to step 309 and/or to step 313 to do so.

As discussed, in one or more embodiments, training instructions, activities and communications may be created in any format, such as, for example, in video format. If the scripts for such videos have not already been written by step 315, a user may return to step 309 and/or to step 313 and complete the scripts and/or any other things related to developing such videos. In one or more embodiments, training instructions, activities and communications scripts may include, for example, reference to other training instructions, activities and communications. Such may reinforce the concepts and/or targeted behaviors taught, and enhance the ability of such to move from a trainee's short-term memory to his/her long-term memory and/or ultimately to habit formation. In one or more embodiments, scripts may be outlined and written in any manner, such as, for example, according to the following outline: identifying the purpose of why that particular training video is being produced and/or to provide intrinsic motivation for the trainee to remain attentive to the training process; identifying a concept(s) and/or the targeted behavior taught in the video; provide an example illustrating the concept and/or targeted behavior; and/or provide a supporting activity.

In one or more embodiments, once the scripts for videos have been written, they may be loaded into a teleprompter and the video may be shot. In one or more embodiments, a user and/or representative and/or agent of a customer may read the script displayed on the teleprompter during the filming of the video. In one or more embodiments, such may be done, for example, to maintain the integrity of the message and/or to otherwise keep it in conformity with the principles disclosed herein. In one or more embodiments, the film may be high quality and/or shot on a green screen. In one or more embodiments, post production elements may be added, such as, for example, transitions, audio, and/or graphics which may reinforce visual content.

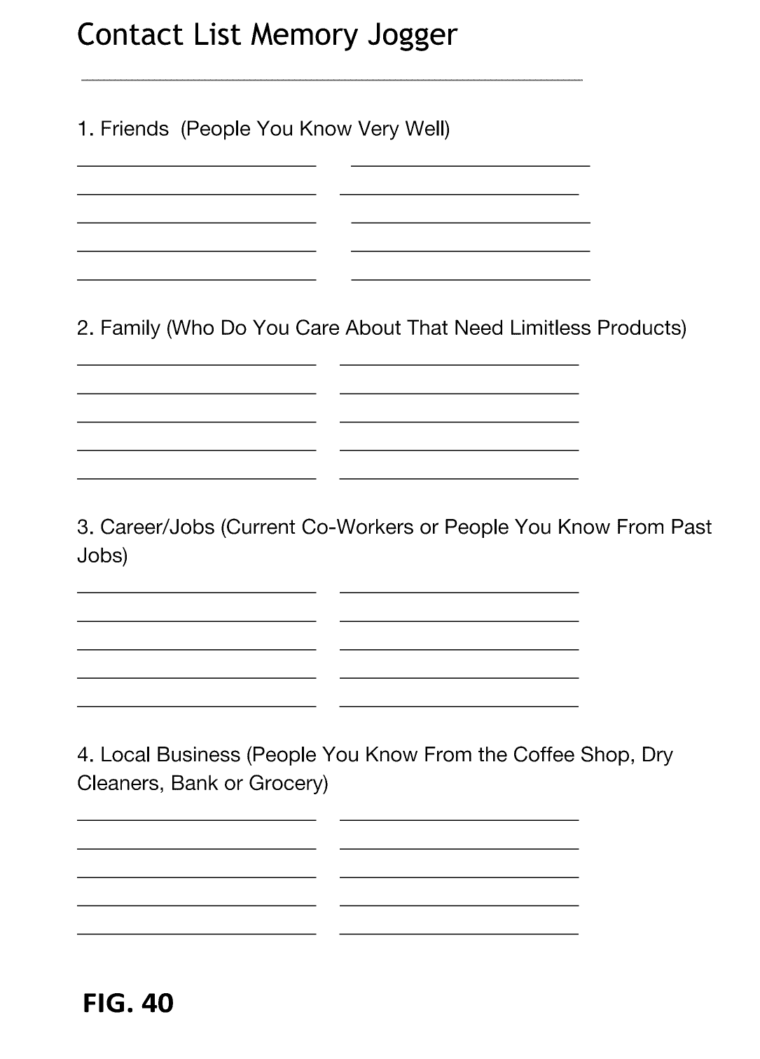

As discussed above, in one or more embodiments, training activities may be created in any format, such as, for example, in the form of worksheets. If a particular training activity has not already been developed a user may return to step 309 and/or to step 313 and create it. A training activity worksheet may include such things as, for example, illustrated in FIG. 40, which depicts one embodiment of an exemplary training activity aimed at helping learners identify prospects.

In one or more embodiments, in step 315, a user may return to step 309 and/or to step 313, to develop training topics, instructions, activities and communications, which may be to develop, obtain and/or provide to all or part of a method for training and teaching people (and/or all or part of a system which implements such a method), such as, for example, method for training and teaching people 300, data representing training topics, instructions, activities and communications by any means in any form from any source, and/or combination of the same (including those discussed in relation to discussed in step 309 and/or to step 313, all of which steps are hereby incorporated herein by reference in its entirety as if set forth in full), whether developed later or known at the time of filing.

In one or more embodiments, in step 317, a user may prepare training instructions, activities and communications to be distributed to intended recipients. In one or more embodiments, by step 317 a particular, some and/or all training instructions, activities and communications may have been developed and may need to be prepared to be distributed to their intended recipients.

In one or more embodiments, in step 317, preparing training instructions, activities and communications to be distributed to intended recipients may including a user doing anything necessary to ensure that the intended recipient receives the intended training instructions, activities and communications via all or part of a method for training and teaching people (and/or all or part of a system which implements such a method), such as, for example, method for training and teaching people 300, including, for example,
Develop, manage and/or frame the content and parameters of training communication which may deliver each training instruction, activity and communication;
Specify the time, order, and to whom each training communication may be sent; and/or
Attaching, linking, embedding, uploading, selecting and/or specifying the training instructions, activities and/or communications that will be in each training communication.

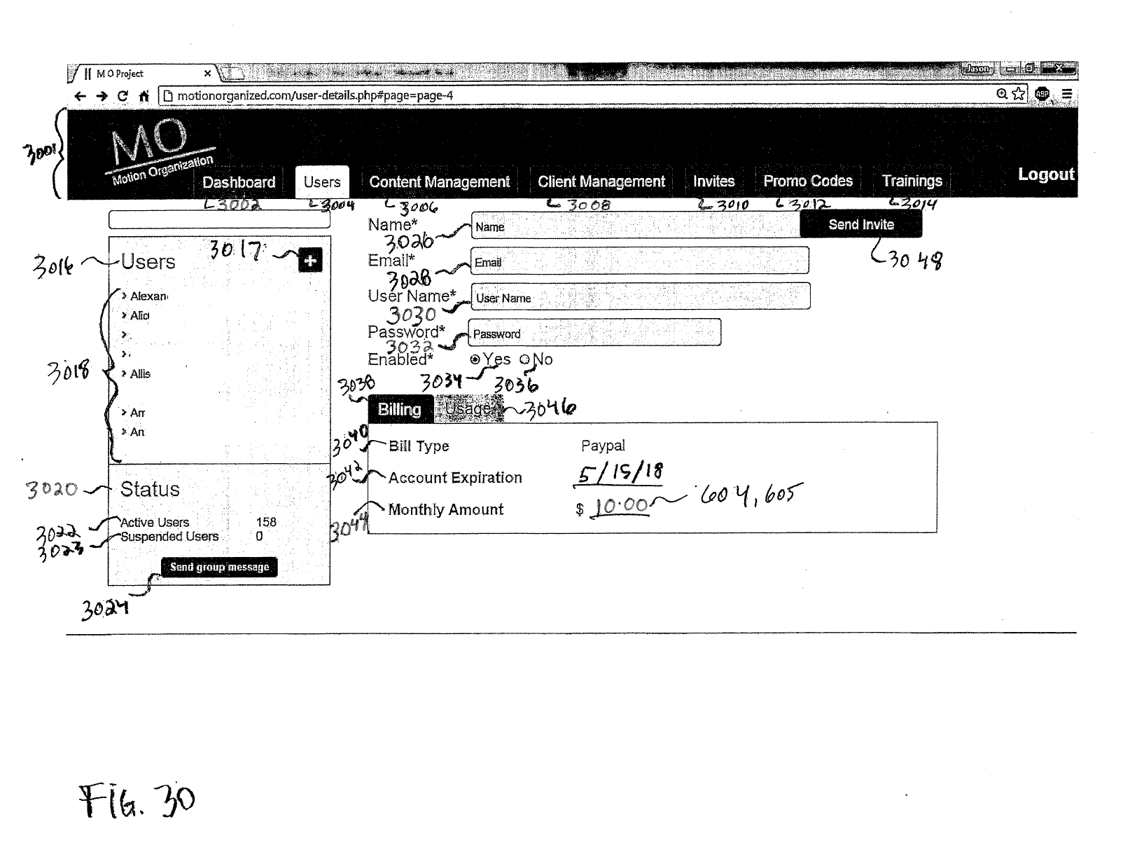

FIG. 30 through FIG. 39 are screenshots wherein a user has logged into a particular user account that depict one or more embodiments of aspects of an exemplary website 181 for a system implementing a method for teaching and training people, such as, method for teaching and training people 300 and the appearance, functionality and features of such may vary greatly while still remaining true to the spirit and principles of this disclosure.

The broad definition of the term “user” as stated above controls unless otherwise specifically stated. In one or more embodiments, website 181 may be designed to each user a unique password/username combination, which, when entered, will display information, layouts, features, and/or functionality (such as, for example, administrative privileges and/or capacities) customized and/or relevant to that particular user.

In one or more embodiments, referring to FIG. 30, website 181 may allow users to perform various different functions, such as, for example, to select from various tabs located on a horizontal menu bar 3001, such as “Dashboard” tab 3002, “User” tab 3004, “Content Management” tab 3006, “Client Management” tab 3008, “Invites” tab 3010, “Promo Codes” tab 3012, and/or “Training” tab 3014, each displaying various functionality a user may perform. In one or more embodiment, tabs may be added, modified and/or eliminate to horizontal menu bar 3001, and/or a vertical menu bar or any other design, as needed.

In one or more embodiments, referring to FIG. 30 under “User” tab 3004, website 181 may allow users to review, enter and/or modify various information regarding users, such as, for example: (i) a list of all registered users (3018) in a particular user account, such as, for example, under “User” header 3016; (ii) a summary of the status of various users, such as, for example, under “Status” header 3020 which indicates the number of “Active Users” 3022 and the number of “Suspended Users” 3023; (iii) information associated with a particular user; and/or (iv) any other information as needed. In one or more embodiments, after selecting a particular user listed (3018) under “Users” heading 3016, information associated with a particular user may include such things as, for example, that particular user's name in “Name” text field 3026 (which may be the same as the user entered into “Name” text field 404 when initially registering, as illustrated in FIG. 4); that particular user's email address in “Email” text field 3028 (which may be the same as the user entered into “Email Address” text field 406 when initially registering, as illustrated in FIG. 4); that particular user's user name in “User Name” text field 3030 (which may be the same as initially sent to that particular user when he/she registered, as illustrated in FIG. 10); that particular user's password in “Password” text field 3032 (which may be the same as initially sent to that particular user when he/she registered, as illustrated in FIG. 10); whether that particular user's account is enabled or not, such as, for example, by selecting either the radio button “Yes” 3034 or “No” 3036; that particular user's billing information (some and/or all of which may be the same as initially entered via the same, similar and/or different functionality as illustrated in FIG. 5 though FIG. 7), for example, as indicated in “Billing” tab 3038 (as discussed in greater detail below); and/or that particular user's usage information, for example, as indicated in “Usage” tab 3046 (as discussed in greater detail below).

Continuing in FIG. 30 under “Billing” tab 3038, website 181 may allow users to review, enter and/or modify the following information about a particular user: (i) the types of billing payments made by a particular user in anyway and/or in any form, such as, for example, PayPal, credit card, checking account, and/or as indicated in “Billing Type” text field 3040 (which may be the same as a particular user initially selected as illustrated in FIG. 7); (ii) the date a particular user's account expires, such as, for example, as indicated in “Account Expiration” text field 3042; and/or (iii) the payment amounts and/or frequency of payments due by a particular user, such as, for example, yearly fees, quarterly fees, and/or as indicated in “Monthly Amount” text field 3044 (which may be the same as initially selected (604, 605) as illustrated in FIG. 6).

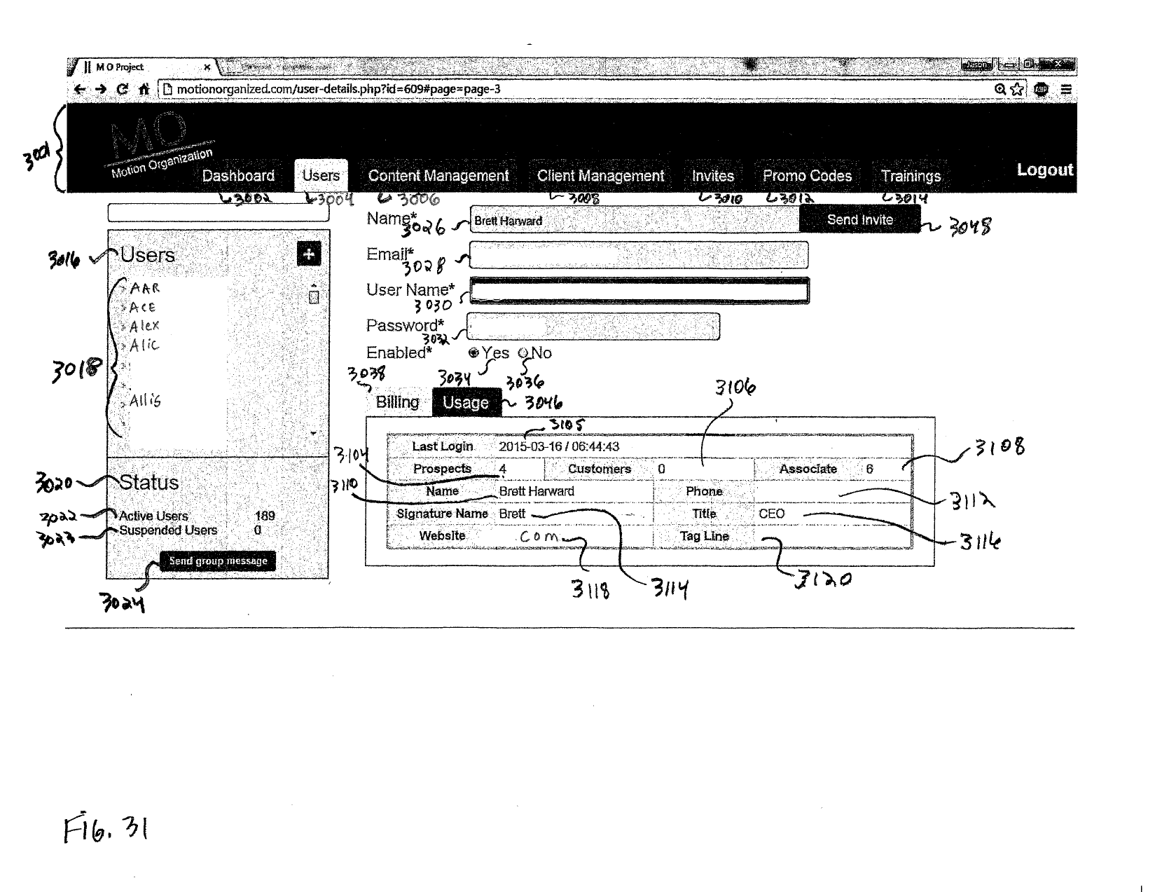

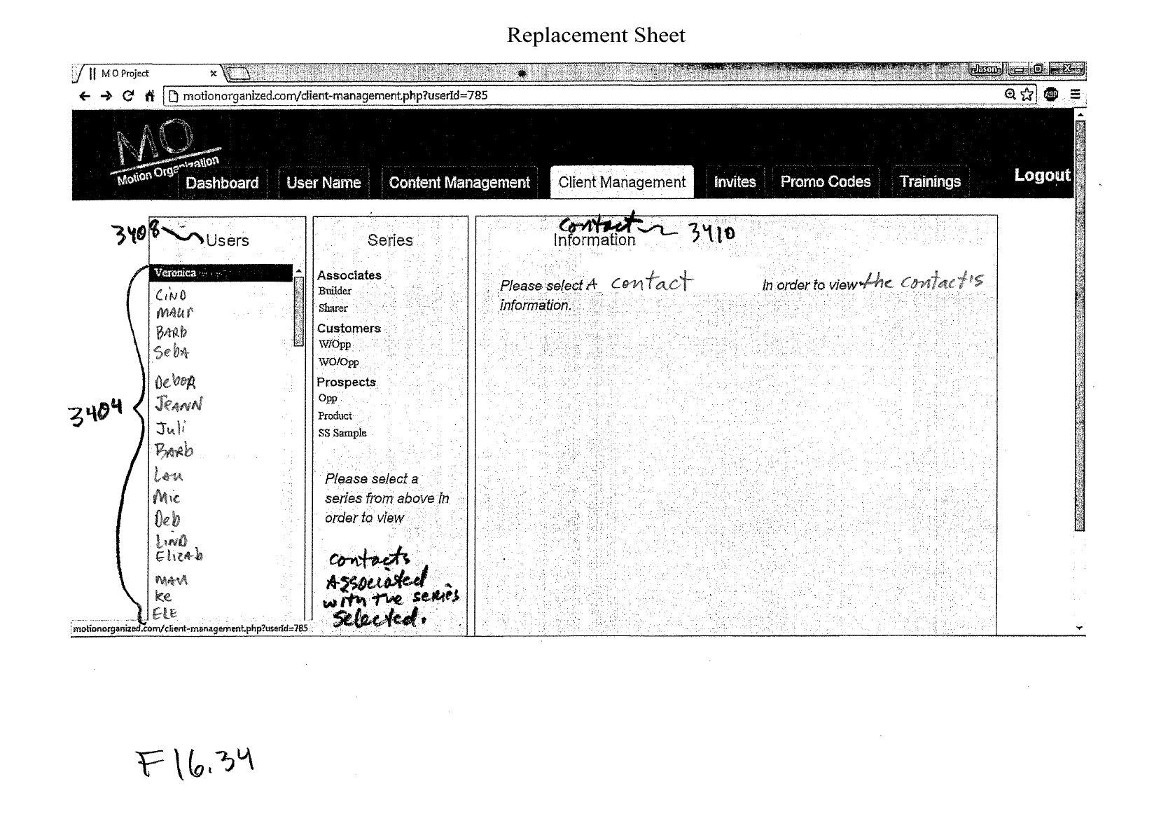

Referring to FIG. 31 under “Usage” tab 3046, website 181 may allow users to review, enter and/or modify the following information about a particular user: (i) a particular user's last login time, such as, for example, indicated in “Last Login” text field 3105; (ii) a particular user's number of prospects, such as, for example, as indicated in “Prospects” text field 3104 (which may correspond to the number of prospects as indicated in one or more mobile applications 183, for example, as illustrated in FIG. 13 (1306), FIG. 17A, and/or FIG. 27 (2704) and/or as illustrated in FIG. 34 under “Client Management” 3008); (iii) a particular user's number of customers, such as, for example, as indicated in “Customers” text field 3106 (which may correspond to a number of customers, such as, for example, as indicated in one or more mobile applications 183, for example, as illustrated in FIG. 13 (1310) and/or FIG. 27 (2708) and/or in one or more websites 181, for example, as illustrated in FIG. 34 under “Client Management” 3008); (iv) a particular user's number of associates, such as, for example, as indicated in “Associate” text field 3108 (which may correspond to the number of associates as indicated in one or more mobile applications 183, for example, as illustrated in FIG. 13 (1308), FIG. 18, and/or FIG. 27 (2706) and/or in one or more websites 181, for example, as illustrated in FIG. 34 under “Client Management” 3008); (v) a particular user's name, such as, for example, as indicated in “Name” text field 3110 (which may to the name as indicated in one or more mobile applications 183, for example, as illustrated in FIG. 25 (2504)); (vi) a particular user's phone number, such as, for example, as indicated in “Phone” text field 3112 (which may correspond to the phone number as indicated in one or more mobile applications 183, for example, as illustrated in FIG. 25 (2506)); (vii) a particular user's signature name, such as, for example, as indicated in “Signature Name” text field 3114 (which may correspond to the signature name as indicated in one or more mobile applications 183, for example, as illustrated in FIG. 25 (2510)); (viii) a particular user's title, such as, for example, as indicated in “Title” text field 3116 (which may correspond to the title as indicated in one or more mobile applications 183, for example, as illustrated in FIG. 25 (2512)); (ix) a particular user's website, such as, for example, as indicated in “Website” text field 3118 (which may correspond to the website as indicated in one or more mobile applications 183, for example, as illustrated in FIG. 25 (2516)); and/or (x) a particular user's tag line, such as, for example, as indicated in “Tag Line” text field 3120 (which may correspond to the tag line as indicated in one or more mobile applications 183, for example, as illustrated in FIG. 25 (2518)).

Returning to FIG. 30, in one or more embodiments, website 181 may allow users to perform various functions, such as, for example: (i) inviting potential users to register, such as by, for example, sending an invitation to a potential user via entering its/his/her name in “Name” text field 3026 and email address in “Email” text field 3028, and then by clicking “Send Invite” button 3048 and/or (ii) send mass messages to certain groups of users and/or all registered users, such as by, for example, clicking “Send group message” button 3024 which may allow users to select all and/or some of the registered users, create a communication, and/or select the time and/or date the communication may be transmitted, and other features as needed.

In one or more embodiments, all or part of a method for training and teaching people (and/or all or part of a system which implements such a method), such as, for example, method for training and teaching people 300, may allow users to develop and manage the content, parameters and distribution of each training instruction, activity and communication (such as, for example, in one or more websites 181 as illustrated herein).

In one or more embodiments, after a user has developed training instructions, activities, and communications in step 309 and/or in step 313, the data representing such may be stored, accesses, transferred, included, provided, obtained, processed, available, implemented, and/or otherwise used into/by/in/to/from (i) any network system, such as, for example, network system 190, (ii) any computing system's memory system such as, for example, located on client systems 100, 206, 220, 228, 150, 210, 224, 232; (ii) any mobile device's memory system, such as, for example, located on client systems 130, 208, 222, 230, 150, 210, 224, 232; (iii) any database, such as, for example, databases 174, 176; (iv) some and/or all of software implemented processes 192, 194, 196; and/or (v) otherwise available to all or part of a method for training and teaching people (and/or all or part of a system which implements such a method), such as, for example, method for training and teaching people 300, may allow users to link to, attach, copy, insert, package, display, incorporate and/or otherwise contain such training instructions, activities, and communications in training communications that may be sent to intended recipients (such as, for example, in one or more websites 181 as illustrated herein).

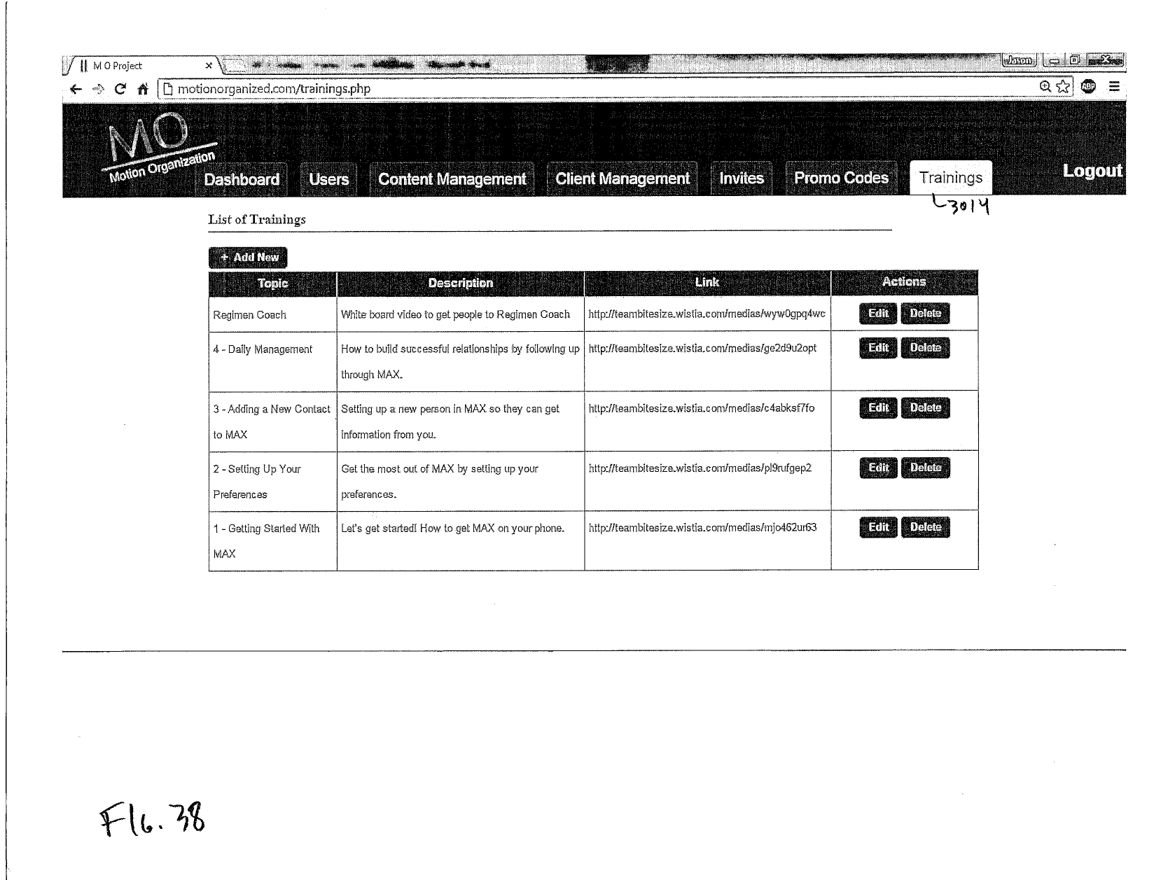

In one or more embodiments, referring to FIG. 38, website 181 may allow users to create, upload link, view, edit, distribute and/or otherwise manage training instructions, activities, and communications to be distributed to one or more mobile applications 183.

In one or more embodiments, all or part of a method for training and teaching people (and/or all or part of a system which implements such a method), such as, for example, method for training and teaching people 300, may allow users to classify and/or reclassify users into customizable categories and/or subcategories. In one or more embodiments, all or part of a method for training and teaching people (and/or all or part of a system which implements such a method), such as, for example, method for training and teaching people 300, may correspond to categories and subcategories selected for users in one aspect of the system (such as, for example, in one or more mobile applications 183) to another aspect of the system (such as, for example, one or more websites 181).

In one or more embodiments, all or part of a method for training and teaching people (and/or all or part of a system which implements such a method), such as, for example, method for training and teaching people 300, may allow users to view all users and/or users associated with other users and/or which category and/or subcategory each user has been assigned. For example, in one or more embodiments, referring to FIG. 35, website 181 may allow users to click on a particular user listed (3404) under “Users” heading 3408, at which time all users associated with that particular user's contacts may appear under “Contact Information” heading 3410, although not shown in FIG. 35). Users may then, in one or more embodiments, identify each user's assigned categories and subcategories, such as, for example, by clicking on any of the available subcategories (at which time all of the users associated with that particular user who may be assigned to that particular subcategory, may appear under “Contact Information” heading 3410, although not shown in FIG. 35). In one or more embodiments, website 181 may provide users information about each user and/or users associated with other users, such as, for example, by clicking on a contact listed under “Contact Information” heading 3410, although not shown in FIG. 35.

In one or more embodiments, all or part of a method for training and teaching people (and/or all or part of a system which implements such a method), such as, for example, method for training and teaching people 300, may allow users to specify, for example, (i) which users (such as, for example, which category and/or subcategory of users) are to be distributed what training instructions, activities and/or communications, (ii) the content of the training communication that will distribute said trainings, (iii) the means by which the training communication will be sent such as, for example, text, email, phone calls, notifications, reminders, etc.), and/or (iv) the time and order such training communications will be sent (such as, for example, date and time) (such as, for example, in one or more websites 181 as illustrated herein).

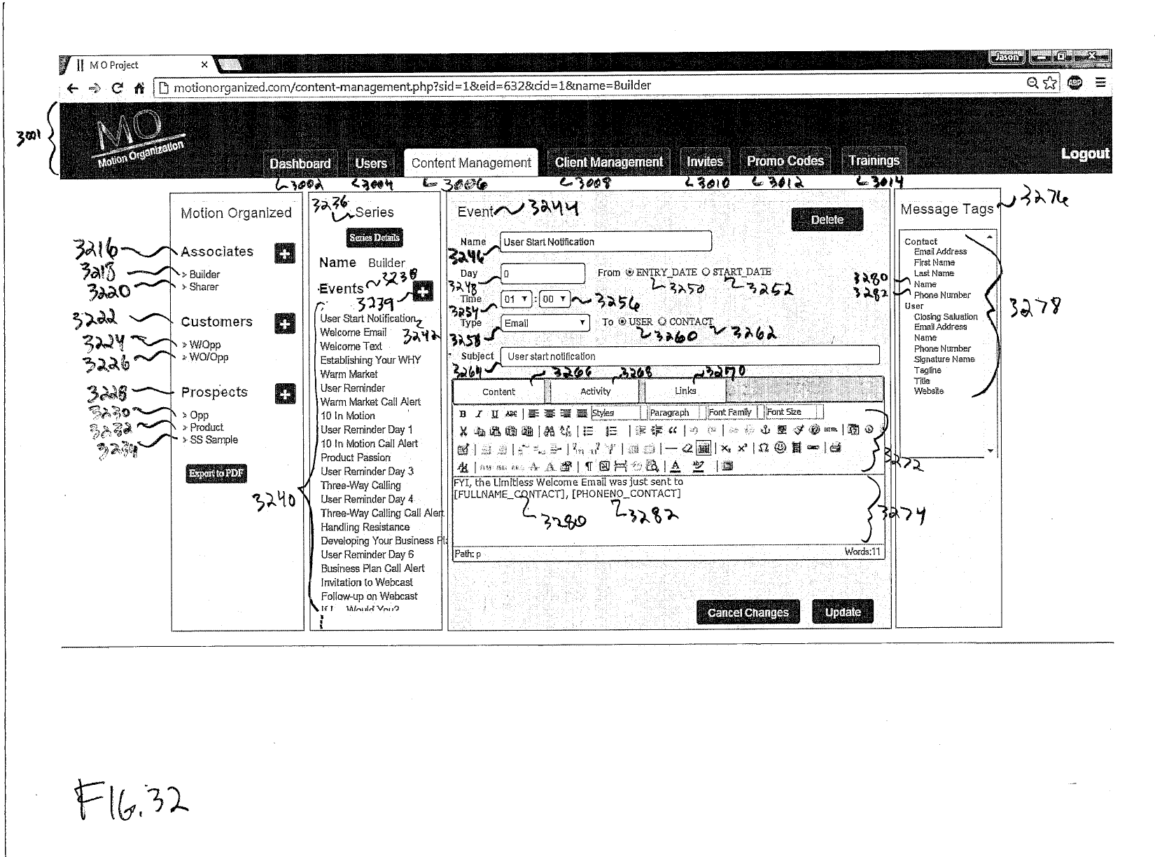

For example, in one or more embodiments, referring to FIG. 32, under “Content Management” tab 3006, website 181 may allow users to classify users into three categories: “Associates” 3216, “Customers” 3222, and “Prospects” 3228 (which may correspond with “Associates” button 1416, “Customer” button 1418, and “Prospects” button 1414 in mobile application 183, as illustrated in FIG. 14). The term “Associates” 3216 means, in this example, people who are distributors in a multilevel marketing company. “Associates” 3216 may be further broken down into “Builders” 3218 and “Sharers” 3220 subcategories (which may correspond with “Builders” button 1604 and “Sharers” button 1606 in mobile application 183, as illustrated in FIG. 16). The term “Builders” 3218 means, in this example, associates who are actively seeking to build their business. The term “Sharers” 3220 means, in this example, associates who are actively seeking to sell a customer's product, but who are not otherwise trying to build their business. “Associates” 3216 may be reclassified as “Customers” 3222 and/or “Prospects” 3228 and the various subcategories therein. The term “Customers” 3222 means, in this example, people who are not distributors but who purchase products from distributors in a multilevel marketing company. “Customers” 3222 may be further broken down into “W/Opp” 3224 and “WO/Opp” 3226 subcategories (which may correspond with “W/Opp” button 1604 and “WO/Opp” button 1606 in mobile application 183, as illustrated in FIG. 17). The term “W/Opp” 3224 means, in this example, customers who show an interest in becoming associates, but only purchase products from distributors at that time. The term “WO/Opp” 3226 means, in this example, customers who do not show an interest in becoming associates, and only purchase products from distributors at that time. “Customers” 3222 may be reclassified as “Associates” 3216 and/or “Prospects” 3228 and the various subcategories therein. The term “Prospects” 3228 means, in this example, possible leads. “Prospects” 3228 may be further broken down into “Opp” 3230, “Product” 3232, and/or “SS Sample” 3234 subcategories (which may correspond with “Opp” button 1422, “Product” button 1424, and/or “SS Sample” 1420 in mobile application 183, as illustrated in FIG. 17). The term “Opp” means, in this example, possible leads that show signs of becoming associates. The term “Product” means, in this example, possible leads that show signs of becoming customers. The term “SS Sample” means, in this example, possible leads which may respond well to obtaining a sample of a product. “Prospects” 3228 may be reclassified as “Associates” 3216 and/or “Customers” 3222 and the various subcategories therein.

In one or more embodiments, website 181 may allow each category and/or subcategory of users to receive a different series of training instructions, activities and/or communications tailored to the needs of their intended recipients (such as, for example, illustrated and discussed with reference to FIG. 2B and FIG. 2C above, such as, for example, a hospital's administrative team may need different training than its doctors and staff and a multilevel marketing company's management team may need different training than its distributors, who may need different training than new contacts).

For example, in one or more embodiments, referring to FIG. 32, website 181 may allow users to view the series (3236) of training instructions, activities and/or communications associated with a particular subcategory by clicking on a particular subcategory (such as, for example, “Builders” 3218, “Sharers” 3220, “W/Opp” 3224, “WO/Opp” 3226, “Opp” 3230, “Product” 3232, and/or “SS Sample” 3234 subcategories). In one or more embodiments, once a user has selected a subcategory, all training instructions, activities and/or communications (collectively, 3240) associated with that particular subcategory may populate under “Events” heading (3238). In one or more embodiments, users may add training events, such as, for example, by clicking “+” button 3239 and creating the content and setting the parameters of the new event.

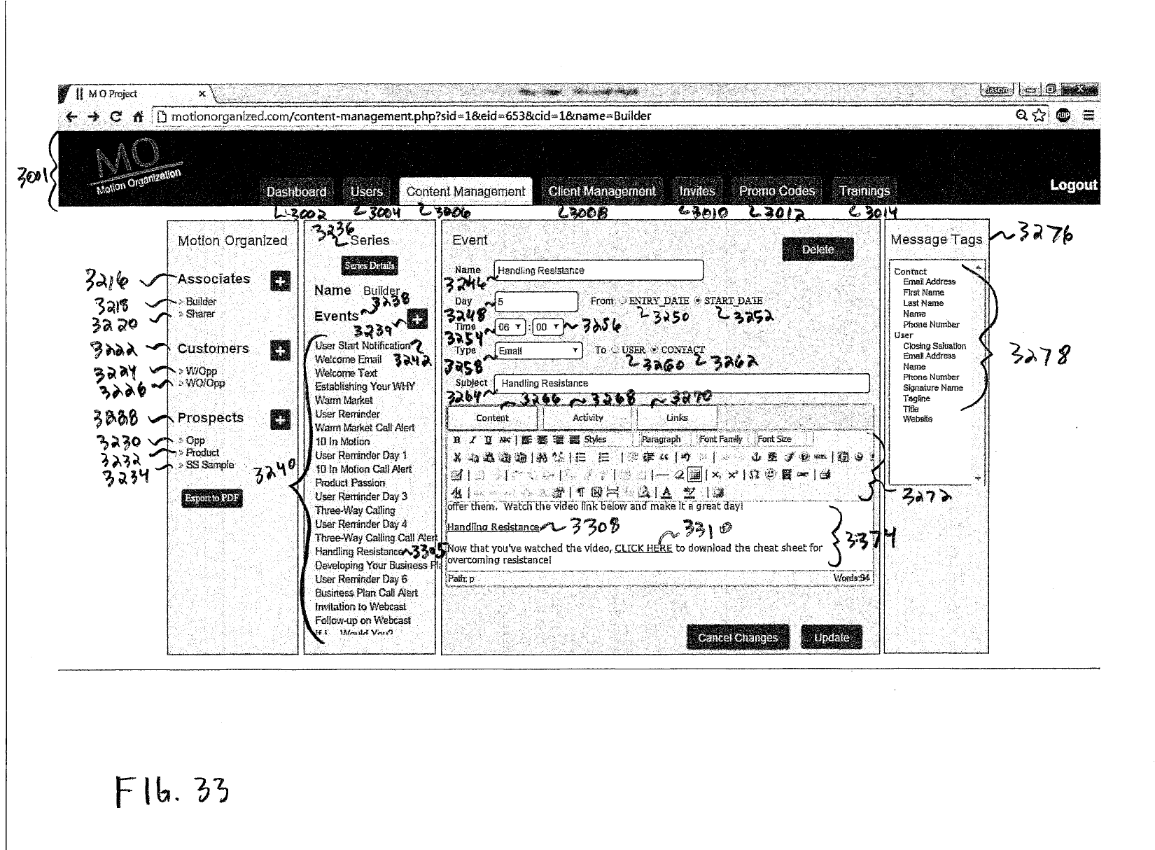

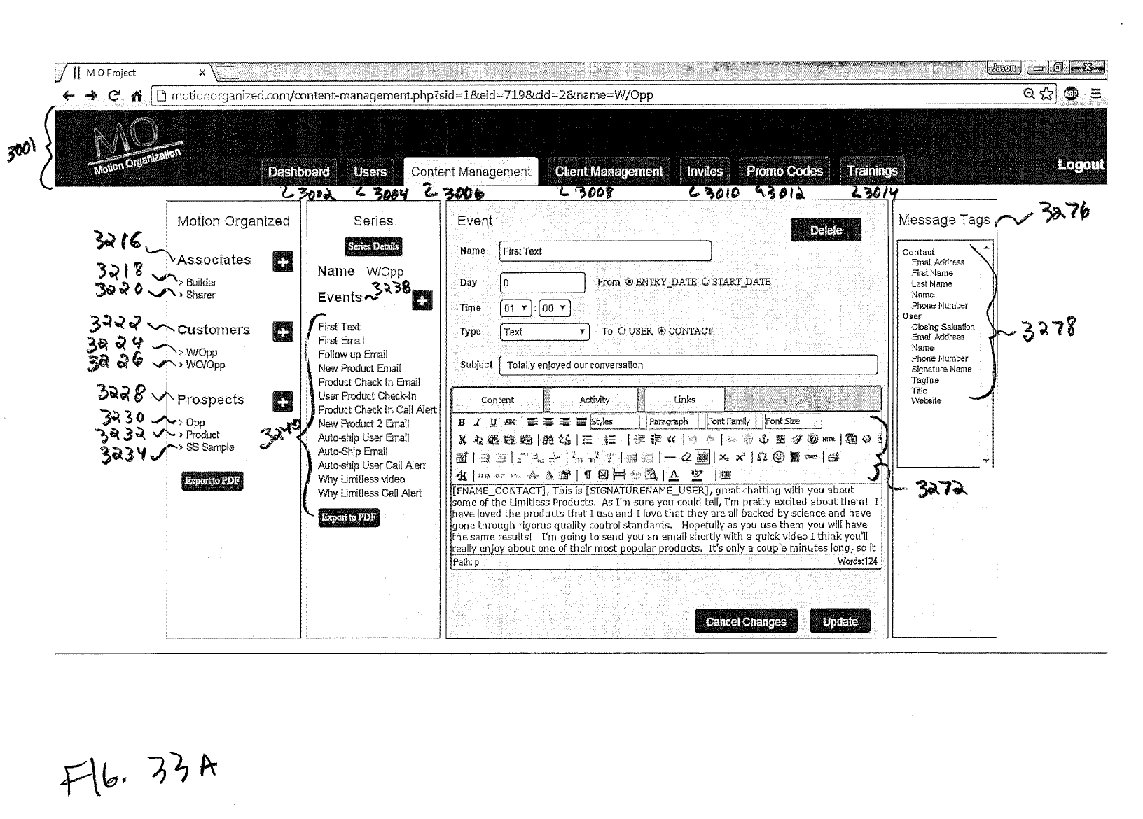

In one or more embodiments, website 181 may allow users to view and/or modify the content and/or relevant settings/parameters for particular events. For example, in one or more embodiments, in FIG. 32, the first event listed for “Builder” subcategory 3118 may be “User Start Notification” 3242 wherein by clicking on a “User Start Notification” 3242 website 181 may allow users to review and/or modify certain settings/parameters about that particular event. Such settings/parameters may include, for example, in one or more embodiment, the event's name (such as, for example, as indicated in “Name” text field 3246); the date and time it is intended to be distributed (such as, for example, the number of days from either the date a user was entered into the system (such as illustrated in “START DATE” radio button 3252) and/or a date users specify (such as illustrated in “Day” text field 3248, “ENTRY DATE” radio button 3250)). In one or more embodiments, a user may specify the specific day, hour and minute (as indicated “Time” drop down menu 3254 and 3256) the event may be distributed. In one or more embodiments, other information illustrated in FIG. 32, may include, for example, the type of correspondence of a particular event (such as, for example, text, email or phone call, as illustrated in “Type” drop down menu 3258); to whom that particular event is intended to be sent (such as, for example, a user or contact as selected in “USER” radio button 3260 or “CONTACT” radio button 3262); and/or the subject of that particular event (such as, for example, as indicated in “Subject” text field 3264). In one or more embodiments, website 181 may allow users to create, edit, add, attach, link, embed, upload, select and/or specify the content, parameters and distribution of each training instruction, activity and communication associated with each event (3240). For example, in one or more embodiments, referring to FIG. 32, website 181 may allow users to associate training activities with a particular event in a variety of ways, including, for example, by clicking on “Activity” button 3268 and having the ability to select from a drop down menu of available activities, such as, for example, challenges to be completed by a certain time, journal questions, and/or tests. In one or more embodiments, referring to FIG. 32, website 181 may allow users to embed videos, audio, downloads and other links in training communications distributed to users in a variety of ways, such as, for example, by clicking on “Links” button 3270 and typing a URL associated with videos, audios, downloads and other links into an available text field. In one or more embodiments, referring to FIG. 32 and FIG. 33, website 181 may allow users to create and/or edit the content of a particular event (3240) in a variety of ways, including, for example, by clicking on “Content” button 3266 and/or having the ability to:
Draft the content of a particular event (such as, for example: (i) drafting a text message in text field 3274, which reads, “Customer John Nye's assignment today after watching the video Handling Resistance, is to connect with you to go over the schedule of upcoming events. Be prepared with your calendar and help build the excitement!”; (ii) drafting an email reminder which may read, “Today customer Bob Smith will be watching the Sympathizing video. The instructor will be giving them an assignment to practice using the Sympathizing technique. Follow up with them later and give them an opportunity to practice with you.”; and/or (iii) instructing a user on what questions to ask a prospect, such as, for example, “Customer Sam Jones should've watched the video we just sent. Call the customer and ask: What did you like best about the video? Can you see why I'm so excited about this company and its products? Do you see any reason why you wouldn't want to try their products?”);
Edit the content of a particular event (such as, for example, functionality (3272) typical of word processing applications, such as, for example, Microsoft Word, and/or features of HTML editors and/or website administrators, such as, for example, Microsoft FrontPage);
Attach files to a particular event;
Insert predetermined data tags into a particular event (such as, for example, listed under “Message Tags” header 3276);
Link to videos (such as, for example, illustrated in FIG. 33, 3304), documents (such as, for example, illustrated in FIG. 33, 3306) and other files in a particular event; and/or
Perform any other functionality necessary (such as, for example, illustrated in FIG. 32 and FIG. 33), some of which may not be specifically recited herein but which are obvious to those skilled in the art.

In one or more embodiments, FIG. 33 and FIG. 33A illustrate two different series (3240) of training instructions, activities and communications for two different subcategories (i.e. “Builders” 3218 and “W/OPpp” 3224).

In one or more embodiments, referring to FIG. 33, website 181 may allow users to frame the content of training instructions, activities and communications. In one or more embodiments, framing the content of training instructions, activities and communications may seek to provide the intended recipients intrinsic motivation to engage in the learning process, get and keep their attention, and/or enhance the likelihood that the trainings will enter into their short-term memory, move to their long-term memory, and ultimately develop into habits, behaviors and/or desired outcomes.

For example, in one or more embodiments, referring to FIG. 33, website 181 may allow users to select specific events, such as, for example, the event “Handling Resistance” 3305 which may be selected from the list of events 3238 and associated with “Builder” subcategory 3218. In one or more embodiments, in text field 3374 on website 181 may provide a link to training instruction (such as, for example, a video) entitled “Handling Resistance” 3308, as well as a link 3310 to a training activity (such as, for example, a document) regarding overcoming resistance. In one or more embodiments, although not visible in its entirety in text field 3374, a user may type the following email communication (3358) in said text field, in order to frame the content of training instruction (3308) and training activities (3310) for the intended recipient (3362): “Handling resistance is a valuable tool to learn because everyone encounters some resistance from time to time. Today, [CEO Kirk Jensen] will discuss ways in which you can overcome resistance and share a powerful technique with you that is virtually bulletproof! You'll learn how easy it can be to respond when someone resists the great opportunity you have to offer them. Watch the video link below and make it a great day! Handling Resistance Now that you've watched the video, CLICK HERE to download the cheat sheet for overcoming resistance!” In one or more embodiments, this email communication (3358) seeks to set the stage (or, in other words, frame the content) and provides intrinsic motivation for the contact to engage in the learning process. In one or more embodiments, it states what the contact is about to be taught (e.g. “Handling Resistance”) and why it is important (e.g. “Handling resistance is a valuable tool to learn because everyone encounters some resistance from time to time.”). In one or more embodiments, it is short and focused, and seeks to build excitement (e.g. “the great opportunity you have to offer them”). In one or more embodiments, framing the video and document activity may be intended to get and keep the contact's attention and/or enhance the likelihood that the training will enter into his/her short-term memory, move to his/her long-term memory, and ultimately develop into habits, behaviors and/or desired outcomes.

In one or more embodiments, in step 317, a user may develop, obtain and/or provide to all or part of a method for training and teaching people (and/or all or part of a system which implements such a method), such as, for example, method for training and teaching people 300, data representing preparing training instructions, activities and communications to be distributed to intended recipients, by any means in any form from any source, and/or combination of the same, whether developed later or known at the time of filing.

For example, in one or more embodiments, a user may develop and/or obtain data representing preparing training instructions, activities and communications to be distributed to intended recipients from communication with a customer and/or third party (such as, for example, conversations with management, human resources, consultants, living/mock training sessions, etc.) and/or from materials and documents (such as, for example, reports, financial statements, manuals, handbooks, books, etc.) which may be provided to all or part of a method for training and teaching people (and/or all or part of a system which implements such a method), such as, for example, method for training and teaching people 300, by a user entering such data into client systems 202, 204, 218, 226 via user interfaces.

For example, in one or more embodiments, a user may develop, obtain and/or provide to all or part of a method for training and teaching people (and/or all or part of a system which implements such a method), such as, for example, method for training and teaching people 300, data representing preparing training instructions, activities and communications to be distributed to intended recipients, to/from any data stored and/transferred electronically which may be in a computer readable format and/or to/from a computer program product (such as, for example, emails, text messaging, instant messaging, spreadsheets, PowerPoint presentations, ebooks, videos, webinars, webcasts, podcasts, on-demand trainings, internet sites, emails, text, CD's, DVD's, flash memory, USB drives, tapes, audio files, etc. and/or any applicable software application, package, and/or system).

For example, in one or more embodiments, a user may develop, obtain and/or provide to all or part of a method for training and teaching people (and/or all or part of a system which implements such a method), such as, for example, method for training and teaching people 300, data representing preparing training instructions, activities and communications to be distributed to intended recipients, to/from one, some and/or all of software implemented processes 192, 194, 196 which implement, include, are accessed by, and/or are otherwise related to all or part of a method for training and teaching people (and/or all or part of a system which implements such a method), such as, for example, method for training and teaching people 300.

In one or more embodiments, a user may develop, obtain and/or provide to all or part of a method for training and teaching people (and/or all or part of a system which implements such a method), such as, for example, method for training and teaching people 300, data representing preparing training instructions, activities and communications to be distributed to intended recipients, to/through any network (such as, for example, network system 190) or combination of network systems, such as, for example, wide area networks, local area networks, public networks (such as, for example, the Internet), private networks and/or hybrid networks, and/or other network types (whether data is transmitted in waveform or otherwise transferred, collected, relayed, accessed, obtained, and/or provided and/or which may be capable of communicating between and among two or more server systems and/or client systems, including, for example, any network, server systems, computing systems, and/or devices disclosed herein), and/or combinations of the same, along with all related software and/or hardware, whether developed later or known at the time of filing.

In one or more embodiments, a user may develop, obtain and/or provide to all or part of a method for training and teaching people (and/or all or part of a system which implements such a method), such as, for example, method for training and teaching people 300, data representing preparing training instructions, activities and communications to be distributed to intended recipients, to/from: (i) any computing system's memory system such as, for example, located on client systems 100, 206, 220, 228, 150, 210, 224, 232; (ii) any mobile device's memory system, such as, for example, located on client systems 130, 208, 222, 230, 150, 210, 224, 232; and/or (iii) any database, such as, for example, databases 174, 176.

In one or more embodiments, a user may develop, obtain and/or provide to all or part of a method for training and teaching people (and/or all or part of a system which implements such a method), such as, for example, method for training and teaching people 300, data representing preparing training instructions, activities and communications to be distributed to intended recipients, to/from: (i) any other database, memory system, server system, web-based system, network, computing system, any device (including mobile devices), computer readable medium, computer program product, apparatus, method, means, process, and/or machine, and/or combination of the same, whether developed later or known at the time of filing; and/or (ii) any other means (and/or combination of the same, whether developed later or known at the time of filing, not otherwise expressly stated herein) for copying, imputing, transferring, transmitting, processing, scanning, relaying, entering, uploading, downloading, accessing and/or providing such data to, into, and/or by all or part of a method for training and teaching people (and/or all or part of a system which implements such a method), such as, for example, method for training and teaching people 300.

In one or more embodiments, in step 319, all or part of all or part of a system which implements such a method for training and teaching people, such as, for example, method for training and teaching people 300, distributes training instructions, activities and communications to intended recipients, in any form in any way from any source, whether developed later or known at the time of filing.

In one or more embodiments, once a user has selected the applicable parameters (such as, for example, discussed in step 317 above) regarding training communications associated with a particular event, all or part of a method for training and teaching people (and/or all or part of a system which implements such a method), such as, for example, method for training and teaching people 300, may be designed so that that particular event may be automatically distributed to intended recipients associated with that particular event in accordance with the parameters set by a user (such as, for example, referring to FIG. 32, FIG. 33, FIG. 33A, and FIG. 34 regarding website 181). The benefit of such functionality may be, in one or more embodiments, that thousands, perhaps millions, of different users may automatically receive training timed, ordered and/or tailored to their needs.

For example, in one or more embodiments, the following scenario may occur: An organization may be hired by an insurance company to provide certain training. The organization may assess the company's training needs and develop two series of training topics, instructions, activities and communications (such as, for example, discussed in step 303 and step 309)—one for the company's sales agents on how to close deals and the other for prospects on why to buy the company's products. The organization may register the company's management team into the system and provide access to a website (such as for example, website 181) wherein the company's management team may perform various administrative functions regarding its sales agents and their prospects. The organization may assess the company's support channel needs and develop a series of training topics, instructions, activities and communications (such as, for example, discussed in step 311 and step 313) which may notify each manager about the various trainings each of their subordinates are receiving and reminders to follow-up, follow through and/or hold their subordinates accountable for trainings they receive. The organization may establish a private branded mobile application (such as, for example, mobile application 183) wherein the company's sales agents may input prospect information. Each sales agent, prospect and manager may access their respective training instructions, activities and/or communications via the Internet regardless of where they are located provided that they have access to a mobile device (such as, for example, mobile devices 130, 208, 222, 230) and/or a computing system (such as, for example, computing systems 100, 206, 220, 228, which may access email, text, watch a video, and/or communicate via a website and/or mobile application (such as, for example, one or more websites 181 and/or mobile applications 183) via the Internet through a network (such as, for example, network system 190), or communicate via a telephone call.

Under such a scenario, in one or more embodiments, the training series developed for prospects may be prepared and automatically distributed (such as, for example, discussed in step 317 and step 319) to each existing prospect and to all new prospects added to the system according to the parameters set. Likewise, in one or more embodiments, the training series developed for the sales agents may be prepared and automatically distributed (such as, for example, discussed in step 317 and step 319) to each existing sales agent and to all newly hired sales agents when they are added to the system. Likewise, in one or more embodiments, the training series developed for the support channels may be prepared and automatically distributed (such as, for example, discussed in step 311 and step 313) to each existing management and to newly hired management when they are added to the system. Thus, in one or more embodiments, no matter when a new prospect or a new sales agent or a new manager is added into the system (such as, for example, via website 181 and/or mobile application 183 as discussed above), the training series specified for them may be automatically distributed to them. As a result, in one or more embodiments, each sales agent, each prospect, and each manager may be fully trained and/or held accountable regardless of when they are hired.

Under such a scenario, in one or more embodiments, the insurance company may have an existing eight-hour long training program aimed at training its sales agent on numerous topics regarding how to close a deal. In such a case, the organization, in the process of developing training topics, instructions, activities and communications, may break down the eight-hour long training program into about 120 separate focused training instruction videos, each about four minutes long. In one or more embodiments, learners may review at least one training video per day, thus there may be 120 days of training. In one or more embodiments, the organization may also develop at least one training activity (such as a worksheet, a challenge, a journaling topic, etc.) to accompany each training video, thus totaling 120 training activities and their supporting materials.

If, under such a scenario, in one or more embodiments, the insurance company had about 50,000 sales agents, all or part of a method for training and teaching people (and/or all or part of a system which implements such a method), such as, for example, method for training and teaching people 300, may automatically distribute about 6 million communications each containing a training video, a training activity, and supporting documentation, with each training video and activity being potentially viewed and performed by recipients at different specific times and each learner may be in need of follow-up at different specific times.

In addition, in one or more embodiments, if there was one manager for every 100 sales agents, the insurance company may have about 500 managers, each manager receiving training communications (such as, for example, notifications and reminders) specifically timed, distributed and topically correlated to the specific trainings each of their respective sales agents are receiving. In one or more embodiments, each manager may receive a separate notification and/or reminder every time one of his/her sales agents receives and/or completes a training video and/or activity and needs follow-up. Under such a scenario, all or part of a method for training and teaching people (and/or all or part of a system which implements such a method), such as, for example, method for training and teaching people 300, may automatically distribute about a total of 6 million additional communications to 500 managers.

In addition, in one or more embodiments, each manager may receive their own training instructions, activities and communications on how to be more effective managers. Furthermore, in one or more embodiments, there may be different levels of management wherein each manager may be managed by a senior manager, which senior manager may be managed by an even more senior manager, and so on and so forth up the corporate ladder (totaling, for example, six levels of management), with each manager at each level receiving communications (such as, for example, notifications and reminders) regarding their subordinates which may be specifically timed, distributed and topically correlated to the specific trainings each of their subordinates are receiving and/or with each manager at each level receiving their own training instructions, activities and communications.

Under such a scenario, the combination of different categories of users and channels of support and the sheer number of training instructions, activities and/or communications distributed, noticed and followed-up on, all of which may be at different specific times to many different people, becomes very large and very complex. The complexity may increase if individuals are located in different parts of the world in different time zones and if individuals speak different languages. Such complexity may be implemented by all or part of a method for training and teaching people (and/or all or part of a system which implements such a method), such as, for example, method for training and teaching people 300. The above scenario is regarding only one customer—the insurance company who hired the organization to provide certain training. Certainly it is anticipated that the organization using all or part of a method for training and teaching people (and/or all or part of a system which implements such a method), such as, for example, method for training and teaching people 300, to provide such training may have more than one customer. For example, in one or more embodiments, a user may be hired by 100 companies to provide certain training, with each company having about 50,000 employees. In one or more embodiments, if all 100 companies needed the same amount of training as indicated above, the number of training instructions, activities and communications just to the front-line employees (not including support channels) may equal 600 million. Thus it may be obvious to a person skilled in the art that, in one or more embodiments, the number of training instructions, activities and communications needed to be developed and distributed is astronomical. In one or more embodiments, all or part of a method for training and teaching people (and/or all or part of a system which implements such a method), such as, for example, method for training and teaching people 300, has the ability to develop and asynchronously distribute numerous training instructions, activities and communications implementing psychologically and/or brain functioning related teaching and training techniques (such as, for example, developing training instructions that (i) may contain intrinsically motivating material, (ii) may focus on three to five points, (iii) may be three to five minutes long, (iv) may be tied to senses, emotions, past memories, past events, mental functions, and/or physical functions; etc.; developing training activities that may enable a learner to practice and apply what they have learned; developing training communications designed to properly frame and set up the content of training instructions and activities and to ensure follow-up, follow through and accountability by various support channels) aimed at increasing the effectiveness of enabling the teachings and trainings to enter into and move from learners' short-term memory, to their long-term memory and ultimately to habit formation and/or displacement according to a customer's desired outcomes, through an automated system to numerous front-line learners and various levels of numerous support channels.

The benefits of the disclosure, for example, in one or more embodiments, may include such things as, for example, the benefits listed in the SUMMARY section, which are hereby incorporated herein as if set forth in full.

In one or more embodiments, training instructions, activities and communications may be caused to be distributed in various ways, such as, for example:
Automatically according to parameters set by a user, such as, for example, via one or more websites 181 and/or mobile applications 183;
Upon request from a user, such as, for example, via one or more websites 181 and/or mobile applications 183; and/or
Upon request from a purchaser and/or from their employer, such as, for example, via one or more websites 181 and/or mobile applications 183.

In one or more embodiments, in step 303, a user may develop, obtain and/or provide to all or part of a method for training and teaching people (and/or all or part of a system which implements such a method), such as, for example, method for training and teaching people 300, data representing distributed training instructions, activities and communications, by any means in any form from any source, and/or combination of the same, whether developed later or known at the time of filing.

For example, in one or more embodiments, a user may develop and obtain data representing distributed training instructions, activities and communications from communication with a customer and/or third party (such as, for example, conversations with management, human resources, consultants, living/mock training sessions, etc.) and/or from materials and documents (such as, for example, reports, financial statements, manuals, handbooks, books, etc.) which may be provided to all or part of a method for training and teaching people (and/or all or part of a system which implements such a method), such as, for example, method for training and teaching people 300, by a user entering such data into client systems 202, 204, 218, 226 via user interfaces.

For example, in one or more embodiments, a user may develop, obtain and/or provide to all or part of a method for training and teaching people (and/or all or part of a system which implements such a method), such as, for example, method for training and teaching people 300, data representing distributed training instructions, activities and communications, to/from any data stored and/transferred electronically which may be in a computer readable format and/or to/from a computer program product (such as, for example, emails, text messaging, instant messaging, spreadsheets, PowerPoint presentations, ebooks, videos, webinars, webcasts, podcasts, on-demand trainings, internet sites, emails, text, CD's, DVD's, flash memory, USB drives, tapes, audio files, etc. and/or any applicable software application, package, and/or system).

For example, in one or more embodiments, a user may develop, obtain and/or provide to all or part of a method for training and teaching people (and/or all or part of a system which implements such a method), such as, for example, method for training and teaching people 300, data representing distributed training instructions, activities and communications, to/from one, some and/or all of software implemented processes 192, 194, 196 which implement, include, are accessed by, and/or are otherwise related to all or part of a method for training and teaching people (and/or all or part of a system which implements such a method), such as, for example, method for training and teaching people 300.

In one or more embodiments, a user may develop, obtain and/or provide to all or part of a method for training and teaching people (and/or all or part of a system which implements such a method), such as, for example, method for training and teaching people 300, data representing distributed training instructions, activities and communications, to/through any network (such as, for example, network system 190) or combination of network systems, such as, for example, wide area networks, local area networks, public networks (such as, for example, the Internet), private networks and/or hybrid networks, and/or others network types (whether data is transmitted in waveform or otherwise transferred, collected, relayed, accessed, obtained, and/or provided and/or which may be capable of communicating between and among two or more server systems and/or client systems, including, for example, any network, server systems, computing systems, and/or devices disclosed herein), and/or combinations of the same, along with all related software and/or hardware, whether developed later or known at the time of filing.

In one or more embodiments, a user may develop, obtain and/or provide to all or part of a method for training and teaching people (and/or all or part of a system which implements such a method), such as, for example, method for training and teaching people 300, data representing distributed training instructions, activities and communications, to/from: (i) any computing system's memory system such as, for example, located on client systems 100, 206, 220, 228, 150, 210, 224, 232; (ii) any mobile device's memory system, such as, for example, located on client systems 130, 208, 222, 230, 150, 210, 224, 232; and/or (iii) any database, such as, for example, databases 174, 176.

In one or more embodiments, a user may develop, obtain and/or provide to all or part of a method for training and teaching people (and/or all or part of a system which implements such a method), such as, for example, method for training and teaching people 300, data representing distributed training instructions, activities and communications, to/from: (i) any other database, memory system, server system, web-based system, network, computing system, any device (including mobile devices), computer readable medium, computer program product, apparatus, method, means, process, and/or machine, and/or combination of the same, whether developed later or known at the time of filing; and/or (ii) any other means (and/or combination of the same, whether developed later or known at the time of filing, not otherwise expressly stated herein) for copying, imputing, transferring, transmitting, processing, scanning, relaying, entering, uploading, downloading, accessing and/or providing such data to, into, and/or by all or part of a method for training and teaching people (and/or all or part of a system which implements such a method), such as, for example, method for training and teaching people 300.

In one or more embodiments, in step 321, a user may evaluate the training progress of intended recipients in any way by any means from any source. For example, in one or more embodiments, all or part of all or part of a system which implements such a method for training and teaching people, such as, for example, method for training and teaching people 300, may collect, receive, track, gather, obtain, access, process, receive, generate, display, use, provide and/or otherwise make available to a user information regarding (i) the progress of those in whom training instructions, activities and/or communications were distributed in various ways, (ii) all customer accounts, user accounts and contact accounts, such as, for example, billing information, payment status, training progress, usage information, goals, logins, up line and down line relationships associated with each customer user and all contacts, and/or (iii) all other aspects of any user for any purpose.

For example, in one or more embodiments, one or more websites 181 may collect, receive, track, gather, obtain, access, process, receive, generate, display, use, provide and/or otherwise make available to a user information regarding: (i) the progress of those in whom training instructions, activities and/or communications were distributed in various ways, (ii) all customer accounts, user accounts and contact accounts, such as, for example, billing information, payment status, training progress, usage information, goals, logins, up line and down line relationships associated with each customer user and all contacts, and/or (iii) all other aspects of any user for any purpose, such as, for example, regarding customer's baselines, leading indicators, lagging/trailing indicators, targets, and/or desired outcomes; and/or other user information.

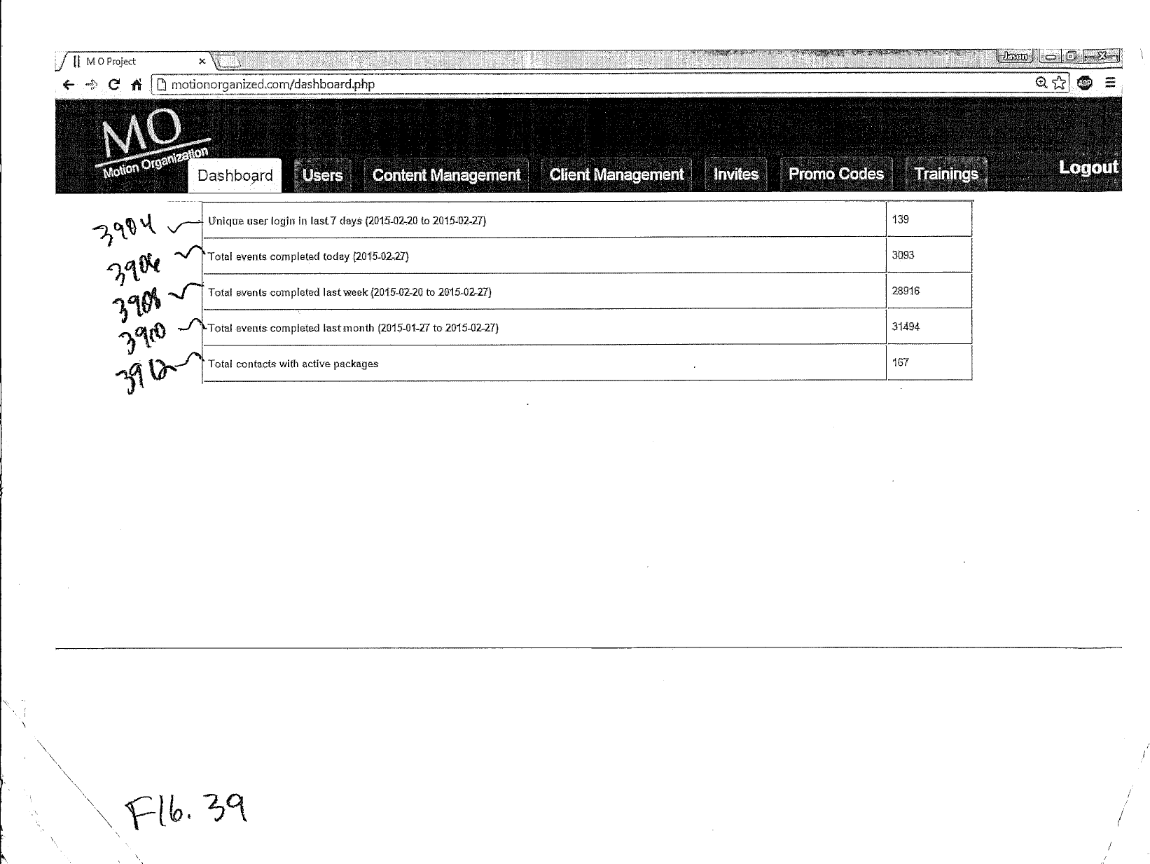

For example, in one or more embodiments, referring to FIG. 39, website 181 may collect, receive, track, gather, obtain, access, process, receive, generate, display, use, provide and/or otherwise make available to a user the following information: “Unique user login in last 7 days” 3904, “Total events completed today” 3906, “Total events completed last week” 3908, “Total events completed last month” 3910, and/or “Total contacts with active packages” 3912.

In one or more embodiments, one or more mobile applications 183 may collect, receive, track, gather, obtain, access, process, receive, generate, display, use, provide and/or otherwise make available to a user (i) the progress of those in whom training instructions, activities and/or communications were distributed in various ways, (ii) all customer accounts, user accounts and contact accounts, such as, for example, billing information, payment status, training progress, usage information, goals, logins, up line and down line relationships associated with each customer user and all contacts, and/or (iii) all other aspects of any user for any purpose.

For example, in one or more embodiments, referring to FIG. 17A, FIG. 18, FIG. 22, FIG. 23, and FIG. 26, one or more mobile applications 183 may collect, receive, track, gather, obtain, access, process, receive, generate, display, use, provide and/or otherwise make available to a user the following information: the number of trainings each of his/her user contacts have completed (1710a, 1710b, 1710c, 1710d, 1810a, 1810b, 1810c, 1810d, 1810e, 18100; the number of trainings to be completed (1712a, 1712b, 1712c, 1712d, 812a, 1812b, 1812c, 1812d, 1812e, 1812f); scheduled text messages to be sent and/or calls to be made; the events scheduled to be accomplish that day; and/or whether certain goals have been met.

In one or more embodiments, all or part of a method for training and teaching people (and/or all or part of a system which implements such a method), such as, for example, method for training and teaching people 300, may provide certification tools, which may track and/or update users on the progress of themselves and other users in completing training instructions, activities and communications.

In one or more embodiments, in step 303, a user may develop, obtain and/or provide to all or part of a method for training and teaching people (and/or all or part of a system which implements such a method), such as, for example, method for training and teaching people 300, data representing the training progress of intended recipients, by any means in any form from any source, and/or combination of the same, whether developed later or known at the time of filing.

For example, in one or more embodiments, a user may develop and obtain data representing the training progress of intended recipients from communication with a customer and/or third party (such as, for example, conversations with management, human resources, consultants, living/mock training sessions, etc.) and/or from materials and documents (such as, for example, reports, financial statements, manuals, handbooks, books, etc.) which may be provided to all or part of a method for training and teaching people (and/or all or part of a system which implements such a method), such as, for example, method for training and teaching people 300, by a user entering such data into client systems 202, 204, 218, 226 via user interfaces.

For example, in one or more embodiments, a user may develop, obtain and/or provide to all or part of a method for training and teaching people (and/or all or part of a system which implements such a method), such as, for example, method for training and teaching people 300, data representing the training progress of intended recipients, to/from any data stored and/transferred electronically which may be in a computer readable format and/or to/from a computer program product (such as, for example, emails, text messaging, instant messaging, spreadsheets, PowerPoint presentations, ebooks, videos, webinars, webcasts, podcasts, on-demand trainings, internet sites, emails, text, CD's, DVD's, flash memory, USB drives, tapes, audio files, etc. and/or any applicable software application, package, and/or system).

For example, in one or more embodiments, a user may develop, obtain and/or provide to all or part of a method for training and teaching people (and/or all or part of a system which implements such a method), such as, for example, method for training and teaching people 300, data representing the training progress of intended recipients, to/from one, some and/or all of software implemented processes 192, 194, 196 which implement, include, are accessed by, and/or are otherwise related to all or part of a method for training and teaching people (and/or all or part of a system which implements such a method), such as, for example, method for training and teaching people 300.

In one or more embodiments, a user may develop, obtain and/or provide to all or part of a method for training and teaching people (and/or all or part of a system which implements such a method), such as, for example, method for training and teaching people 300, data representing the training progress of intended recipients, to/through any network (such as, for example, network system 190) or combination of network systems, such as, for example, wide area networks, local area networks, public networks (such as, for example, the Internet), private networks and/or hybrid networks, and/or other network types (whether data is transmitted in waveform or otherwise transferred, collected, relayed, accessed, obtained, and/or provided and/or which may be capable of communicating between and among two or more server systems and/or client systems, including, for example, any network, server systems, computing systems, and/or devices disclosed herein), and/or combinations of the same, along with all related software and/or hardware, whether developed later or known at the time of filing.

In one or more embodiments, a user may develop, obtain and/or provide to all or part of a method for training and teaching people (and/or all or part of a system which implements such a method), such as, for example, method for training and teaching people 300, data representing the training progress of intended recipients, to/from: (i) any computing system's memory system such as, for example, located on client systems 100, 206, 220, 228, 150, 210, 224, 232; (ii) any mobile device's memory system, such as, for example, located on client systems 130, 208, 222, 230, 150, 210, 224, 232; and/or (iii) any database, such as, for example, databases 174, 176.

In one or more embodiments, a user may develop, obtain and/or provide to all or part of a method for training and teaching people (and/or all or part of a system which implements such a method), such as, for example, method for training and teaching people 300, data representing the training progress of intended recipients, to/from: (i) any other database, memory system, server system, web-based system, network, computing system, any device (including mobile devices), computer readable medium, computer program product, apparatus, method, means, process, and/or machine, and/or combination of the same, whether developed later or known at the time of filing; and/or (ii) any other means (and/or combination of the same, whether developed later or known at the time of filing, not otherwise expressly stated herein) for copying, imputing, transferring, transmitting, processing, scanning, relaying, entering, uploading, downloading, accessing and/or providing such data to, into, and/or by all or part of a method for training and teaching people (and/or all or part of a system which implements such a method), such as, for example, method for training and teaching people 300.

In one or more embodiments, in step 323, a user determines whether a customer's desired outcomes (developed and obtained in step 303), were achieved. If so, then the process flows to step 325, else the process returns to step 309 where a user reassesses a customer's training needs and develops training topics, instructions, activities and communications accordingly. In one or more embodiments, a user's evaluation may be influenced by, based on, shaped by and/or otherwise informed by evaluation performed in step 321.

In one or more embodiments, in step 325, a user determines whether a customer has additional desired outcomes. If so, the process returns to step 303, else the process terminates at step 327.

FIG. 3A is a flow diagram that depicts a method for teaching and training people 300A in accordance with one embodiment. In one or more embodiments, the method for teaching and training people as illustrated flow diagram FIG. 3A may be customized, flexible and adapted to various circumstances and situations. For example, in one or more embodiments, all or part of a method for training and teaching people (and/or all or part of a system which implements such a method), such as, for example, method for training and teaching people 300A, may include one or more websites 181 and/or mobile applications 183 wherein training topics, instructions, activities and/or communications and/or all or part of a method for training and teaching people (and/or all or part of a system which implements such a method), such as, for example, method for training and teaching people 300A, may be purchased, used, accessed, obtained, downloaded, viewed and/or otherwise interacted with via a network system (such as, for example, network system 190) via the Internet.

For example, in one or more embodiments, a person searching for leadership training may search in Google and find a link to one or more websites 181 containing a leadership training series for sale and/or one or more mobile applications 183 for sale containing a leadership training series. In one or more embodiments, a purchaser may purchase, download, view and use either and/or both for his/her personal use or otherwise.

In one or more embodiments, in step 301A, a user enters the process, which may include such things as, for example, things in step 301 (which step is hereby incorporated herein by reference in its entirety as if set forth in full).

In one or more embodiments, in step 309A, a user assesses market training needs and develops training topics, instructions, activities and communications, which may include such things as, for example, things discussed in relation to developing training topics, instructions, activities and communications for customers as discussed in step 309 (which step is hereby incorporated herein by reference in its entirety as if set forth in full). In one or more embodiments, assessing market training needs may include anything in relations to gaging market demand for particular trainings topics and their corollary training instructions, activities and communications, as well as, for example, the profitability of such.

In one or more embodiments, in step 311A, a user may optionally determine whether support channels exist that may provide learners support during the training process, which may include such things as, for example, things discussed in relation to optionally determine whether support channels exist that may provide learners support during the training process as discussed in step 311 (which step is hereby incorporated herein by reference in its entirety as if set forth in full). In one or more embodiments, if support channels exist, a user may optionally assess the support channels' training needs and develop training topics, instructions, activities and communications for such in step 313A, else the process flows to step 315A.

In one or more embodiments, once support channels' training needs have been determined, in step 313A, a user may optionally develop training topics, instructions, activities and communications for support channels, which may include such things as, for example, things discussed in relation to developing training topics, instructions, activities and communications for support channels as discussed in step 313 (which step is hereby incorporated herein by reference in its entirety as if set forth in full).

In one or more embodiments, in step 315A, a user may determine whether training topics, instructions, activities and communications have been developed, which may include such things as, for example, things discussed in relation to determine whether training topics, instructions, activities and communications have been developed as discussed in step 315 (which step is hereby incorporated herein by reference in its entirety as if set forth in full). In one or more embodiments, if so, the process flows to step 317A, else the process returns to step 309A and/or step 313A.

In one or more embodiments, in step 317A, a user may prepare to distribute training instructions, activities and communications to intended recipients, which may include such things as, for example, things discussed in relation to preparing to distribute training instructions, activities and communications to intended recipients as discussed in step 317 (which step is hereby incorporated herein by reference in its entirety as if set forth in full).

In one or more embodiments, in step 319A, all or part of all or part of a system which implements such a method for training and teaching people, such as, for example, method for training and teaching people 300A, distributes training instructions, activities and communications to intended recipients, in any form in any way from any source, whether developed later or known at the time of filing, which may include the things disclosed in step 319 (which step is hereby incorporated herein by reference in its entirety as if set forth in full).

In one or more embodiments, in step 327A, a user terminates the process.

What is claimed is:

1. A method for teaching and training people associated with a customer entity, the method comprising:
identifying a desired training outcome of a customer entity;
identifying existing training information of the customer entity;
identifying the customer entity's training needs;
organizing the customer entity's training needs into training topics;
developing a training instruction for each of the training topics;
identify a topic master for providing support to learners;
distributing a first training instruction associated with a training topic to the topic master;
training the topic master to become a master of the training topic;
asynchronously distributing a second training instruction associated with the training topic to a plurality of learners;
assisting, by the topic master, each of the plurality of learners to learn using the second training instruction;
evaluating the training progress of each of the plurality of learners compared to the desired training outcome; and
communicating to the topic master the training progress of each of the plurality of learners.

2. The method of claim 1, further comprising:
assisting, by the topic master, each learner identified as having a training progress less than the desired training outcome.

3. The method of claim 1, wherein asynchronously distributing a second training instruction comprises transmitting the second training instruction to a plurality of learners using a channel selected from the group consisting of email, website, text messaging, instant messaging, social media and push notification.

4. The method of claim 1, further comprising:
identifying a support channel for providing support to topic masters;
distributing a third training instruction associated with the training topic to the support channel;
training the support channel with the third training instruction; and
assisting, by the support channel, the topic master to learn using the first training instruction.

5. A system for teaching and training people, comprising:
a first computing device comprising a first processor and first memory, the first memory storing instructions that when executed by the first processor cause the first computing device to implement functions, comprising:
identify a desired training outcome of a customer entity;
identify existing training information of the customer entity;
identify the customer entity's training needs;
organize the customer entity's training needs into training topics;
develop a training instruction for each of the training topics;
identify a topic master for providing support to learners;
distribute a first training instruction associated with a training topic to the topic master;
asynchronously distribute a second training instruction associated with the training topic to a plurality of learners;
evaluate the training progress of each of the plurality of learners compared to the desired training outcome; and
communicate to the topic master the training progress of each of the plurality of learners;
a second computing device comprising a second processor and a second memory, the second memory storing instructions that when executed by the second processor cause the second computing device to implement functions, comprising:
receive the first training instruction;
assist a topic master to become a master of the training topic; and
receive the training progress of each of the plurality of learners.
a third computing device comprising a third processor and a third memory, the third memory storing instructions that when executed by the third processor cause the third computing device to implement functions, comprising:
receive the second training instruction;
assist a learner to learn the training topic using the second training instruction; and
communicate a training progress of the learner to another computing device.

6. The system of claim 5, further comprising:
a fourth computing device comprising a fourth processor and a fourth memory, the fourth memory storing instructions that when executed by the fourth processor cause the fourth computing device to implement functions, comprising:
receive the second training instruction;
assist a second learner to learn the training topic using the second training instruction; and
communicate a training progress of the second learner to another computing device;
wherein asynchronously distributing a second training instruction comprises transmitting the second training instruction to the third computing device and the fourth computing device.

7. The system of claim 5, wherein the instructions stored in the first memory further cause the first computing device to identify a support channel for providing support to topic masters and distributing a third training instruction associated with the training topic to the support channel, wherein the system further comprises:
a fourth computing device comprising a fourth processor and a fourth memory, the fourth memory storing instructions that when executed by the fourth processor cause the fourth computing device to implement functions, comprising:
receive the third training instruction;
assist in training the support channel with the third training instruction; and
assist the support channel in training the topic master to learn using the first training instruction.

8. The system of claim 5, wherein the first computing device is a remote server, the second computing device is a portable device communicately coupled to the remote server, and the third computing device is a portable device communicately coupled to the remote server.

9. A system for organizing instruction, comprising a computing device comprising a processor and memory, the memory storing instructions that when executed by the processor cause the computing device to implement functions, comprising:
identify a desired training outcome of a customer entity;
identify existing training information of the customer entity;
identify the customer entity's training needs;
organize the customer entity's training needs into training topics;
develop a training instruction for each of the training topics;
identify a topic master for providing support to learners;
distribute a first training instruction associated with a training topic to the topic master, the first training instruction instructing the topic master to become a master in the training topic;
asynchronously distribute a second training instruction associated with the training topic to a plurality of learners, the second training instruction configured to enable each of the plurality of learners to learn the training topic with assistance from the topic master;
evaluate the training progress of each of the plurality of learners compared to the desired training outcome; and
communicate to the topic master the training progress of each of the plurality of learners.

10. The system of claim 9, wherein asynchronously distributing a second training instruction comprises transmitting the second training instruction to a plurality of computing devices.

11. The system of claim 9, wherein the instructions stored in the memory further cause the computing device to identify a support channel for providing support to topic masters and distribute a third training instruction associated with the training topic to the support channel, the third training instruction configured to assist the support channel to train the topic master to become a master in the training topic.

12. The system of claim 9, wherein the computing device server is remote to a customer entity being trained.

13. The system of claim 9, wherein the instructions stored in the memory further cause the computing device to update the second topic instruction based on the training progress of each of the plurality of learners.
